(19) United States
(12) Patent Application Publication
(10) Pub. No.: US 2024/0055247 A1
(43) Pub. Date: Feb. 15, 2024

(54) OFF-AXIS ION EXTRACTION AND SHIELD GLASS ASSEMBLIES FOR SAMPLE ANALYSIS SYSTEMS

(71) Applicant: Exum Instruments, Denver, CO (US)

(72) Inventors: Jeffrey WILLIAMS, Denver, CO (US); Jens COLE, Golden, CO (US); Peyton Mackenzie WILLIS, Denver, CO (US); Oleg MALTSEV, Albuquerque, NM (US); Jonathan C. PUTMAN, Denver, CO (US); Nathan KAISER, Brier, WA (US); Cole NAYMARK, Englewood, CO (US)

(21) Appl. No.: 18/232,747

(22) Filed: Aug. 10, 2023

Related U.S. Application Data
(60) Provisional application No. 63/396,868, filed on Aug. 10, 2022.

(51) Int. Cl. H01J 49/06; H01J 49/16

(52) U.S. Cl. CPC H01J 49/067; H01J 49/164

(57) ABSTRACT

A system includes a sample chamber, an aperture plate defining an aperture having an aperture axis aligned with a sample location within the sample chamber. The system further includes a first laser source to produce a cloud of material from a sample and a second laser source configured to produce ionized material from the cloud of material. The system also includes an ion extractor assembly defining an ion extraction path and a mass spectrometer in communication with the ion extractor assembly. The ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by the second beam along the ion extraction path.

### CROSS-REFERENCE TO RELATED APPLICATION

This application is related to and claims priority under 35 U.S.C. § 119(e) from U.S. Patent Application No. 63/396,868 filed Aug. 10, 2022, titled “Off-Axis Ion Extraction and Shield Glass Assemblies for Sample Analysis Systems”, the entire content of which is incorporated herein by reference for all purposes.

### TECHNICAL FIELD

Aspects of the present disclosure involve systems and methods for chemical analysis of samples. More specifically, the present disclosure is directed to systems and methods for analyzing organic and inorganic components of a sample

### BACKGROUND

Mass spectrometry is a technique for analyzing chemical species of a sample material by sorting ions of the material based on their mass-to-charge ratio. In general, the process includes generating ions from a sample such as by bombarding the sample with an energy beam (e.g., a photon or electron beam) in the case of solid sample analysis. The resulting ions are then accelerated and subjected to an electromagnetic field resulting in varying deflection of the ions based on their respective mass-to-charge ratios. A detector (e.g., electron multiplier) is then used to detect and quantify particles having the same mass-to-charge ratios. The results of such analysis are generally presented as a spectrum indicating the relative amount of detected ions having the same mass-to-charge ratio. By correlating the masses of the ions obtained during analysis with known masses for atoms and molecules, the specific atom or molecule for each component of the spectra may be identified, quantified, and the general composition of the sample can be obtained.

Conventional mass spectrometry systems are complex and costly instruments that generally require significant capital investment, space, and training to operate. Moreover, many such systems are limited in their ability to effectively analyze both organic and inorganic components of a given sample.

With these thoughts in mind among others, aspects of the analysis systems and methods disclosed herein were conceived.

### SUMMARY

In one aspect of the present disclosure, a system for performing sample analysis is provided. The system includes a sample chamber and an aperture plate defining an aperture having an aperture axis. The aperture axis is aligned with a sample location within the sample chamber such that, when a sample is disposed within the sample chamber below the aperture plate and a beam is applied to the sample along the aperture axis, a cloud of material removed from the sample by the beam passes through the aperture. The system also includes an ion extractor assembly defining an ion extraction path and including an ion extractor tip. The ion extractor tip is disposed within the sample chamber and defines an ion extractor inlet. The ion extractor inlet is disposed above the aperture and offset from the aperture axis. The system further includes a mass spectrometer in communication with the ion extractor assembly along the ion extraction path and configured to receive ionized material from the ion extractor assembly and to analyze the ionized material. The ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by applying an ionization beam to the cloud of material toward the ion extractor inlet and along the ion extraction path.

In another aspect of the present disclosure, a method of performing sample analysis is provided. The method includes generating a rejection field within a sample chamber of a sample analysis system, the rejection field shaped to direct ions of a cloud of material away from an ion extraction path of an ion extractor assembly. The ion extractor assembly is operably connected to a mass spectrometer and the cloud of material is produced by applying a beam to a sample within the sample chamber. The method further includes generating an acceptance field within the sample chamber, the acceptance field shaped to direct ionized material toward the ion extraction path, wherein the ionized material is generated by applying an ionization beam to the cloud of material subsequent to generating the rejection field.

In yet another aspect of the present disclosure, a system is provided. The system includes a sample chamber and an aperture plate defining an aperture having an aperture axis, the aperture axis aligned with a sample location within the sample chamber. The system also includes a first laser source configured to deliver a first beam along a first beam path to produce a cloud of material from a sample disposed at the sample location and a second laser source configured to deliver a second beam along a second beam path to produce ionized material from the cloud of material at an ionization location, wherein the ionization location is between the sample location and the aperture. An ion extractor assembly of the system defines an ion extraction path and includes an ion extractor tip. The ion extractor tip is disposed within the sample chamber and defines an ion extractor inlet disposed above the aperture and offset from the aperture axis. The system also includes a mass spectrometer in communication with the ion extractor assembly along the ion extraction path, the mass spectrometer configured to receive ionized material from the ion extractor assembly and to analyze the ionized material. The ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by the second beam along the ion extraction path.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1A is a schematic illustration of an analysis system according to an implementation of the present disclosure.

FIG. 1B is a detailed schematic illustration of a mounting assembly of the analysis system of FIG. 1A.

FIG. 2 is a schematic illustration of an image capture system for use in conjunction with the analysis system of FIG. 1A.

FIGS. 3A and 3B are schematic illustrations of halves of a kinematic mounting system as may be incorporated into either of the analysis system of FIG. 1A and the image capture system of FIG. 2.

FIG. 4 is a graphical representation of the relationship between images and results data obtained during analysis of a sample, such as by using the system of FIG. 1A.

FIGS. 5A-5D are a flow diagram for a method of analyzing a sample in accordance with the present disclosure. More specifically, FIG. 5A illustrates initial preparation of the sample and analysis system, FIG. 5B illustrates general operation of the analysis system, FIG. 5C illustrates the steps involved in analyzing each of organic and inorganic components of a sample, and FIG. 5D illustrates quantification of the analysis and feedback to improve operation of the analysis system.

FIG. 6 is a flow chart illustrating a method for processing mass spectrometry data collected during analysis of organic or inorganic material obtained from a sample.

FIG. 7 is a schematic illustration of a second analysis system in accordance with the present disclosure in a closed configuration.

FIG. 8 is a schematic illustration of the analysis system of FIG. 7 in an open configuration.

FIG. 9 is a schematic illustration of a macro-level imaging device assembly of the analysis system of claim 7.

FIG. 10 is a schematic illustration of an optical assembly of the analysis system of claim 7.

FIG. 11 is a schematic illustration of an ion extraction system of the analysis system of claim 7.

FIG. 12 is a schematic illustration of a sample chamber of the analysis system of claim 7.

FIG. 13 is a cross-sectional view of another analysis system according to the present disclosure.

FIG. 14 is a detailed cross-sectional view of the analysis system of FIG. 13 with emphasis on an ion extraction assembly of the analysis system.

FIG. 15 is an isometric view of a modular component including elements of the ion extraction assembly of FIG. 14.

FIG. 16 is a cross-sectional view of the modular component of FIG. 15.

FIG. 17 is a cross-sectional view of the ion extraction assembly of FIG. 13 illustrating movement of particles and ions during operation of the analysis system.

FIGS. 18A and 18B are illustrations of a rejection field and an acceptance field, respectively, and corresponding ion paths produced during operation of the ion extraction assembly of FIG. 13.

FIG. 19 is a detailed cross-sectional view of the ion extraction assembly of the system of FIG. 13 illustrating various geometric relationships between components of the assembly.

FIG. 20 is an isometric view of an aperture plate of the ion extraction assembly of FIG. 13.

FIG. 21 is a cross-sectional view of the aperture plate of FIG. 20.

FIGS. 22A-22C illustrate different arrangements of an inner cone and an outer cone of the ion extraction assembly of FIG. 13 and the effect of relative cone placement on the field produced by the ion extraction assembly.

FIGS. 23A and 23B illustrate different angular orientations of a repelling plate of the ion extraction assembly of FIG. 13 and the effect of repelling plate angular orientation on the field produced by the ion extraction assembly.

FIGS. 24A and 24B illustrate different offsets of the repelling plate of the ion extraction assembly of FIG. 13 and the effect of repelling plate offset on the field produced by the ion extraction assembly.

FIGS. 25A-25C illustrate different repelling plate sizes and the effect of repelling plate size on the field produced by the ion extraction assembly.

FIG. 26 is a detailed cross-sectional view of an ion bender assembly of the ion extractor assembly of FIG. 13.

FIG. 27 is a top view of the ion bender assembly of FIG. 26 illustrating a split lens arrangement.

FIG. 28 is a detailed view of the ion bender assembly of FIG. 26 with a gate valve in a closed configuration.

FIG. 29 is a detailed view of the ion bender assembly of FIG. 26 with the gate valve in a open and electrically chargeable configuration.

FIG. 30 is a schematic illustration of the ion bender assembly of FIG. 26 emphasizing the various electrically chargeable components of the ion bender assembly.

FIG. 31 is a detailed cross-sectional view of the analysis system of FIG. 13 including a glass shield assembly.

FIG. 32 is a block diagram illustrating control of the glass shield assembly.

FIG. 33 is an isometric view of an ion processing chamber of the analysis system of FIG. 13 illustrating external components of the glass shield assembly.

FIG. 34 is an isometric view of the ion processing chamber of FIG. 33 with an external housing removed.

FIG. 35 is an isometric view of the glass shield assembly.

FIG. 36 is a bottom isometric view of the glass shield assembly.

FIG. 37A is a side view of the glass shield assembly.

FIG. 37B is a cross-sectional side view of the glass shield assembly.

FIG. 38 is a top view of a labyrinth gear of the glass shield assembly.

FIG. 39 is an isometric view of a sample chamber of the analysis system of FIG. 13 with an external housing partially removed.

FIG. 40 is a partial cross-sectional view of the sample chamber of FIG. 39 illustrating a second glass shield assembly.

FIG. 41 is another isometric view of the sample chamber of FIG. 39 with a cover removed to show a glass shield of the second glass shield assembly.

FIG. 42 is another isometric view of the sample chamber of FIG. 39 with the glass shield removed to show a coupling of the second glass shield assembly.

FIG. 43 is an external isometric view of the sample chamber of FIG. 39 illustrating a drive system of the second glass shield assembly.

FIG. 44 is a block diagram illustrating a computer system as may be included in analysis systems according to this disclosure.

### DETAILED DESCRIPTION

Aspects of the present disclosure involve systems and methods for analyzing a sample using mass spectrometry and, in particular, for efficiently analyzing both organic and inorganic components of the sample. Analysis systems according to the present disclosure implement an extraction and ionization technique in which both organic and inorganic material may be extracted from a sample, ionized, and analyzed. For example, in a first stage of the analysis process, organic material may be desorbed from a location of a sample to form a vapor cloud. The vapor cloud is then ionized and the resulting ions may be transported to a mass spectrometer for analysis. In a second stage of the analysis process, non-organic material may be ablated from the sample, forming a particle cloud. The particle cloud may then be ionized and the resulting ions transported to the mass spectrometer for analysis.

To facilitate the foregoing processes, systems according to the present disclosure include a single laser source and various optical elements to produce beams suitable for each of desorption and ablation. For example, in one implementation, the system includes a neodymium-doped yttrium aluminum garnet (Nd:YAG) laser used to produce a source beam for producing each of a relatively low energy beam (e.g., in the infrared (IR) range) for heating and desorbing organic material from the sample and a relatively high energy beam (e.g., in the ultraviolet (UV) range) beam capable of ablating inorganic material from the sample. Lasers included in systems according to this disclosure may be pulsed lasers with any of a range of suitable timescales. For example, and without limitation, lasers implemented in systems of this disclosure may include femtosecond, picosecond, and/or nanosecond scale lasers.

In certain implementations, the laser source may be configured to have a fundamental wavelength and other characteristics that correspond to one of the desorption beam or the ablation beam. In such implementations, production of the desorption/ablation beam from the source beam may include redirecting and/or passing the source beam without modifying other characteristics of the source beam. Stated differently, in the context of the present disclosure, a source beam generally refers to a beam as it exits a laser source while a beam produced from the source beam generally refers to a beam as it is delivered to perform its particular functionality (e.g., ablation, desorption, ionization), regardless of whether characteristics of the source beam have been modified to generate the final beam. For purposes of the present disclosure, the terms “desorption/ablation (D/A) beam” and “material removal beam” are used to refer collectively to beams for removing material from a sample for analysis, regardless of whether the removed material is organic or inorganic and whether the beams remove material by desorption or ablation of the sample.

Each of the desorbed organic material and the ablated inorganic material are subsequently ionized using a second laser system including a second laser source and corresponding optics. In one implementation, the second laser system is configured to produce a relatively high energy beam (e.g., in the UV range) and is directed to intersect the vapor cloud and the particle cloud produced by the desorption and ablation processes, respectively. In certain implementations, the second laser source may also be a Nd:YAG laser and the second laser system may include optical elements to produce an ionization beam having a wavelength of 266 nm. The resulting ions are then extracted and transported (e.g., by applying an electrostatic potential using an electrostatic lens system such as an Einzel lens, quadrupole ion guide, or ion funnel) as an ion beam into a mass spectrometer. Mass spectrometry data is then collected and quantified.

Conventional techniques, such as laser-induced breakdown spectroscopy (LIBS) and laser ionization mass spectroscopy (LIMS), which only use plasma generated by an initial ablation laser, have fundamental weaknesses centered around low ionization efficiency and matrix effects (i.e., the effects on the analysis caused by components of the sample other than the specific component to be quantified). These shortcomings lead to difficulty with quantification and have contributed to the difficulty in fully commercializing such technologies across multiple fields and applications. For example, reasonable quantification of LIBS data requires sample standard matching and, therefore, is highly subject to matrix effects. Therefore, LIBS has been difficult to use in applications in which a variety of matrices may be used and requires a significant amount of data reduction.

In contrast, in various possible examples, the techniques described herein may have the advantage of ionizing from the neutral vapor cloud or particle cloud resulting from ablation. These clouds are significantly less variable across different matrices and more closely represents the sample constituents and their proportions within the sample. Accordingly, the techniques described herein have significant potential to quantify multi-matrix samples using uniform or algorithmically adjusted quantification schema.

Implementations of the present disclosure may further include imaging systems, such as camera systems, for capturing images of samples prior to, during, or subsequent to analysis. For example, the analysis system may include a first camera system to capture images of the sample at a large or “macro” scale. The analysis system may further include a camera system configured to capture a detailed or “micro” image of a specific location of the sample being to be analyzed. Such images may be associated with any captured data, allowing users to visually analyze a sample at a macro level, visually identify particular regions of interest of the sample, readily obtain detailed data for such regions, and perform various other functions.

In addition to the foregoing, various other advantages may be associated with implementations of the present disclosure. For example, the implementations of the present disclosure may be static systems. Such systems may operate using a vacuum chamber within which no gases are required since ionization does not require an inductively coupled plasma source. Doing so eliminates molecular isobars that may hinder detection of elements such as, but not limited to, silicon, potassium, calcium, and iron. Moreover, the two-step multiphoton ionization source allows for an algorithmic approach to quantification. The absence of hot, inductively coupled plasma also eliminates the thermal emission of contaminant ions from the cones and injector that may hinder the analysis of sodium, lead, and many volatile metals. Rather, in implementations of the present disclosure, ions are sourced only from the sample spot under ablation.

Implementations of the present disclosure also may have considerable advantage regarding the transmission efficiency of the generated ion beam. For example, laser ablation inductively coupled plasma mass spectrometry (LA-ICP-MS) has a high ionization efficiency (>90%) for elements with a first ionization potential of approximately 8 eV or less and has a relatively low transmission efficiency of about 0.01-0.001% (i.e., approximately 1 in every 10⁵-10⁶ ions reach the detector). This is largely due to the fact the ions are created in atmosphere (argon plasma) and are then transferred to the mass spectrometer in stages until reaching the ultimate high-vacuum mass filter. The transition through these stages is done through a system of cones and lenses that removes a significant portion of ions. In contrast, the techniques discussed herein do not suffer from transmission losses across atmosphere to vacuum systems as the entirety of the process is conducted under vacuum.

Another advantage of the presently disclosed system is its ability to efficiently analyze both organic and inorganic matter. Organic analysis is performed in at least certain implementations of the present disclosure using an infrared component of the Nd:YAG laser (1064 nm). A long-pass cut-on filter (or similar filtering element) may then be placed in the beam path allowing for the transmission of IR energy while blocking UV energy. The IR pulse may then be used to flash heat the sample. By flash heating (e.g., on the order of 10⁸ K/s), the organic compounds are desorbed from the sample surface intact where lower heating rates may result in undesirable decomposition of the organic material.

Other advantages of implementations of the present disclosure relate to their overall size, efficiency, and cost-effectiveness as compared to conventional analysis systems. For example, by using laser sources for multiple purposes (e.g., desorption and ablation, multi-energy level ionization) and making specific use of optics to redirect beams from such laser sources, the overall size and shape of the analysis system may be reduced. As a result, implementations of the present disclosure are generally suitable for benchtop and/or field applications that would otherwise be problematic or simply not possible for conventional systems.

These and other features and advantages of systems according to the present disclosure are provided below.

### Analysis System Components and Design

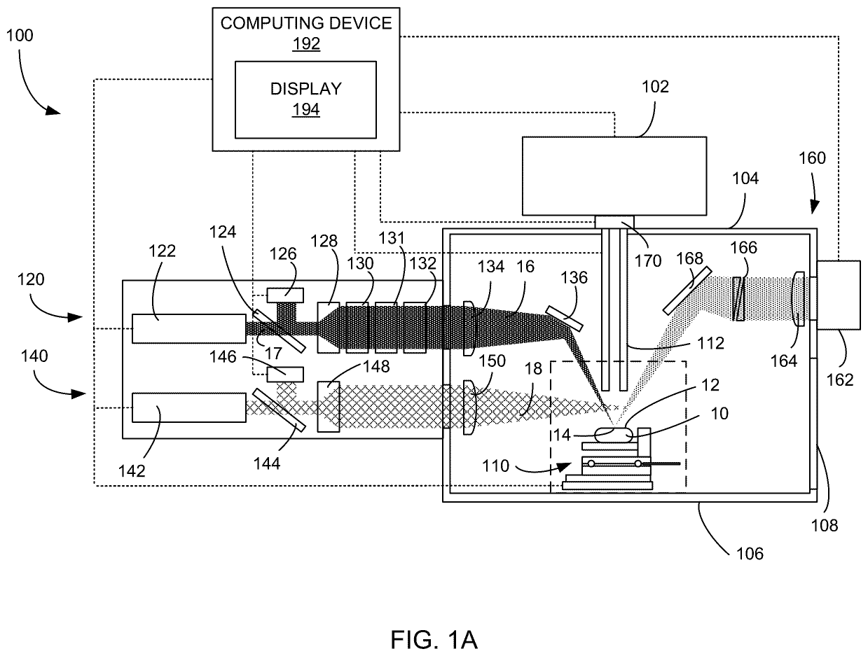

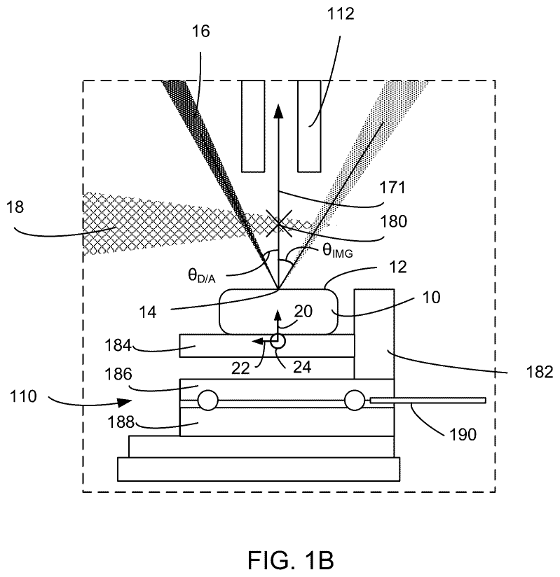

FIG. 1A is a schematic illustration of an analysis system 100 in accordance with the present disclosure. In general, the analysis system 100 includes a sample chamber 104 within which a sample 10 is disposed for analysis by a mass spectrometer 102. The analysis system 100 may be capable of operating in multiple modes to facilitate analysis of both organic and inorganic material of the sample 10. Generally, and as described below in further detail, the analysis system 100 includes a desorption/ablation (D/A) sub-system 120 to selectively apply energy to desorb organic material from the sample 10 or to ablate inorganic material from the sample 10. The desorbed or ablated material is then ionized using an ionization sub-system 140. The ionized material is then directed to a mass spectrometer 102 for analysis. In certain implementations, the mass spectrometer 102 is a time-of-flight (ToF) mass spectrometer.

The analysis system 100 further includes a computing device 192. The computing device 192 may take various forms, however, the computing device 192 generally includes one or more processors and a memory including instructions executable by the one or more processors to perform various functions of the analysis system 100. In one implementation, the computing device 192 may be physically integrated with the other components of the analysis system 100. For example, the computing device 192 may be a panel, tablet, or similar computing device integrated into a wall of the sample chamber 104. In other implementations, the computing device 192 may be a separate device operably coupled to the other components of the analysis system 100. Coupling between the computing device 192 and the components of the analysis system 100 may be wireless, wired, or any combination and may use any suitable connection and communication protocol for exchanging data, control signals, and the like. To facilitate interaction with the analysis system 100, the computing device 192 may include various input and output devices including, but not limited to, a display 194 (which may be a touchscreen); a microphone; speakers; a keyboard; a mouse, trackball, or other pointer-type device; or any other suitable device for receiving input from or providing output to a user of the analysis system 100.

The sample chamber 104 generally includes a vacuum chamber 106 accessible, e.g., by a chamber door 108 or similar sealable opening. During operation, the sample 10 may be supported within the sample chamber 104 by a mount 110. In certain implementations, the mount 110 may be motorized or otherwise movable such that the sample 10 may be repositioned within the vacuum chamber 106. By doing so, analysis of the sample 10 may be conducted at multiple locations without removing the sample 10 from the vacuum chamber 106. As described in further detail below, the mount 110 may be configured to move incrementally and with a high degree of precision to facilitate mapping and analysis of the sample 10. FIG. 1B provides a more detailed view of the mount 110 and associated components of the analysis system 100.

The D/A sub-system 120 is generally configured to provide beams of at least two distinct wavelengths to a surface 12 of the sample 10 for purposes of removing material from the sample 10. To do so, the D/A sub-system 120 includes a D/A laser source 122 for producing a source beam and optical elements configured to generate the different material removal beams from the source beam. In at least certain implementations, the D/A sub-system 120 may produce a first material removal beam having a first wavelength and that is generally used to heat the sample 10 and desorb organic material from the sample 10 without substantially decomposing the organic material or damaging the surface 12 of the sample 10. The organic vapor cloud produced by the desorption process may then be energized by the ionization sub-system 140 and the resulting ionized vapor cloud may be directed to the mass spectrometer 102 for analysis, such as by a quadrupole ion guide 112 (or similar guide device, such as, but not limited to an Einzel lens or a series of lenses). The D/A sub-system 120 may also produce a second material removal beam having a second wavelength, the second material removal beam having a higher energy density than the first material removal beam such that the second material removal beam is suitable for ablation of inorganic material from the surface 12 of the sample 10. Similar to the organic vapor cloud produced by desorption, the particle cloud produced by ablation may be ionized by the ionization sub-system 140. In certain implementations, such ionization may occur after a delay to allow plasma generated during the ablation process to extinguish. The resulting ionized particle cloud may then be directed to the mass spectrometer 102 for analysis by the quadrupole ion guide 112 (or similar guide device). In certain implementations, a gate valve 170 or similar mechanism may be disposed between the ion guide 112 and the mass spectrometer 102, for example and among other things, to reduce pump down time between samples, to keep the mass spectrometer 102 under high vacuum conditions, and to reduce exposure to air.

The optical elements of the D/A sub-system 120 are generally used to produce a material removal beam 16 from a source beam 17 of the D/A laser source 122 and to direct the produced material removal beam (which may be either a desorption or ablation beam) to an analysis location 14 of the sample 10. In instances where the fundamental wavelength of the material removal beam 16 differs from that of the source beam 17, producing the material removal beam 16 from the source beam 17 may include modifying the fundamental wavelength of the source beam 17, e.g., by filtering the source beam 17. The energy density of the material removal beam 16 at the analysis location 14 may also be controlled to facilitate desorption or ablation. Direction of the removal beam 16 may be achieved, for example, by one or more mirrors disposed within the vacuum chamber 106, such as mirror 136, positioned to direct the beam 16 from an initial beam direction to an incident beam direction having a particular angle of incidence (θ_{D/A}, shown in FIG. 1B) relative to a normal 171 defined by a surface 12 of the sample 10. The value of θ_{D/A} may vary based on the location of the optical elements of the D/A sub-system 120, the location of the D/A laser source 122 relative to the surface 12 of the sample 10, and the general size and shape of the vacuum chamber 106. However, in at least some implementations of the present disclosure, θ_{D/A} is from and including about 15 degrees to and including about 45 degrees. In one specific implementation, θ_{D/A} is about 40 degrees. Among other things, such values for θ_{D/A} may allow for a relatively small form factor for the analysis system 100 (e.g., by avoiding interference of the mirror 136 and other optical components with the ion guide 112) while ensuring that sufficient energy is delivered to the surface 12 of the sample 10 to desorb/ablate.

As noted above, optical elements of the D/A sub-system 120 may also be used to control or modify characteristics of the source beam 17 to produce the material removal beam 16. Such processing may include, among other things, modifying fundamental wavelengths, attenuating, focusing/diffusing, or splitting the source beam 17 or any intermediate beams produced during the process of producing the material removal beam 16 from the source beam 17. As a first example, the D/A sub-system 120 may include at least one filter 130 to produce a beam having a fundamental wavelength that is a harmonic wavelength of the source beam 17. In other implementations, the filter 130 may include multiple selectable filter elements configured to change the wavelength of a beam entering the filter element (e.g., the source beam 17) from a fundamental wavelength of the beam to one of several harmonic wavelengths of the beam. In either case and in at least certain implementations, the filter 130 may be in the form of an electronically controlled filter wheel that allows automatic or manual application or removal of one or more filters to facilitate production of the material removal beam 16.

The D/A laser source 122 may include various types of laser sources, however, to facilitate a relatively compact form factor, in at least certain implementations of the present disclosure the D/A laser source 122 includes a miniaturized, high-powered, solid-state laser. For example, and without limitation, the D/A laser source 122 may be a neodymium-doped yttrium aluminum garnet (Nd:YAG) laser. In one specific example, the Nd:YAG laser may produce a source beam having a fundamental wavelength of 1064 nm, i.e., within the infrared (IR) range. In such implementations, the source beam may be passed through the D/A sub-system 120 without altering its fundamental wavelength such that the resulting material removal beam also has a fundamental wavelength of 1064 nm and may be used for desorbing organic matter from the sample 10. When ablation is to occur, a filter or other optical elements of the D/A sub-system 120 may be applied to the source beam such that the material removal beam produced from the source beam has a wavelength of 266 nm (e.g., the fourth harmonic wavelength of the original 1064 nm beam) or 213 nm, falling in the ultraviolet (UV) range. This material removal beam may then be used to ablate the sample 10 at the analysis location 14 for analysis of inorganic matter.

A Nd:YAG lasers is provided merely as an illustrative example of a laser that may be implemented as the D/A laser source 122. As noted, desorption of organic material in the context of the current disclosure refers to the process of supplying energy from a beam to the sample to produce a vapor cloud of organic material of the sample. Ablation of inorganic material, on the other hand, refers to the process of supplying energy from a beam to the sample to generate an ionized particle cloud from inorganic matter of the sample. Accordingly, any laser having a beam that may be used in the production of each a first beam for use in desorbing organic material from a sample and a second beam for use in ablating inorganic material from the same sample may be used. Various processes and techniques for selecting such a laser are known in the art and, as a result, are not described in detail within this disclosure. Accordingly, while an Nd:YAG laser is used herein as a primary example of a laser suitable for use as the D/A laser source 122, implementations of this disclosure are not limited to Nd:YAG lasers. Rather, those of skill in the art, given the teachings herein, would understand and know how to identify and select other types of lasers suitable for use in implementations of this disclosure.

Similarly, while 1064 nm and 266 nm/213 nm are provided as examples of suitable wavelengths for desorption and ablation, respectively, implementations of the present disclosure are not limited to those particular wavelengths. Rather, as is known in the art, desorption of organic material and ablation of nonorganic material may be achieved using beams of various wavelengths. As discussed herein, whether a given beam results in desorption or ablation is generally a function of, among other things, the sample composition, the total energy delivered to the sample, and the rate at which that energy is delivered to the sample. Although wavelength is one factor related to the energy delivered by the beam, other aspects of the beam (e.g., width, duty cycle, etc.) may be used to control the total energy delivered and, as a result, the occurrence of desorption or ablation. Accordingly, while 1064 nm is used herein as the primary example wavelength for the desorption beam and 266 nm is used herein as the primary example wavelength for the ablation beam, implementations of the present disclosure are not limited to those wavelengths and those of skill in the art, given the teachings herein, would be able to determine other suitable wavelengths.

In each of the desorption and ablation cases, the material removal beam 16 or intermediate beams between the source beam 17 and the material removal beam 16 may also be attenuated, expanded, or focused to modify the power density at the sample 10. Accordingly, the D/A sub-system 120 may further include one or more of a beam expander 128, one or more attenuators (e.g., UV attenuator 131 and IR attenuator 132), and a focusing lens 134. The D/A sub-system 120 may also include multiple beam expanders, attenuators, focusing lenses, or similar optical elements, as required by the particular application. Beam expanders used in implementations of the present disclosure may be fixed or variable and attenuators may be included for attenuating beams having specific wavelengths or ranges of wavelengths. For example, as previously discussed, in at least one implementation, the D/A sub-system 120 may produce a material removal beam in either the IR or UV range for desorption and ablation, respectively. In such implementations, one or both of an IR attenuator and a UV attenuator may be included in the D/A sub-system 120 to further tune the energy of beams within the D/A sub-system 120. Finally, the focusing lens 134 may be configured such that the material removal beam has a particular size and, as a result, particular energy density at the surface 12 of the sample 10.

As previously discussed, in at least one example the D/A laser source 122 is a Nd:YAG laser capable of producing a desorption beam with a fundamental wavelength of 1064 nm. The optics of the D/A sub-system 120 may be configured such that the beam width and/or energy density of the desorption beam is sufficient and suitable for thermal desorption of organics of various molecular sizes without causing decomposition. For example, when operating in a desorption mode, the D/A sub-system 120 may generate a desorption beam with a wavelength of 1064 nm and an energy density at the surface 12 of the sample 10 from and including about 10 MW/cm² to and including about 150 MW/cm². In certain implementations, the optics of the D/A sub-system 120 may also be configured to focus the desorption beam to be no more than about 50 μm in diameter at the surface 12 of the sample 10. As discussed below in further detail, doing so allows multiple samples to be taken from the sample 10 at a relatively high sample density to facilitate thorough analysis of the sample 10.

With respect to ablation and as previously noted, the 1064 nm beam of the Nd:YAG laser may be filtered to produce an ablation beam having a wavelength of 266 nm. The optics of the D/A sub-system 120 may be configured such that the beam width and/or energy density of the ablation beam is sufficient and suitable for breaking bonds of non-organic matter of the sample. For example, in at least one implementation, when operating in an ablation mode, the D/A sub-system 120 generates an ablation beam with a wavelength of 266 nm and an energy density at the surface 12 of the sample 10 from and including about 1 GW/cm² to and including about 100 GW/cm². Again, the optics of the D/A sub-system 120 may also be configured to focus the ablation beam to be no more than about 50 μm in diameter at the surface 12 of the sample 10.

Although 50 μm is provided above as an example diameter of the desorption and ablation beams as the surface 12 of the sample 10, it should be appreciated that the diameter of the beam may vary between implementations of the present disclosure and may also be variable within a given implementation. For example, any suitable number of fixed or variable beam expanders and/or focusing lenses (such as the beam expander 128 and the focusing lens 134) may be implemented in the D/A sub-system 120 to achieve various beam widths and, as a result various energy densities of the beam at the sample 10.

As illustrated in FIG. 1A, the D/A sub-system 120 may further include at least one beam splitter 124 configured to split a beam within the D/A sub-system 120 and direct a portion of the beam to an energy meter 126. The energy meter 126 may be used to measure the energy of the beam. Such energy values may be used as a feedback or similar mechanism to facilitate control of the analysis system 100, as inputs to one or more equations or algorithms used to analyze the sample 10, or any other use related to the operation of the analysis system 100 or processing of data obtained by the analysis system 100.

To facilitate analysis of each of the desorbed organic material and ablated inorganic material, the analysis system 100 may include an ionization sub-system 140 configured to ionize the organic and inorganic material removed from the sample 10 as a result of desorption or ablation. Similar to the D/A sub-system 120, the ionization sub-system 140 generally includes an ionization laser source 142 and various optical elements for manipulating an ionization beam generated by the ionization laser source 142.

In general, the ionization sub-system 140 produces an ionization beam for exciting, at least in part, one or both of the vapor cloud created by the desorption process and the particle cloud generated by the ablation process. In one specific implementation, the beam generated by the ionization sub-system 140 excites the vapor/particle cloud using multiphoton ionization (MPI). In general, MPI provides a relatively efficient method of generating ions (as compared to argon plasma of inductively coupled plasma processes) across a wide range of ionization energies. For example, the ionization sub-system 140 may implement MPI such that it is capable of generating ions having ionization potential of approximately 9.3 eV or less. MPI is further advantageous in that it is capable of ionizing a range of particles as compared to other techniques, such as resonant enhanced multiphoton ionization (REMPI), which generally require tuning of the ionization beam to a particular ionization frequency to excite particular molecules or particles.

In certain specific implementations, the ionization laser source 142 may be a Nd:YAG laser and the ionization sub-system 140 may be configured to provide an ionization beam having a wavelength of 213 nm or 266 nm. However, as was the case with the D/A laser source 122, a Nd:YAG laser is provided merely as an illustrative example of a laser that may be implemented as the ionization laser source 142. More generally, any suitable laser source may be used in conjunction with the broader ionization sub-system 140 provided that the ionization sub-system 140 generates a beam for ionizing material that has been desorbed or ablated from the sample 10. Various processes and techniques for selecting a laser suitable for producing an ionization beam are known in the art and, as a result, are not described in detail within this disclosure. Accordingly, while an Nd:YAG laser is used herein as a primary example of a laser suitable for use as the ionization laser source 142, implementations of this disclosure are not limited to Nd:YAG lasers. Rather, those of skill in the art, given the teachings herein, would understand and know how to identify and select other types of lasers and similar energy sources that suitable for producing an ionization beam.

The vapor cloud created by the desorption process and the particle cloud generated by the ablation process may rise substantially normal to the surface 12 of the sample 10. Accordingly, as illustrated in FIG. 1A, in at least some implementations of the present disclosure, the ionization sub-system 140 may be configured to direct the ionization beam parallel to the surface 12 of the sample 10 and, as a result, through the vapor cloud or particle cloud produced from the sample 10.

Although various types of laser sources may be used for the ionization laser source 142, in at least one implementation, the ionization sub-system 140 produces a beam having a wavelength of 266 nm. The ionization sub-system 140 may also be configured such that the ionization beam produced has a particular beam width and/or energy density at an ionization location disposed above the surface 12 of the sample 10. For example, in one implementation the ionization beam may be focused on a particular location 180 above the sample 10 such that the ionization beam has an energy density of at least about 1 GW/cm² at the location 180. To do so, the ionization sub-system 140 may include various optical elements including, without limitation, an attenuator 148, and a focusing lens 150. In other implementations filters and/or other optical elements may also be included in the ionization sub-system 140 for further control of the ionization beam. Similar to the D/A sub-system 120, the ionization sub-system 140 may further include at least one beam splitter 144 configured to split a beam of the ionization sub-system 140 and to direct a portion of the beam to an energy meter 146. The energy meter 146 may be used to measure the energy of the ionization beam 18 to facilitate control of the analysis system 100.

In one specific example, the ionization sub-system 140 may include optics to control the intensity of the ionization beam 18 depending on whether the analysis system 100 is performing analysis of organic or inorganic matter. In the case of the former, optical elements, such as filters and attenuators, may be used to reduce the energy of the ionization beam from a first energy level suitable for ionizing ablated inorganic material to a second energy level suitable for ionizing desorbed organic material. For example, the second energy level may be chosen to decrease or eliminate the likelihood of fragmentation effects that may be caused if the desorbed organic material were to be ionized using the same energy level as required during the ablation process.

Application of the ionization beam to the vapor/particle cloud may occur after a particular delay following the completion of desorption or ablation, respectively. In the case of ablation in particular, such a delay may be implemented to allow any plasma produced during the ablation process to extinguish. While the duration of the delay may vary between specific applications, in at least one implementation, the delay may be from an including about 10 ns up to and including about 1 μs between the completion of ablation and the application of the ionization laser to the resulting particle cloud.

As further illustrated in FIG. 1A, the analysis system 100 may also include an imaging system 160 for capturing images of the sample 10 and, in particular, for capturing detailed images of specific portions of the sample subject to desorption and/or ablation. In certain implementations, the imaging system 160 may include an imaging device 162 and may further include multiple optical elements for directing light reflected off the surface 12 of the sample 10 to the imaging device 162. In at least certain implementations, the imaging device 162 may be a camera adapted to capture images of the sample 10 in the visible light range or in a broader range, such as a range including one or both of UV and IR wavelengths. In other implementations, the imaging device 162 may be or otherwise include an interferometer or other similar imaging device capable of capturing topographical information of the sample 10.

In certain implementations, the internal volume of the vacuum chamber 106 and placement of the quadrupole ion guide 112 normal to the surface 12 of the sample 10 may require the imaging device 162 to be indirectly aligned with the surface 12 of the sample 10. Accordingly, the optical elements of the imaging system 160 may be used to facilitate placement of the imaging device 162 at a suitable offset relative to the surface 12 while still enabling proper capture of a current analysis location of the surface 12. For example, and without limitation, in at least one implementation, the imaging system 160 may include an objective lens 164, one or more prisms (e.g., prism pair 166), and a mirror 168 in to achieve a relatively tight angle of incidence to the sample surface 12. In at least one implementation, the angle of incidence associated with the imaging system 160 (θ_{IMG}, shown in FIG. 1B) is at least approximately 24 degrees, which generally permits light to exit the vacuum chamber 106 to the imaging device 162 in a substantially parallel direction relative to the top surface of the sample 10 while still allowing capture of a high quality image by the imaging device 162.

As previously noted, and with reference to FIG. 1B, the sample 10 may be retained within the vacuum chamber 106 on a mount 110. The mount 110 may be movable such that an analysis location 14 of the sample 10 may be varied. The mount 110 may be manually or automatically adjustable in multiple directions to ensure a predetermined size and location of the beam 16. For example, the mount 110 may be adjustable in along a first axis 20 (e.g., a z- or vertical axis) to ensure that the analysis location 14 is disposed at a particular height relative to the ion guide 112. The mount 110 may also be movable along each of a second axis 22 and a third axis 24 (e.g., an x-axis and y-axis or similar axes of a horizontal plane) to change the location of the analysis location 14 relative to the surface 12 of the sample 10.

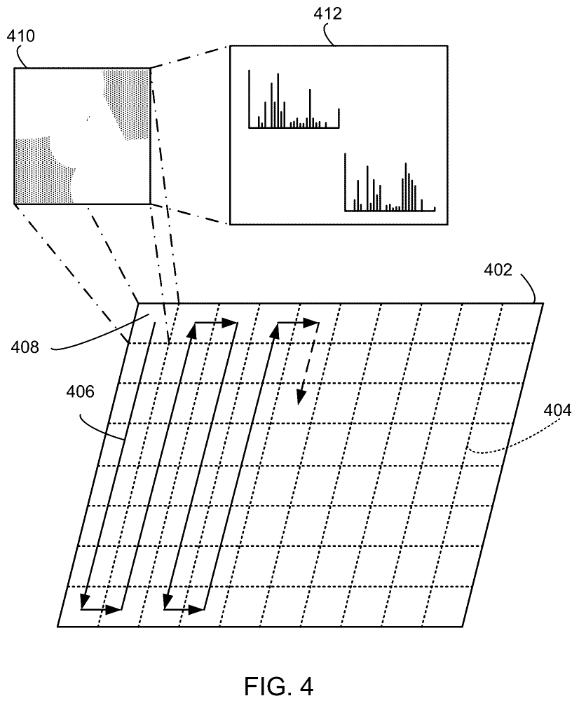

In at least one implementation, the analysis system 100 may be configured to execute an analysis routine in which successive analyses are conducted at different locations of the sample 10. For example, and as discussed below in further detail in the context of FIG. 4, the analysis system 100 may be configured to analyze a sample according to a grid pattern. For each element of the grid, the analysis system 100 may capture a detailed image using the imaging system 160 and perform either or both of an organic analysis and inorganic analysis at the location. Following analysis at a location, the analysis system 100 may be configured to move the mount 110 such that the analysis location 14 is changed relative to the surface 12 of the sample 10. By automating such a process, a sample may be thoroughly analyzed while requiring only minimal intervention from an operator.

In certain implementations, the mount 110 may include a kinematic mount system. In general, a kinematic mount (or kinematic coupling) is a fixture designed to constrain a component in a particular location with high degrees of certainty, precision, and repeatability. Kinematic mounts generally include six contact points between a first part and a second part such that all degrees of freedom of the first part are constrained. Examples of kinematic mounts include, without limitation, Kelvin and Maxwell mounts. In a Maxwell mount, for example, three substantially V-shaped grooves of a mounting surface are oriented to a center of the part to be mounted, while the part being mounted has three corresponding curved surfaces (e.g., hemispherical or spherical surfaces) configured to sit down into the three grooves. The grooves may be cut into the mounting surface or formed by parallel rods (or similar structures) coupled to the mounting surface. When the curved surfaces are disposed in the grooves, each of the grooves provides two contact points for the respective curved surface, resulting in a total of six points of contact that fully constrain the part.

As illustrated in FIG. 1B, in implementations in which a kinematic mount is used, the mount 110 may include a sample holder 182 including a sample stage 184 and a kinematic base 186, the sample holder 182 being removable from the vacuum chamber 106. During use, the sample 10 is placed and retained on the sample stage 184 while the sample holder 182 is outside of the vacuum chamber 106. Once the sample 10 is coupled to the sample stage 184, the sample holder 182 is disposed within the vacuum chamber 106. More specifically, the kinematic base 186 of the sample holder 182 is received by and kinematically coupled to a kinematic mounting surface 188 disposed within the vacuum chamber 106. The mount 110 may further include a magnetic or other latch 190 to fix the kinematic base 186 to the kinematic mounting surface 188. The latch 190 may be integrated into either the sample holder 182 or the kinematic mounting surface 188.

In addition to repeatable placement of the sample 10 within the vacuum chamber 106, implementation of kinematic mounting may also facilitate the generation of composite images and composite image stacking. For purposes of the present disclosure, composite image stacking generally refers to the process of linking one or more low scale images of the sample 10 with multiple large scale images, each of which corresponds to a portion of the low scale image. For example, the small scale image may correspond to an overall image of the entire sample (or a relatively large portion of the sample 10, e.g., a quarter of the sample) while the large scale images may correspond to specific locations of the sample 10 at which organic/inorganic sampling and analysis is conducted.

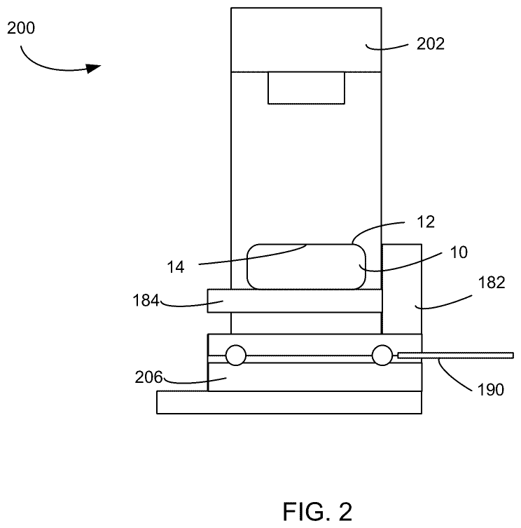

FIG. 2 is a schematic illustration of an image capture system 200 that may be used in conjunction with the analysis system 100 of FIG. 1A to facilitate composite image stacking and, in particular, to capture small scale/macro images of the sample 10 prior to analysis. In general, after a sample has been loaded into the sample holder 182, the sample holder 182 is placed onto a kinematic mounting surface 206 of the image capture system 200. A latch 190 may then be used to fix the sample holder 182 to the kinematic mounting surface 206. An imaging device 202 (e.g., a camera) of the image capture system 200 may then be used to capture one or more macro-scale images of the sample 10. Following capture of the one or more images, the sample holder 182 including the sample 10, is moved into the vacuum chamber 106 of the analysis system 100 for subsequent analysis.

The imaging device 202 may be positioned at a known location relative to the sample holder 182 when the sample holder 182 is placed onto the kinematic mounting surface 206. For example, and without limitation, the imaging device 202 may be positioned directly above the center of the sample stage 184. Similarly, when placed within the vacuum chamber 106, the mount 110 may be “zeroed” such that the sample holder 182 is also disposed in a known position within the vacuum chamber 106. Due to the high repeatability of the kinematic mounting and the ability to place the sample holder 182 in a known position in both the analysis system 100 and image capture system 200, a common coordinate system (or mapping between different coordinate systems) may be readily ascertained between the image capture system 200 and analysis system 100. Based on the common coordinate system, large scale images captured during analysis (e.g., by the imaging system 160) may be readily mapped to corresponding locations of the macro image(s) previously captured by using the image capture system 200.

In addition to establishing a relationship between the macro image and the large-scale/micro images, establishing the common coordinate system also facilitates control and operation of the analysis system 100. For example, in at least one implementation, once the macro-scale image has been captured, it may be displayed on the display 194 of the computing device 192. A user of the analysis system may then use an input (mouse, touchscreen, etc.) to identify one or more specific locations of interest, define or select a sampling pattern/path along which multiple samples are to be taken, or otherwise provide input as to where and how the sample should be analyzed. As described below in further details, the analysis system 100 may generally, for each location, capture one or more detailed images as well as analysis data for both organic and inorganic material at the location. The detailed images and analysis data may then be linked to the corresponding location of the macro image such that a user may select locations of the sample in the macro image and “drill-down” to view one or both of the detailed image and the analysis data for the selected location.

By implementing the foregoing approach, the macro-level image may be readily aligned with any detailed images of specific sample locations (e.g., obtained using the imaging system 160 of the analysis system 100). As discussed below, the detailed images may then be linked or otherwise associated with any data resulting from organic and/or inorganic analysis conducted at the location represented by the detailed image. In other words, the various images captured during analysis of a given sample may be used to generate a stacked and zoomable image that is also tied to underlying analysis data. So, for example, a user may be able to view the macro-level image of a given sample and toggle display of one or more heat maps (or similar visualizations) indicating the presence or concentration of different chemical components identified during analysis. The user may also be able to select specific locations to obtain more detailed information about the chemical makeup and analysis results for that location.

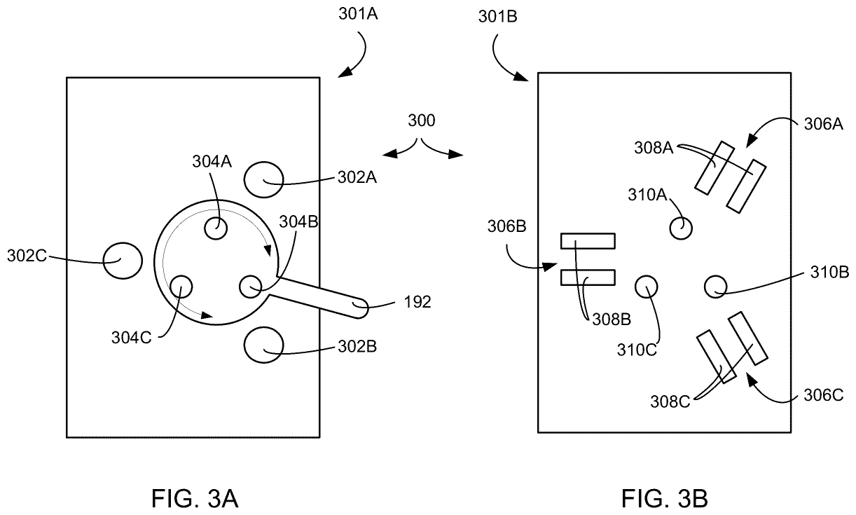

FIGS. 3A and 3B are schematic illustrations of an example kinematic mounting system 300 (collectively) as may be used in implementations of the present disclosure. FIG. 3A illustrates a first half 301A of the kinematic mounting system 300 that may generally correspond to an underside of the sample holder 182. FIG. 3B, on the other hand, illustrates a second half 301B of the kinematic mounting system 300 and may generally correspond to the kinematic mounting surface 188 of the analysis system 100. It should be appreciated, however, that the second half 301B of the kinematic mounting system 300 may also correspond to the kinematic mounting surface 206 of the image capture system 200 of FIG. 2.

Referring first to FIG. 3A, the first half 301A of the kinematic mounting system 300 includes three spherical or hemi-spherical protrusions 302A-302C distributed about the underside of the sample holder 182. As previously discussed, the sample holder 182 may also include a rotatable or otherwise movable latch mechanism. The latch 190 includes a first set of magnets 304A-304C such that rotation of the latch 190 results in rotation of the magnets 304A-304C.

Referring next to FIG. 3B, the second half 301B of the kinematic mounting system 300 includes three channels 306A-306C which, in the illustrated example, are defined by respective pairs of rods 308A-308C. The second half 301B of the kinematic mounting system 300 further includes a second set of magnets 310A-310C arranged in a pattern similar to that of the first set of magnets 304A-304C of the latch 190.

During operation, the first half 301A of the kinematic mounting system 300 and the second half 301B of the kinematic mounting system 300 may be coupled by placing the first half 301A onto the second half 301B such that the protrusions 302A-302C of the first half 301A are received in the corresponding channels 306A-306C of the second half 301B. When so disposed, the latch 190 may be manipulated (e.g., rotated) to align the first set of magnets 304A-304C with the second set of magnets 310A-310C, locking the first half 301A and the second half 301B together. To separate the kinematic mount, the latch 190 may be manipulated to misalign the first set of magnets 304A-304C and the second set of magnets 310A-310C, thereby unlocking the kinematic mounting system 300 and allowing separation of the first half 301A and the second half 301B.

It should be appreciated that the kinematic mount system illustrated in FIGS. 3A and 3B is merely one example of a kinematic mount suitable for use in applications of the present disclosure and other configurations are possible. For example, the components of the first half 301A, such as the protrusions 302A-302C and the latch 190, may instead be disposed on the second half 301B, and vice versa. As previously noted, other styles of kinematic mechanisms may also be used. More generally, however, any suitable mounting system may be implemented in each of the analysis system 100 and the image capture system 200 that facilitates repeatable location of the sample 10 such that the detailed images captured by the analysis system 100 can be readily correlated and aligned with corresponding portions of the macro-level images captured by the image capture system 200.

FIG. 4 is a graphical representation of the foregoing concepts and data storage approach. As previously noted, prior to inserting the sample 10 into the sample chamber 104 of the analysis system 100, a macro image 402 of the sample 10 may be captured using an image capture system, such as the image capture system 200 of FIG. 2. The macro image 402 may then be stored by the analysis system 100 (e.g., in a memory of the computing device 192).

As illustrated in FIG. 4, the macro image 402 may be subdivided by the analysis system 100 into a grid 404 or similar pattern, with each location in the grid representing an analysis location of the sample. The dimensions of each grid element may vary in different applications, however, in at least some implementations each element of the grid is on a similar order as the width of the material removal beam at the surface 12 of the sample 10. For example, as previously discussed, the D/A sub-system 120 may be configured to generate a focused beam having a diameter of no more than about 50 μm in diameter at the surface 12 of the sample 10. In such applications, the macro image 402 of the sample 10 may be sub-divided into a square grid in which each element is a square from and including about 50 μm by 50 μm to and including 100 μm to and including 100 μm.

During operation and prior to analysis, a user may be presented with the macro image 402 for identification of an analysis path/routine. For example, FIG. 4 includes a path 406 that extends through each grid element in a given column before moving to the subsequent column. This pattern may continue such that the path reaches each grid element of the macro image 402. It should be appreciated that the column by column approach illustrated in FIG. 4 is only an example and other analysis routines are contemplated. More generally, a user may select one or more specific locations or areas of the sample 10 for analysis. To the extent the user selects an area (which may correspond to any area up to and including the entire sample), the user may also select an analysis density or pattern. For example, the user may want in-depth analysis of a particular area of a sample and, as a result, may desire that an analysis be conducted at each discrete location (e.g., each grid element) within the area. Alternatively, if a more general analysis is desired, only a subset of grid elements may be identified for analysis (e.g., every second (or any other number) grid element within the area, every other (or any other number) row of elements within the area, every other (or any other number) column within the area). In still other implementations, a random sampling mode may be available in which random locations of all or a subset of the grid 404 is selected for analysis.

In at least certain implementations, the computing device 192 may be configured to automatically generate a path for analysis of the sample. In certain implementations, the analysis system may analyze the entire sample following a path similar to that of the path 406 of FIG. 4. In other implementations, the computing device 192 may be configured to identify particular areas of the sample 10 (e.g., areas having particular colors, shapes, or other notable characteristics) and target such areas of interest for more in-depth analysis (e.g., by automatically increasing the analysis density within the areas of interest).

Once an analysis routine has been identified, the analysis routine may be subsequently executed by the analysis system 100. In general, executing the analysis routine includes successively moving the sample 10 into locations to be analyzed and analyzing each location. As previously discussed, analyzing a given location may include capturing an image of the location and performing each of an organic material analysis and an inorganic material analysis. Following analysis at a location, the capture image (e.g., image 410) and analysis results (e.g., result data 412) may be linked to the grid element (e.g., grid element 408). This process may be repeated for each grid element identified for analysis within the analysis routine. Although illustrated in FIG. 4 as graphical data, it should be appreciated that the result data 412 may be stored as alphanumeric values, as a table of values, or any other suitable format and is not limited to graphical representations.

In light of the foregoing, implementations of the present disclosure may include storage of sample data in an efficient and easily navigable format. More specifically, each sample analyzed using the analysis system 100 may be represented by a macro level image including a relatively large portion of the sample surface. The macro-level image may be sub-divided into a grid or similar pattern and an underlying data structure (e.g., an array) may be linked to the macro-level image in which each element of the array represents a corresponding grid element. To the extent image data and/or mass spectroscopy data is subsequently obtained at a location of the sample, the corresponding array element may be populated with the image/mass spectroscopy data, links/pointers to such data, or similar information for retrieving the analysis data. Accordingly, the analysis data is stored in a manner that allows a user to easily view the sample as a whole (e.g., via the macro image) and select specific sample locations to obtain more detailed images and analysis data for the location. As previously mentioned, linking the analysis data and macro-level image enables the generation and display of various useful visualizations that may be overlaid on top of the macro-level image, such as heat or color maps, to facilitate further analysis by a user of the analysis system 100.

### Analysis and Related Methods

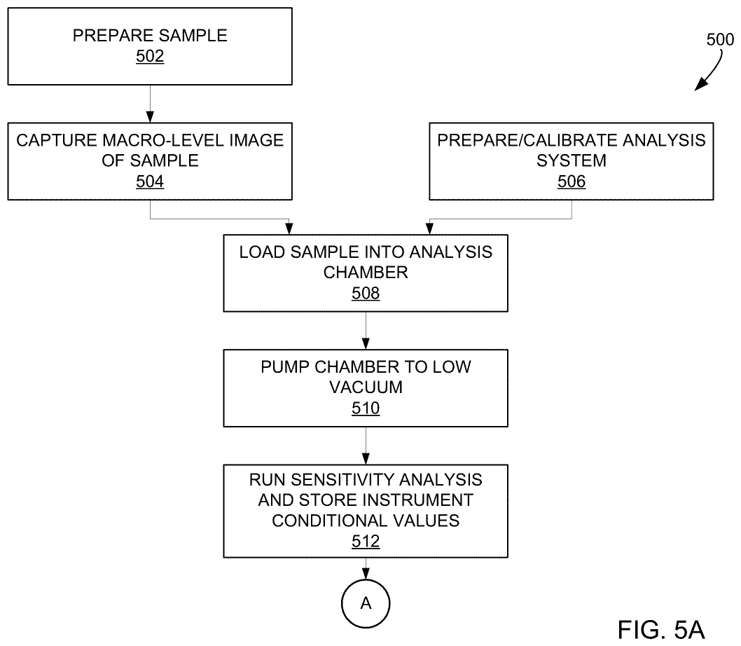

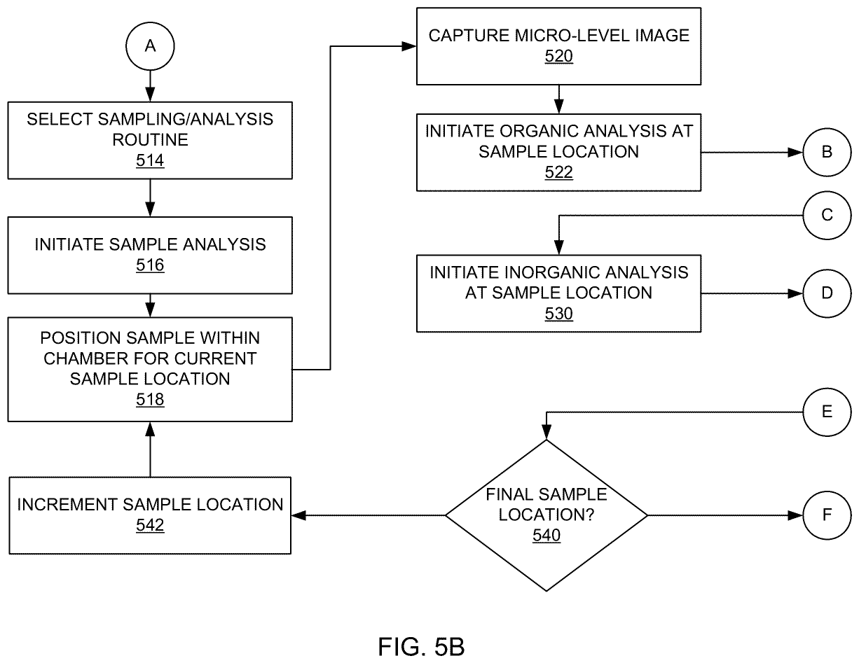

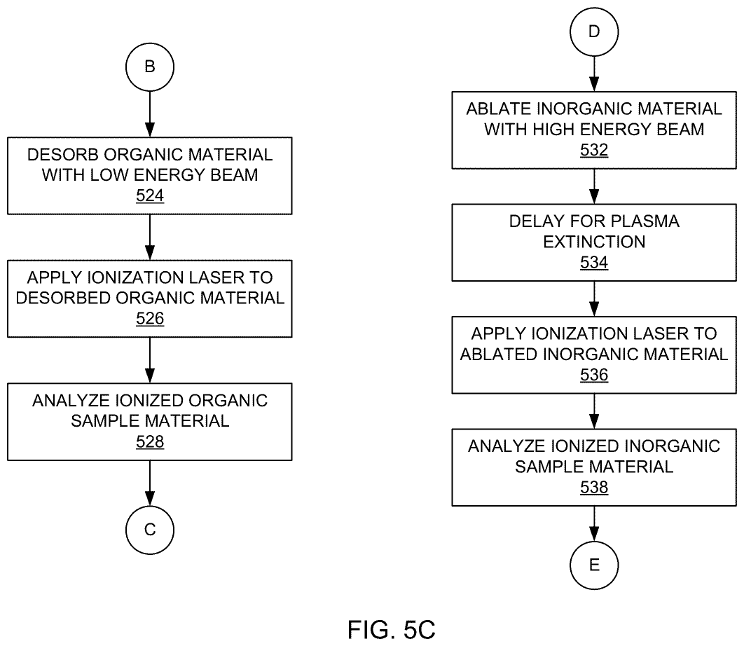

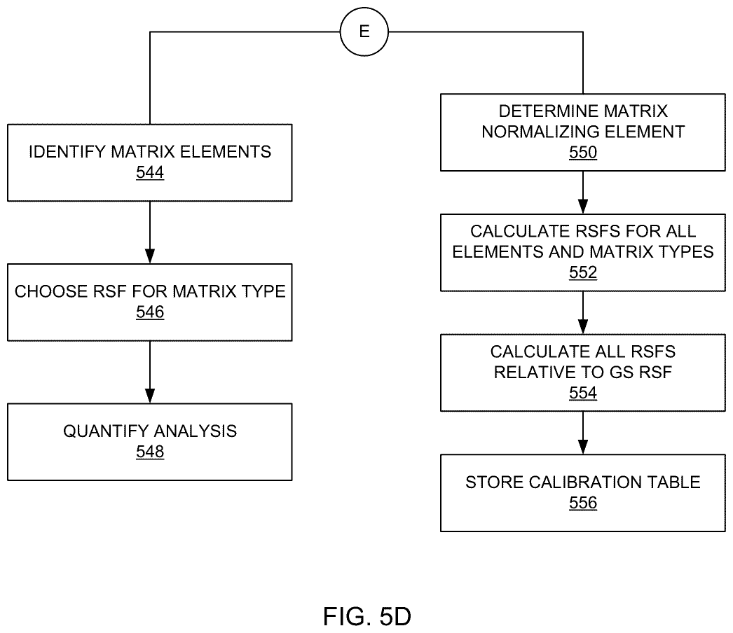

FIGS. 5A-5D illustrate a flow chart of an example method 500 of operating an analysis system in accordance with the present disclosure to analyze a sample containing organic and inorganic components. The method 500 may be implemented, for example, using the analysis system 100 illustrated in FIG. 1A-1B. Accordingly, reference in the following discussion is made to the analysis system 100 and its components; however, it should be understood that the analysis system 100 should be regarded as a non-limiting example of a system that may implement the method 500.

FIG. 5A generally illustrates the steps prior to actual analysis of the sample. Prior to analysis, each of the sample 10 and the analysis system 100 may each be prepared for use. For example, at operations 502 and 504, the sample 10 is prepared and a macro-level image of the sample is capture and stored, respectively. Preparation of the sample 10 may include, among other things, cleaning, chemically treating, cutting, polishing, or otherwise preparing the sample surface 12. Preparation of the sample 10 may further include loading the sample onto a sample stage 184 or similar fixture for retaining the sample 10 during capture of the macro-level image and subsequent analysis. As previously discussed, capturing the macro-level image (operation 504) may include loading the sample 10 onto a kinematic or similar high-precision mount to facilitate later alignment of detailed images captured during analysis of the sample with the macro-level image.

Calibration of the analysis system 100 (operation 506) may include, among other things, performing various checks to confirm communication with and functionality of various sub-systems of the analysis system 100. Calibration may also include testing various components (e.g., confirming a full range of motion for the motors used to move the sample 10 within the sample chamber 104, activation of the various lasers and associated optical sub-systems, etc.). Calibration may also include configuring the mass spectrometer 102, such as by loading various matrix standards or similar information into the mass spectrometer 102 to configure the mass spectrometer 102 for analyzing particular types of samples. This may also include independent system parameters for organic and inorganic analysis. As illustrated in FIG. 5A calibration of the analysis system 100 and preparation of the sample 10 are generally independent steps and may be conducted in any order, including simultaneously (in whole or in part).

Once the sample 10 and analysis system 100 are prepared, the sample 10 may be loaded into the vacuum chamber 106 (operation 508) and the vacuum chamber 106 may be pumped to a low vacuum (operation 510). A sensitivity analysis may then be performed and corresponding instrument conditional values may be stored (operation 512). This may include executing a pre-loaded internal standard of a known matrix or an external standard loaded alongside the sample. Such values may be used to update the internal tables used in quantification.

With the sample 10 loaded into the analysis system 100, an analysis routine may be selected (operation 514). As previously discussed, doing so may include the user interacting with the computing device 192 to select one or more specific locations and/or areas for analysis (e.g., by clicking or otherwise identifying areas of interest on the macro-level image) and specifying to what extent each area is to be analyzed. Alternatively, the computing device 192 may be configured to automatically identify areas of interest of the sample and generate a corresponding analysis routine. With an analysis routine selected, analysis of the sample is initiated (operation 516).

Analysis of a given sample may generally include positioning the sample 10 such that the focal point of the D/A beam 16 and field of view of the imaging system 160 is at a first location specified in the analysis routine (operation 518). Analysis at that location may then commence by first capturing a micro-level image of the location (operation 520). As previously discussed, the captured micro-level image may then be stored in a manner that links the image with the corresponding location of the macro-level image captured during operation 504.

Following capture of the micro-level image, the analysis system 100 may initiate organic analysis at the current location (operation 522). As illustrated in FIG. 5C, organic analysis may generally include the steps of desorbing organic material using a low energy beam (operation 524), ionizing the resulting desorbed organic material to form ionized organic sample material (operation 526), and analyzing the resulting ionized organic sample material (operation 528). As described in the context of FIG. 1A, the desorption process may include modifying an operational mode of a desorption/ablation (D/A) sub-system to generate a material removal beam suitable for desorption of organic material from the sample 10. Generating a material removal beam having suitable characteristics for desorption may include, among other things, using one or more filters, attenuators, mirrors, lenses, or other similar optical elements to manipulate a size, energy density, and wavelength of a source beam generated by a D/A laser source 122 of the D/A sub-system 120 and directing the resulting material removal beam to the current analysis location of the sample 10.

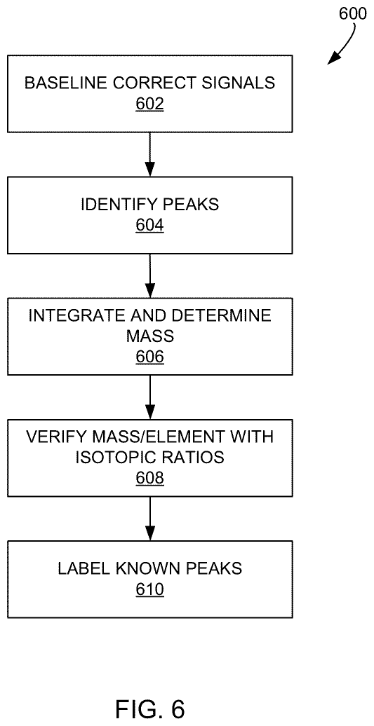

Desorption may generally result in a vapor cloud of organic material rising normal to the surface 12 of the sample 10. Accordingly, in certain implementations, the process of ionizing the desorbed organic sample material (operation 526) may include producing and directing an ionization beam 18 generated by an ionization sub-system 140 to a location normal to the sample surface 12. The resulting ionized organic sample material may subsequently be analyzed by the mass spectrometer 102 of the analysis system (operation 528). Doing so may include transporting the ionized organic sample material, such as by use of the quadrupole ion guide 112 or similar delivery system, including the opening of any valves (e.g., gate valve 170) to allow transportation of the ionized vapor from the vacuum chamber 106 to the mass spectrometer 102. One example of an analysis process is illustrated in FIG. 6 and is discussed below in further detail. Analysis of the sample at operation 528 may further include storing the results of the analysis. Similar to the micro-level image, such storage may include storing the organic analysis result data in a manner that is linked with the corresponding location of the macro-level image captured during operation 504.

Following the completion of organic analysis, the analysis system 100 may initiate inorganic analysis at the current sample location (operation 530, shown in FIG. 5B), e.g., without repositioning the sample within the sample chamber and without modifying the material removal beam angle of incidence. As illustrated in FIG. 5C, inorganic analysis may generally include the steps of ablating inorganic material using a high energy beam (operation 532), imposing a delay to allow for extinction of any plasma resulting from the ionization process (operation 534), ionizing the resulting particle cloud of inorganic sample material to form ionized inorganic sample material (operation 536), and analyzing the resulting ionized inorganic sample material (operation 538). Similar to the desorption process, the ablation process may include modifying an operational mode of the desorption/ablation (D/A) sub-system to generate a material removal beam suitable for ablating inorganic material from the sample 10. Generating such a material removal beam may include, among other things, using one or more filters, attenuators, mirrors, lenses, or other similar optical elements to manipulate a size, energy density, and wavelength of a source beam generated by the D/A laser source 122 of the D/A sub-system 120 and directing the resulting beam to the current analysis location of the sample 10.

Ablation generally results in a cloud of inorganic particles material rising normal to the surface 12 of the sample 10. In certain cases, the energy used to ablate the inorganic material may generate charged plasma that may negatively impact subsequent ionization and analysis of the inorganic material. Accordingly, as noted above, the analysis system 100 may be configured to apply a delay between ablation and ionization (operation 534). The duration of the delay may vary, however, in at least certain implementations, the delay may be from and including about 10 ns to and including about 1 μs.

Following the delay, the resulting particle cloud of inorganic matter may be ionized (operation 526). Similar to ionization of the vapor cloud in operation 526, ionization of the particle cloud may include producing and directing the ionization beam 18 generated by the ionization sub-system 140 to a location normal to the sample surface 12. The resulting ionized particles may then be directed to and analyzed by the mass spectrometer 102 of the analysis system (operation 538). Analysis of the sample at operation 538 may further include storing the results of the inorganic analysis. Similar to the micro-level image and the organic analysis data, such storage may include storing the inorganic analysis result data in a manner that is linked with the corresponding location of the macro-level image captured during operation 504.

Following execution of the inorganic analysis, the analysis system determines whether the current sample location is the final sample location as dictated by the analysis routine (operation 540). If not, the sample location is incremented (operation 542) to the next sample location of the analysis routine and the process of positioning the sample, capturing an image of the sample, and performing each of an organic and inorganic analysis (operations 518-538) are repeated at the new location.

If, on the other hand, data for the final location of the analysis routine is captured, final processing of the collected data may occur. Although analysis of the collected data may vary, in at least one implementation of the present disclosure, analyzing the collected data may include each of identifying matrix elements (operation 544), choosing a suitable relative sensitivity factor (RSF) for the matrix type (operation 546), and applying each of the identified matrix and corresponding RSF to quantify the analysis (operation 548). This allows for quantification of a sample which may have many matrices within a small area. Each grid may be analyzed first for matrix compositions which then determines the factors used for ultimate quantification

In addition to quantifying the analysis, the collected data may also be used to provide feedback to the analysis system 100 and/or to update or otherwise modify calibration data of the analysis system 100. For example, and without limitation, in at least one implementation, following analysis of a sample a matrix normalizing element may be identified (operation 550). Moreover, each of RSFs for all elements and matrix types may also be calculated and RSFs relative to a general standard RSF may also be calculated (operations 552, 554, respectively). Finally, the foregoing information may be stored in a calibration table (operation 556) for later use in calibrating the analysis system 100 prior to analysis of subsequent samples.

While the foregoing description of the method 500 includes analysis of both organic and inorganic material at each sample location, it should be appreciated that in other implementations the system may be configured to analyze only organic material or only inorganic material at any or all sample locations.

As previously noted, FIG. 6 is a flow chart illustrating a method 600 of analyzing ionized particles, such as may be used by the mass spectrometer 102 of the analysis system 100 in conjunction with the computing device 192. The method 600 illustrated in FIG. 6 may generally be applied to analysis of either the ionized vapor cloud produced during analysis of organic material or the ionized particle cloud produced during analysis of inorganic material.

At operation 602, a baseline correction may be applied to the signals received during the analysis process. The corrected signals may then be analyzed to identify peaks (operation 604) in the mass spectrum results. Such peaks generally correspond to relatively high quantities of detected particles having particular mass-to-charge ratios. The resulting peak data may then be integrated or otherwise processed to determine the mass of the particles associated with each peak (operation 606). The masses and elements may then be verified using isotropic ratios (operation 608). Following verification, the peaks may be labelled or otherwise tagged with the particular element or compound represented by the peak (operation 610).

It should be appreciated that the unique configuration of the analysis system 100 enables a single standard to be used for multi-matrix quantification. As a result, the strict sample-standard matching practices required for many conventional instruments and which are highly susceptible to matrix effects can be avoided. For example, in implementations of the current disclosure, the initial neutral particle cloud formed during ablation is not affected to a substantial degree by the ablation process and the effect of the changing chemical environment (i.e., the matrix) is orders of magnitude less than ions which are produced by the resultant plasma. Thus, by having a more regular particle cloud which ionized particles may be produced, the resulting ionized particles can be more readily characterized and quantified. It should be noted that all variances in matrix effects may be normalized and thus the matrix characterization may be used to determine the relative RSFs (MEM) as discussed below in further detail.

In at least certain implementations, the quantification process may require an initial calibration stage in which standards of varying matrix types are analyzed (e.g., the calibration operation 506 of FIG. 5A). Such calibration may include selecting one or more general standards (e.g., silicate glass), analyzing the selected standards, and calculating individual relative sensitivity factors (RSFs) for the standards. A matrix-effect-multiplier (MEM) may then be computed for each matrix type based on the foregoing calculations. The MEM generally functions as a scaling factor for each element's effects in different matrices relative to the general standard matrix. Accordingly, by calculating an MEM for a given sample, the sample may be rapidly quantified despite the sample possibly including multiple matrices in a small area. The foregoing approach is only possible because of the neutral particle production normalization and the fact the instrument is in a static environment with no gas-flows or changes in atmospheric conditions. Such static conditions allow for more regular behavior and operation as compared to conventional analysis systems. It should also be noted that the operational behavior of systems according to the present disclosure also allows the system to be characterized and standardized less often than other techniques and can also lead to the development of standard-less quantification.

During quantification, a relative sensitivity factors (RSF) is generally used to scale measured peak areas obtained during spectrometry such that variations in the peak areas are representative of the amount of material in the sample. In other words, the RSF is applied to convert the measured ion intensities obtained during spectrometry into atomic concentrations in the investigated matrix. Each element within a sampled matrix may behave differently in a particular spectrometry system. As a result, a respective RSF is generally required for each element within a sample being quantified.

RSFs often depend on characteristics of the sample being analyzed but also on the conditions under which such analysis occurs. Accordingly, while libraries of RSFs may be available for certain spectrometry systems, the relative utility of such RSFs are highly dependent on subsequent analysis conditions being substantially the same as when the RSFs were determined. To the extent analysis is conducted under disparate conditions (e.g., different environmental conditions or different instrument conditions such as resulting from instrument drift), previously determined RSF values may be unreliable or otherwise inaccurate.

To address the foregoing issue, implementations of systems according to the present disclosure may calculate effective RSF (RSF_{Eff}) values that more readily take into account variability in the analysis system as compared to simply relying on libraries of stored RSF values. In one implementation, effective RSFs are calculated for each element of interest based on each of a dynamically updated general standard RSF and a library of matrix standard RSFs. The general standard RSF corresponds to a known material for which a test sample is available and for which the actual contents/quantification of molecular species within the test sample are known. In one example, the general standard RSF may correspond to a standard form of glass (e.g., a standardized piece of borosilicate glass) with a known and certified composition. The matrix standard RSFs, on the other hand, are RSF values associated with particular matrices and characterize the relative sensitivity attributable to matrix effects for those matrices. In the context of sample analysis for oil and gas, for example, various matrix standard RSFs for commonly encountered minerals/matrices (e.g., plagioclase, alkali feldspar, pyroxene, quartz, mica, etc.) may be provided to the analysis system, each matrix standard RSF providing relative sensitivity values arising out of the matrix effects for the particular mineral/matrix. In certain implementations of the present disclosure, initial general standard RSFs and the matrix standard RSFs may be combined to generate what are referred to herein as matrix effect multipliers (MEMs) for various elements of interest.

As conditions associated with the analysis system change, the test sample corresponding to the general standard RSFs may be periodically analyzed to obtain updated general standard RSFs. The updated general standard RSFs may then be scaled using the corresponding MEMs to determine the effective RSF.

Over time or as environmental or other conditions change, the sample material may be reanalyzed by the system to obtain an updated general standard RSF which in turn may be used to calculate updated effective RSFs.

As noted, the foregoing process includes calculating an effective relative sensitivity factor for an element in question (e). In one specific implementation, the effective relative sensitivity factor can be calculated according to the following equation (1):

RSF_{Eff}=MEM^{e}(RSF_{G}^{e}) (1)

where RSF_{Eff} is the effective relative sensitivity factor, MEM is a matrix effect multiplier, RSF_{G} is a relative sensitivity factor according to a general standard, and e is the element in question.

The matrix effect multiplier (MEM) for the element e may in turn be calculated according to equation (2):

$$M E {M}^{e} = \frac{R S {F}_{M}^{e}}{R S {F}_{G}^{e}} \qquad ( 2 )$$

where RSF_{M} is a relative sensitivity factor according to a matrix effect standard for element e.

The relative sensitivity factor according to the general standard (RSF_{G}) may in turn be calculated according to equation (3):

$$R S {F}_{G}^{e} = [ \frac{( \frac{{x}_{G}^{e}}{{x}_{G}^{{N}_{G}}} )}{( \frac{{P}_{G}^{e}}{{P}_{G}^{{N}_{G}}} )} ] \qquad ( 3 )$$

where X_{G} is concentration according to the general standard and P_{G} is an integrated peak according to the general standard. Each of XG and P_{G} are further included in terms of the element in question (e) and a normalizing element relative to the general standard (N_{G}).

Similarly, the relative sensitivity factors according to the matrix effect standard (RSF_{M}) may in turn be calculated according to equation (4):

$$R S {F}_{M}^{e} = [ \frac{( \frac{{x}_{M}^{e}}{{X}_{M}^{{N}_{M}}} )}{( \frac{{P}_{M}^{e}}{{P}_{M}^{{N}_{M}}} )} ] \qquad ( 4 )$$

where X_{M} is concentration according to the matrix effect standard and P_{M} is an integrated peak according to the matrix effect standard. Each of X_{M} and P_{M} are further included in terms of the element in question (e) and a normalizing element relative to the matrix effect standard (N_{M}).
Analysis Systems including Coaxial Material Removal Beams and Micro-Level Field of View

As previously discussed, and illustrated in FIGS. 1A-1B, each of the absorption/desorption beam 16 and the micro-level imaging device 162 of the analysis system 100 may have an associated angle of incidence (θ_{D/A} and θ_{CAM}, each shown in FIG. 1B) corresponding to the angle at which the material removal beam 16 (e.g., either of a desorption beam or an ablation beam) is directed onto the sample 10 and the angle of view of the imaging device 162, respectively. In other implementations, the material removal beam and the angle of view of the imaging device may instead be arranged to be coaxial and perpendicular to a top surface of the sample 10. Such implementations may provide improved alignment of the material removal beam and the imaging, easier system calibration, reduced system footprint, and other benefits.

Systems with Co-Axial D/A Beams and Imaging

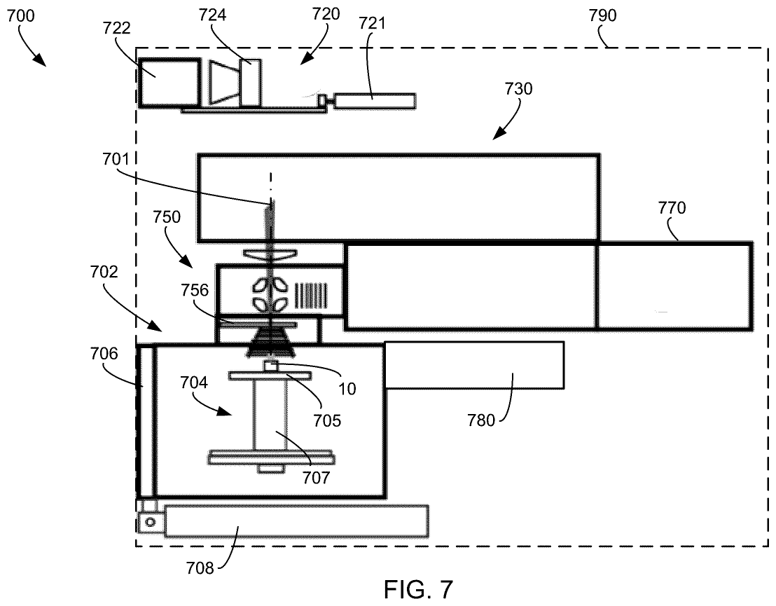

FIGS. 7-12 are schematic illustrations of an alternative analysis system 700 in accordance with the present disclosure in which each of the material removal beam and micro-level imaging device field of view are arranged coaxially and perpendicular to a top surface of a stage/sample holder 705. For example, as illustrated in FIG. 7, each of the desorption beam, the ablation beam, and field of view of the micro-level imaging device may be directed along an axis 701. In instances where a top surface of a sample 10 is substantially parallel to the top surface of the stage/sample holder 705, the material removal beam and micro-level imaging device field of view would also be perpendicular to the top surface of the sample 10. The analysis system 700 further incorporates additional features for improved capture of a macro image of the sample 10.

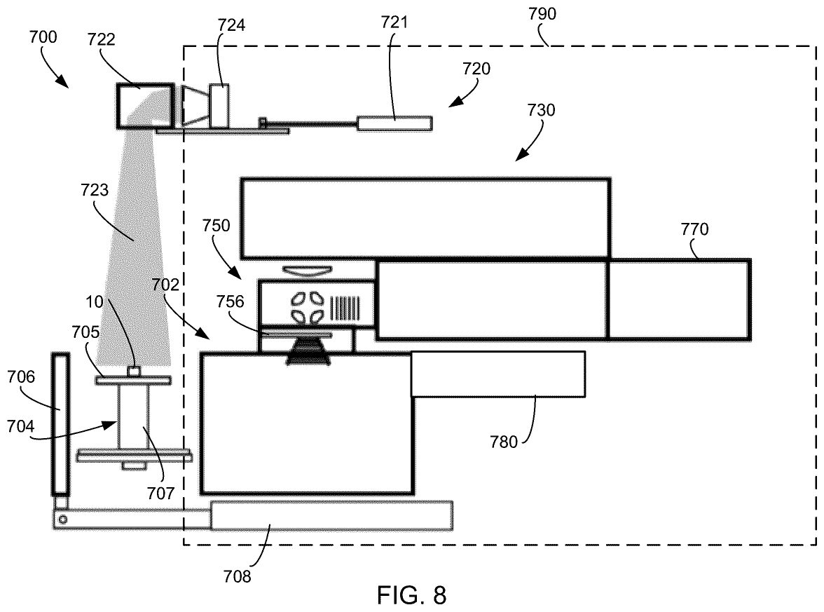

As shown in FIGS. 7 and 8 (which illustrate the analysis system 700 in a closed configuration and open configuration, respectively), the analysis system 700 may generally include a sample chamber 702, a macro-level imaging assembly 720, an optical assembly 730, an ion extraction system 750, and a mass spectrometer 770 (e.g., a time-of-flight mass spectrometer). The analysis system 700 may be contained within a suitable housing or case 790 (shown in dashed lines for purposes of illustrating internal components of the analysis system 700). A computing system for controlling and operating the analysis system 700 is omitted for clarity; however, it should be understood that the analysis system 700 may be operated and controlled locally and/or remotely using a suitable computing device. Such a computing system may generally contain similar components and perform functions similar to the computing device 192 of the analysis system 100, as described above.

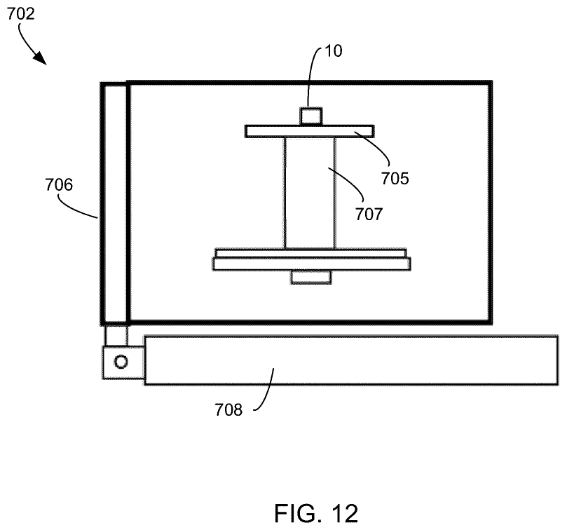

During use, a door 706 of the sample chamber 702 (which is illustrated in further detail in FIG. 12) may be opened to insert a sample 10. An example opened configuration is generally illustrated in FIG. 8. In certain implementations, the sample chamber 702 may be opened using a corresponding control element such as a button (physical or electronic) or interactive element of a user interface, such as a user interface of a computing device (not shown) communicatively coupled to the analysis system 700. In response to activation of the control element, an actuator 708 (e.g., an electropneumatic or similar actuator) may open the door 706. Alternatively, the door 706 of the sample chamber 702 may be opened, at least in part, by a user of the analysis system 700.

When the door 706 is opened, a stage assembly 704 of the analysis system 700 may be accessed. The stage assembly 704 may generally include a stage/sample holder 705 for retaining the sample 10 and one or more actuators (e.g., actuator 707) for adjusting the position of the stage/sample holder 705. For example, in certain implementations, the stage assembly 704 may include three or more actuators such that the stage/sample holder 705 may be translated in any of the x-, y-, or z-directions. In other implementations, actuators of the stage assembly may further permit at least some rotation about at least one of the x-, y-, or z-axes. The stage assembly 704 may also be coupled to an additional actuator (not shown) that automatically translates the stage assembly 704 out of the sample chamber 702 in response to opening of the door 706. In other implementations, the stage assembly 704 may be manually translated out of the sample chamber 702 when the door 706 is opened. Regardless of how the stage assembly 704 is translated from within the sample chamber 702, the stage assembly 704 may be coupled to or otherwise disposed on guides, rails or similar structural elements (not shown for clarity) to maintain alignment of the stage assembly 704.

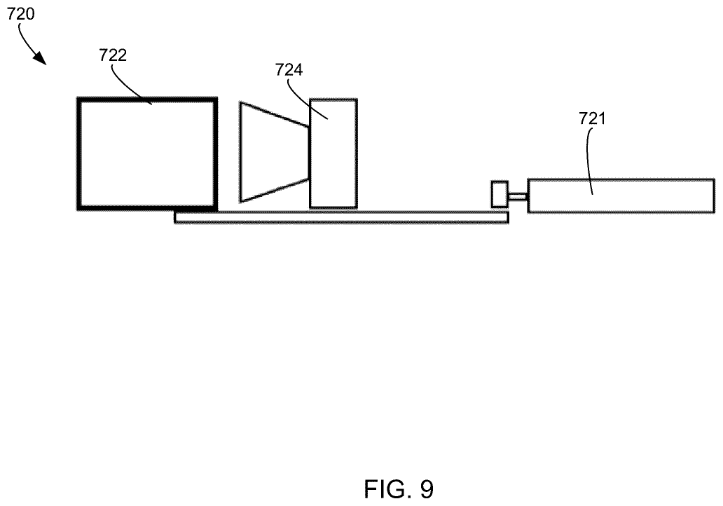

Following placement of the sample 10, a macro-level image of the sample 10 may be captured using the macro-level imaging assembly 720 (which is illustrated schematically in FIG. 9). In one implementation, after the user has loaded the sample 10 onto the stage assembly 704 and confirmed placement of the sample 10 (e.g., using a corresponding on-screen button or prompt or similar physical control element of the analysis system 700), the macro-level imaging assembly 720 may automatically open and extend a macro-level imaging device 724 to align the field of view 723 of the macro-level imaging device 724 to capture an image of the sample 10 and/or the stage/sample holder 705 of the stage assembly 704. The image capture by the macro-level imaging device 724 may include all or a substantial amount of a top surface of the sample 10. In certain implementations, the macro-level imaging assembly 720 may include a mirror 722 (or similar optical element) for directing the field of view of the macro-level imaging device 724 to be aligned with the stage assembly 704 when the stage assembly 704 is translated outside of the sample chamber 702. The macro-level imaging assembly 720 may further include one or more actuators (e.g., actuator 721) for moving one or both of the macro-level imaging device 724 and the mirror 722 for purposes of aligning the field of view of the macro-level imaging device 724 with the stage assembly 704.

Following alignment of the field of view of the macro-level imaging device 724, the analysis system 700 may perform an auto-focusing procedure. In one implementation, the auto-focusing procedure includes translating the stage/sample holder 705 of the stage assembly 704 to bring the sample 10 into focus with respect to the macro-level imaging device 724. After focus is achieved, a macro-level image may be captured using the macro-level imaging device 724. In certain implementations, the captured image may be mapped onto a digital plane representing the moveable area of the stage/sample holder 705 in x- and y-directions. Further processing and use of the macro-level image are described above, e.g., in the context of FIGS. 4-5D.

Following capture of the macro-level image, the stage assembly 704 may be retracted back into the sample chamber 702 and the door 706 may be closed (e.g., manually by the user or by one or more actuators of the analysis system 700). In implementations in which components of the macro-level imaging assembly 720 are also extended/translated for purposes of capturing the macro-level image, such components may similarly be retracted and any doors (or similar openings) through which the components translate through to capture the macro-level image may be closed (either manually or automatically).

With the sample 10 disposed within the sample chamber 702 and the door 706 closed and sealing the sample chamber 702, pressure within the sample chamber 702 may be reduced. For example, in one implementation, a port (not shown) of the sample chamber 702 is opened to a valve (e.g., a roughing valve, not shown) and pumped down to a first reduced pressure level using a corresponding pump (not shown) coupled to the sample chamber 702. In one specific and non-limiting example implementation, pressure may be reduced to approximately 0.3 mbar during this process.

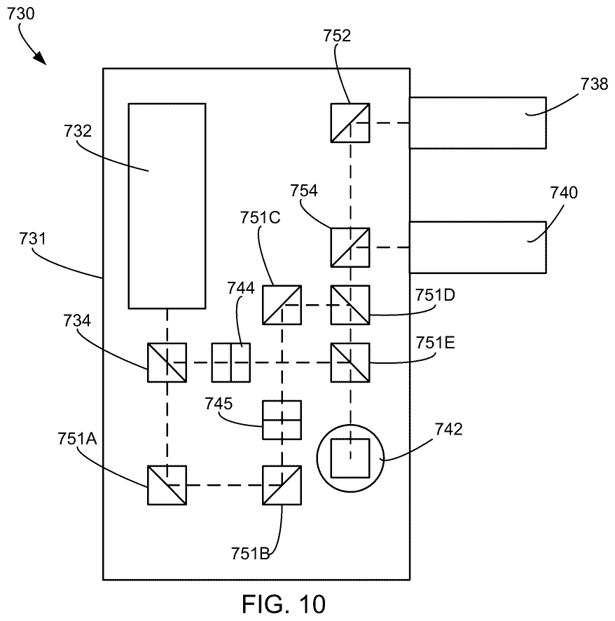

Following initial depressurization, a second adjustment (e.g., an adjustment in the z-direction) of the stage assembly 704 may be performed (either automatically or in response to commands provided by the user, e.g., through a user interface of the computing device of the analysis system 700) such that the sample is brought into focus relative to a micro-level imaging device of the optical assembly 730. A plan view of one implementation of the optical assembly 730 including a micro-level imaging device 738 is provided in FIG. 10. Other aspects of the optical assembly 730 are described below in further detail. In certain implementations, the second adjustment may be performed at multiple locations with the system in a raster mode, such as described above in the context of FIG. 4.

In certain implementations, the initial vertical adjustment of the stage assembly 704 external the sample chamber 702 and based on the macro-level imaging device 724 may be considered a “coarse” adjustment having a first broader range of available positions and a first step-size between selectable positions. In general, this coarse adjustment is intended to achieve a level of focus sufficient to capture a macro-level image of the sample 10 and to bring the sample 10 into substantial focus relative to the micro-level imaging device 738. After retraction of the stage assembly 704 into the sample chamber 702, subsequent adjustment of the stage assembly 704 may be considered a “fine” position adjustment within a range of stage assembly positions about the position set during coarse adjustment. During fine position adjustment, the step size may be significantly reduced as compared to the step size used during coarse adjustment.

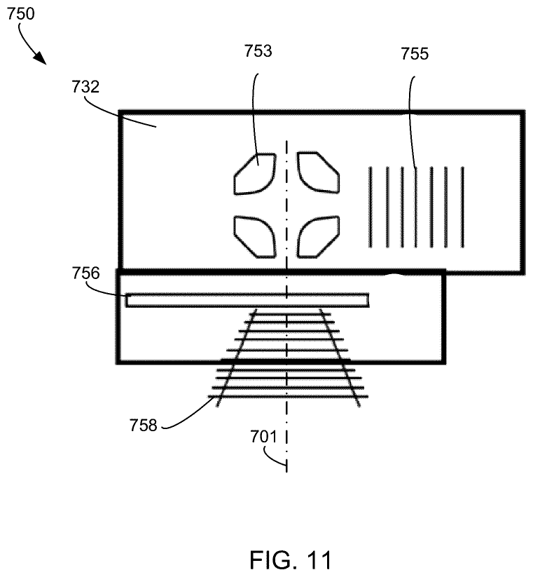

Following the fine adjustment of the stage assembly 704, a valve (e.g., a gate valve 756) of the ion extraction system 750 (shown in detail in FIG. 11) may be opened such that the sample chamber 702 and the ion extraction system 750 are in communication. The roughing valve (or other similar low-pressure valve) previously opened during initial depressurization may also be closed at this time.

A pump (not shown) in communication with the sample chamber 702 may then be used to begin to pull a vacuum in the sample chamber 702. In one specific implementation, a vacuum may be pulled such that pressure within the sample chamber 702 reaches an ultimate pressure of less than 10\hat{ }-3 mbar, which, for purposes of the present discussion is considered to be full vacuum.

Following establishment of a full vacuum within the sample chamber 702, a gas, such as a high purity Helium gas, may be injected, leaked, or otherwise provided into the sample chamber 702. In certain implementations, Helium gas may be provided into the sample chamber 702 to a pressure of 0.01 to 0.3 mbar, depending on analysis conditions.

At any point subsequent to acquiring the macro image of the sample 10, the user may begin selecting specific points, lines, rasters, etc. of the sample 10 for analysis. To do so, the macro image may be presented to the user (e.g., on a display of the analysis system computing device). In certain implementations, as the user selects particular locations in the macro level image, the stage assembly 704 may automatically translate such that the selected location is within the field of view of the micro-level imaging device 738. The user may then “zoom into” the current location by switching to a live feed or otherwise viewing an image of the current location captured by the micro-level imaging device 738. Stated differently, the user may select an area of the sample from the macro-level image captured by the macro-level imaging device 724 and then may be subsequently presented with a more detailed image or video feed corresponding to the selected location and captured using the micro-level imaging device 738. In certain implementations, the user may also be permitted to adjust the focus of the micro-level imaging device 738 by making fine adjustments to the z-position of the stage/sample holder of the stage assembly 704.

As an alternative to manually selecting points, lines, rasters, etc., the user may select from one or more preset analysis routines stored in memory of the analysis system computing device (or otherwise accessible by the computing) via the selectable by the user. Preset analysis routines may include, among other things, routines that follow preset scanning paths that test all or a particular portion of the sample, routines involving randomly or pseudo-randomly selected locations, or locations based on visual characteristics of the sample. With respect to visual characteristics, for example, the analysis system 700 may be configured to identify areas of the sample surface having certain visual characteristics (e.g., color, shape, boundaries, etc.) and may prioritize such areas for testing.

The user may also select whether the analysis procedure is to include inorganic analysis, organic analysis, or both inorganic and organic analysis. Based on the type of analysis to be conducted, the analysis system 700 sets the state of the optical assembly 730 to provide the corresponding beam. More specifically, if inorganic analysis is to be conducted, the analysis system 700 puts the optical assembly 730 in a state to deliver a high energy beam to ablate the sample. Similarly, if organic analysis is to be conducted, the analysis system 700 puts the optical assembly 730 in a state to deliver a lower energy to the sample 10 to desorb organic material from the sample 10. As previously discussed, in at least certain implementations, organic analysis may be conducted using a beam in the IR range while inorganic analysis may be conducted using a beam in the UV range; however, implementations of the present disclosure are not limited to any specific laser types or wavelengths. In implementations in which each of inorganic and organic analysis are to be conducted, the analysis system 700 may configure the optical assembly to first perform organic analysis for all locations of the sample 10 to be analyzed and then, after completing the organic analysis, may reconfigure the optical assembly 730 to perform the inorganic analysis. Alternatively, the analysis system 700 may alternate between performing organic and inorganic analysis for subsets (including individual locations) of the sample locations to be analyzed. For example, in an analysis of ten locations, the system may conduct organic analysis of a first pair of points followed by inorganic analysis of the first pair of points. This process may then be repeated for subsequent pairs of points until all ten locations have been analyzed.

FIG. 10 is a plan view of an example optical assembly 730 in accordance with the present disclosure. The optical assembly 730 generally includes a desorption/ablation (D/A) laser 732, the micro-level imaging device 738, and an illumination source 740 (e.g., an illumination light emitting diode (LED)). The optical assembly 730 is generally configured to selectively provide each of a low energy (e.g., IR) beam for desorption and a high energy (e.g., UV) beam for ablation and to capture micro-level images of the sample 10 disposed within the sample chamber 702. As discussed above in the context of the analysis system 100, in certain implementations, the D/A laser 732 may be a Nd:YAG laser; however, implementations of the present disclosure are not specifically limited to Nd:YAG laser.

The optical assembly 730 further includes a single port 742 defined within a housing 731 and through which the beams generated by the D/A laser 732 may be delivered. More specifically, beams generated by the D/A laser 732 are directed in a substantially horizontal direction within the housing 731 but made to exit through the port 742 in a substantially vertical direction perpendicular to a top surface of the stage/sample holder 705 and sample 10 within the sample chamber 702. Accordingly, the optical assembly 730 may further include various mirrors (e.g., mirrors, prisms, filters, or other optical elements to modify and direct beams generated by the D/A laser 732 within the optical assembly 730 and through the port 742. For example, a filter element 734 may be used to separate the beam produced by the D/A laser into high and low energy components. A low-energy/IR shutter 744 may then be used to selectively control delivery of the low-energy component to the port 742 via a first series of optical elements. Similarly, a high-energy/UV shutter 745 may be used to selectively control delivery of the high-energy component to the port 742 via a second series of optical elements. Other optical elements for purposes of directing, splitting, and otherwise modifying beams provided by the D/A laser 732 are indicated in FIG. 10 as optical elements 751A-751E.

As previously noted, and further illustrated in FIG. 10, the optical assembly 730 further includes the micro-level imaging device 738 and the illumination source 740. With respect to the micro-level imaging device 738, the optical assembly 730 further includes optical elements (e.g., optical element 752) to direct light from the port 742 to the micro-level imaging device 738. Similarly, the optical assembly 730 also includes optical elements (e.g., optical element 754) to direct light from the illumination source 740 through the port 742.

In light of the foregoing, it should be appreciated that the configuration of the optical assembly 730 is such that each of the desorption and ablation produced by use of the D/A laser 732 and light generated by the illumination source 740 exit through the port 742 of the optical assembly 730 when exit through the port 742 coaxially. In certain implementations, port 742 may include a mirror or similar optical element that directs the material removal beams and field of view into the sample chamber (e.g., downward into the image of FIG. 10). Similarly, light to be captured by the micro-level imaging device 748 enters the optical assembly 730 coaxially relative to beams generated by the D/A laser 732 and light produced by the illumination source 740. Stated differently, the field of view of the micro-level imaging device 748 is coaxial with each of desorption beams, ablation beams, and illumination light produced by the optical assembly 730 as each exits or enters the port 742.

In general, axial alignment of material removal beams and the field of view of the micro-level imaging device 748 may be achieved using at least one common optical element that passes or directs the material removal beams and/or the field of view of the micro-level imaging device 748 through the port 742 along a common axis. For example, as illustrated in FIG. 10, the paths of each of the material removal beams and the field of view of the micro-level imaging device 748 pass through, are reflected by, or are otherwise directed to optical element 751E. Subsequent to meeting optical element 751E, each of the material removal beams and the field of view are directed to port 742 along substantially the same axis. Accordingly, optical element 751E and any mirror that may be incorporated in port 742 may be considered common optical elements for purposes of facilitating coaxial direction of the material removal beams and field of view.

Although not depicted, the optical assembly 730 may further include additional optical elements for attenuating, focusing, splitting, or otherwise manipulating light within the optical assembly 730. For example, in one implementation, a respective beam splitter may be disposed along each of the low-energy beam path and the high-energy beam path to direct a portion of the corresponding beam to an energy meter or similar sensor to provide feedback and facilitate control of the analysis system 700.

Following finalization of an analysis routine, the user may initiate the analysis process. As previously discussed, (e.g., in the context of FIGS. 4-5D), analysis generally includes moving the sample 10 (e.g., by actuating the stage assembly 704) through a series of positions corresponding to locations defined by the selected or generated analysis routine and performing an analysis step at each such location. Analysis for a given location may generally include capturing a micro-level image of the location using the micro-level imaging device 738 and then performing one or both of organic and inorganic analysis. Organic analysis generally involves applying a low energy beam to the location to desorb organic material from the sample while inorganic analysis generally involves applying a high energy beam to the location to ablate inorganic material from the sample. The resulting vapor of desorbed material or particle cloud of ablated material is then ionized using an ionization beam generated by an ionization laser 780 (shown in FIGS. 7 and 8) and delivered to the ion extraction system 750 (illustrated in FIG. 11) for analysis. In certain implementations, the ionization beam is directed parallel to a top surface of the sample 10 after a delay (e.g., 100 ns-10 us) following delivery of the low energy beam (when conducting organic analysis) or high energy beam (when conducting inorganic analysis) to the sample 10. Such a delay may be implemented to allow plasmas to extinguish prior to ionization of the desorbed/ablated sample material.

Referring to FIG. 11, in certain implementations, the ion extraction system 750 may be adapted to one or more of concentrate, direct, and extract particular ions produced by applying the ionization beam to material that has been desorbed or ablated from the sample 10. For example, in certain implementations, the ion extraction system 750 may be configured to one or more of concentrate ions produced by the ionization beam, extract ions having particular kinetic energies, and direct extracted ions as a beam to the mass spectrometer 770 for analysis. The operating principle of the ion extraction system 750 may vary in implementations of the present disclosure. For example, in certain implementations, the ion extraction system 750 may be a radio frequency (RF)-based ion extraction system. In other implementations, the ion extraction system 750 may instead be an electrostatic ion extraction system.

In at least certain implementations, the ion extraction system 750 may include an ion funnel 758 for capturing, concentrating, and directing the ions produced by the ionization beam and a gate valve 756 operable to open the ion extraction system 750 to the sample chamber 702. In certain implementations, the ion funnel 758 may be operated at a predetermined frequency (e.g., 1-2 MHz) and may be formed from a series of plates, with every other plate being 90 degrees out of phase. Further, a DC bias may be applied to the ion funnel 758 and equally divided down the plates to form a gradient. During operation, the ion funnel 758 may direct the generated ions into a Quadrupole Ion Deflector (QID) 753 which turns the ions (e.g., by 90 degrees) and directs the ions to an Einzel stack 755. In certain implementations, the QID 753 may be tuned to reject the higher energy ions generated by the initial desorption/ablation and to direct only secondary post-desorption/ablation ions generated by the ionization beam into the Einzel stack 755. The Einzel stack 755 may manipulate (e.g., shape) the ions and further direct the ions to one or more additional elements for further processing/shaping and ultimately to the mass spectrometer 770 for analysis. As illustrated in FIG. 11, each of the ion funnel 758 and the QID 753 may be arranged to lie along the axis 701 of the ablation beam, desorption beam, and micro-level imaging device field of view.

Although the foregoing implementation of the present disclosure generally illustrates the material removal beams and field of view being directed along axis 701 and that axis 701 is substantially vertical or otherwise perpendicular to a top surface of the sample 10, it should be understood that the concepts disclosed herein are not necessarily limited to such implementations. For example, and among other things, while the optical assembly 730 may be configured to direct material removal beams and the field of view of the micro-level imaging device 738 along a common axis, that axis may be non-perpendicular to the top surface of the sample 10.

### Off-Axis Ion Extraction

Systems according to this disclosure operate by applying a beam to a sample, creating a cloud of material, e.g., by ablation or desorption of the material from the sample. Due to the energy involved in generating the cloud of material, the cloud often consists of a combination of neutral particles and positively charged particles, which are referred in this disclosure as “primary ions”. The system then applies a beam for controlled ionization of the cloud of material and directs the ions produced by the controlled ionization to a mass spectrometer for analysis. For purposes of this disclosure, the charged particles generated by the controlled application of the ionization beam are referred to as “secondary ions”.

Due to the way in which the system creates the primary ions, the primary ions often have unpredictable and highly variable characteristics. In contrast, the secondary ions produced by the ionization beam are much more predictable and, as a result, more suitable for analysis by the mass spectrometer. Accordingly, achieving accurate and repeatable test results in systems according to this disclosure can depend on being able to remove the primary ions prior to generation of the secondary ions and to ensure that substantially only secondary ions are delivered to the mass spectrometer for analysis.

In previously discussed implementations, the disclosed system achieved separation between primary and secondary ions by waiting for plasma extinction. Stated differently, the system used a brief delay between application of the desorption/ablation beam and application of the ionization beam such that any positively charged particles generated by the first beam would neutralize, dissipate, or move prior to ionization. In contrast to this passive approach to separating primary and secondary ions, other implementations of this disclosure include an ion extraction assembly that actively directs primary ions away from an ion extraction path extending from an ion extraction chamber to the mass spectrometer and actively directs secondary ion towards and along the extraction path.

The ion extraction assembly includes an aperture plate disposed above the sample and including an aperture through which the desorption/ablation beam and the cloud of material generated by the beam can pass. The aperture has an aperture axis along which the system directs the desorption/ablation beam. The ion extraction assembly further includes an ion extractor tip offset from the aperture axis. The ion extractor tip includes an inlet positioned along the ion extraction path and is in communication with other components (e.g., lenses, valves, etc.) for directing secondary ions to the mass spectrometer for analysis. The ion extractor assembly may also include a repelling plate adjacent the aperture to enable further field shaping for selective direction of ions.

During operation, the ion extraction assembly is selectively operated in each of a rejection state and an acceptance state. When in the rejection state, the system charges components of the ion extraction assembly to generate a rejection field that directs positively charged ions away from the inlet of the ion extractor tip. So, for example, when in the rejection state, the system may positively charge each of the ion extractor tip and the aperture plate such that the resultant electromagnetic field propels positive ions upwards and away from the inlet of the ion extractor tip. When in the rejection state, the system charges components of the ion extraction assembly to generate an acceptance field that directs positively charged ions toward the inlet of the ion extractor tip and along the extraction path. So, for example, in the rejection state the system may negatively charge each of the ion extractor tip and the aperture plate such that the resultant electromagnetic field reduces upward motion of positive ions and directs positive ions towards the inlet of the ion extractor tip.

In certain implementations, a repelling plate disposed opposite the extractor tip may further shape the electromagnetic field. For example, the repelling plate may reinforce the rejection and acceptance fields by being negatively charged during rejection (e.g., to “pull” positive ions away from the inlet) and positively charged during acceptance (e.g., to “push” positive ions towards the inlet). Alternatively, for simplicity and cost effectiveness, the system may positively charge the repelling plate in both states, relying instead on charging of the ion extractor tip and the aperture plate to form the necessary electromagnetic fields.

These and other aspects of the ion extraction subsystem are now discussed in further detail with reference to the figures.

The following description of analysis systems and related components according to this disclosure generally assume that the primary and secondary ions are positively charged. Accordingly, operation of the analysis system (e.g., the ion extraction assembly) is described from the perspective of controlling and directing positive ions. For example, the ion extraction assembly includes various components that are selectively charged to create various electromagnetic fields for directing (e.g., accepting or rejecting) charged ions. The following description discusses charging and general operation of such components under the assumption that the charged ions are positively charged. Nevertheless, implementations of the present disclosure may be configured or adapted to generate, direct, process, and/or analyze negatively charged ions. For example, and unless otherwise specified below, the ion extraction assembly can be generally adapted to direct negative ions by reversing the polarity of charges applied to components of the ion extraction assembly when handling positive ions.

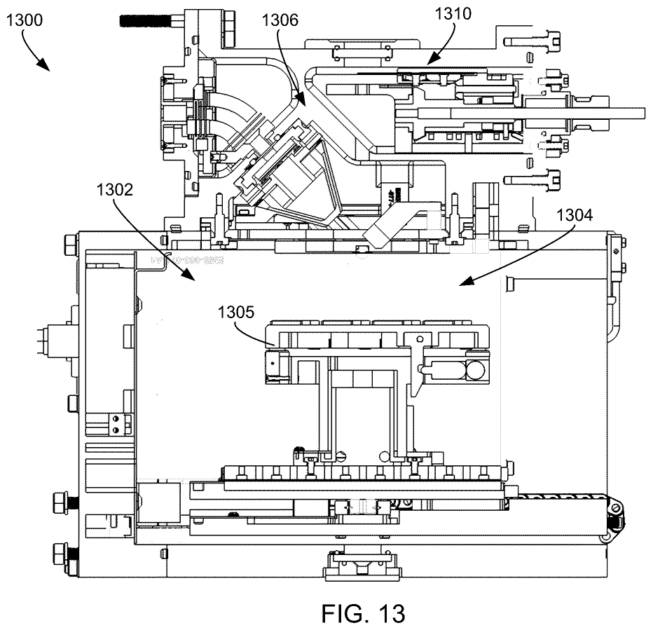

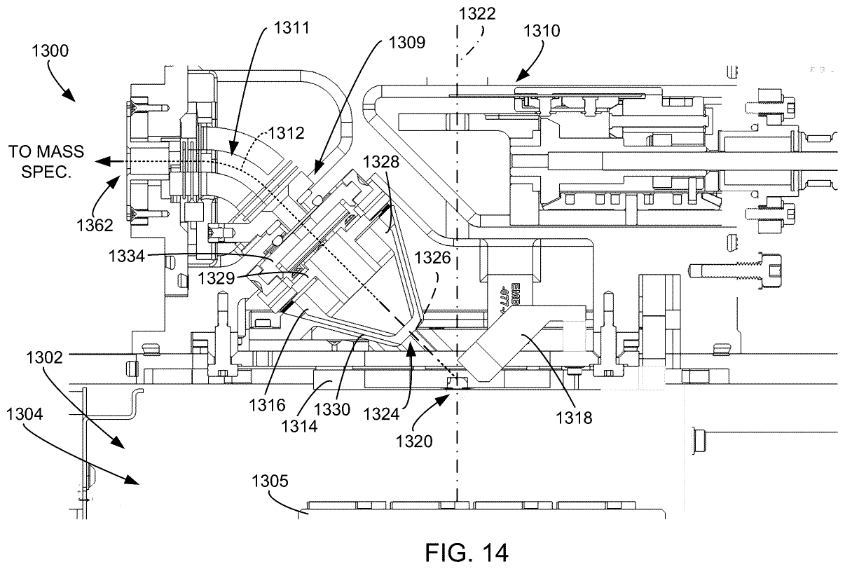

FIG. 13 is a cross-sectional view of a portion of a system 1300 according to the present disclosure. System 1300 includes an internal chamber 1302 generally divided into a sample chamber 1304 and an ion processing chamber 1306. FIG. 14 is a detailed view of ion processing chamber 1306.

Sample chamber 1304 may include a sample holder 1305 on which a sample may be mounted for analysis. In certain implementations, sample holder 1305 may be movable within sample chamber 1304 to analyze multiple locations of the sample without having to open sample chamber 1304 to reposition the sample. System 1300 may be configured to analyze multiple locations of a sample along a path similar to the multi-location analysis discussed above in the context of FIG. 4.

Like previous implementations of this disclosure, during operation, a beam (e.g., a desorption or ablation beam) is applied to a sample supported by sample holder 1305 within sample chamber 1304 to generate a cloud of material. System 1300 ionizes neutral particles of the cloud using an ionization beam applied at a location above the sample. System 1300 then delivers the resulting ionized material to a mass spectrometer for analysis.

The cloud of material produced by the initial beam applied by system 1300 may have a combination of both neutral and positively charged particles, the latter of which this disclosure refers to as “primary ions”. To improve accuracy and repeatability, system 1300 preferably applies the ionization beam to only the neutral particles of the cloud such that creation of the resulting ionized material occurs under controlled conditions. The ionized material is referred to in this disclosure as “secondary ions”.

In certain implementations, system 1300 may operate according to a timing protocol in which a delay is imposed between applying the desorption/ablation beam and applying the ionization beam. In this approach, system 1300 delays application of the ionization beam to permit extinction and/or travel of the primary ions away from an ionization location, thereby increasing the likelihood that only neutral particles will be affected by the ionization beam.

In contrast to this passive approach and with reference to FIG. 14, other implementations of system 1300 may include an ion extraction assembly 1310 above sample chamber 1304 in ion processing chamber 1306. Ion extraction assembly 1310 defines an ion channel 1311 extending between ion processing chamber 1306 and a mass spectrometer (e.g., a time-of-flight (TOF) mass spectrometer, not shown) in communication with ion processing chamber 1306. FIG. 14 further illustrates an ion extraction path 1312 through ion channel 1311, which illustrates a mean or target path of ions directed along ion channel 1311 to the mass spectrometer. To direct and concentrate ions along ion extraction path 1312, ion extraction assembly 1310 may include various electromagnetic lenses and similar components distributed along ion extraction path 1312 (collectively referred to as an ion bender assembly 1309) and which are discussed below in further detail.

During operation, system 1300 selectively changes ion extraction assembly 1310 between a rejection state and an acceptance state. Generally, when in the rejection state, ion extraction assembly 1310 produces an electromagnetic field that directs positively charged ions away from ion extraction path 1312. In contrast, when in the acceptance state, ion extraction assembly 1310 directs ions actively repels positively charged ions away from ion extraction path 1312. Accordingly, after system 1300 produces a cloud of material from a sample using a desorption or ablation beam, system 1300 initially places ion extraction assembly 1310 in the rejection state to divert primary ions away from ion extraction path 1312. Following generation of secondary ions by controlled ionization, system 1300 changes ion extraction assembly 1310 into the acceptance state to direct the resultant secondary ions along ion extraction path 1312 for reception and subsequent analysis by the mass spectrometer.

As shown in FIG. 14, ion processing chamber 1306 includes ion extraction assembly 1310, which further includes an aperture plate 1314, an ion extractor tip 1316, and a repelling plate 1318.

Aperture plate 1314 includes an aperture 1320 defining an aperture axis 1322. Aperture axis 1322 is aligned with the path of the desorption/ablation beam such that when system 1300 applies the desorption/ablation beam to a sample within sample chamber 1304, the resultant cloud of material passes through aperture 1320.

Ion extractor tip 1316 defines an ion extractor inlet 1324 having an inlet axis 1326 that is aligned with ion extraction path 1312. Ion extractor tip 1316 includes an inner cone 1328, an outer cone 1330 surrounding inner cone 1328, and a tube lens 1329 disposed opposite ion extractor inlet 1324 and in communication with the inner volume of inner cone 1328. Tube lens 1329 is separated from the rest of ion channel 1311 by a gate valve 1334 that may be closed to isolate internal chamber 1302 from the mass spectrometer. During operation, system 1300 selectively opens and closes gate valve 1334 to permit ions to travel along ion extraction path 1312 to the mass spectrometer. Additional details of gate valve 1334 are provided below.

Ion extraction assembly 1310 further includes ion bender assembly 1309, which includes multiple electromagnetic lenses disposed along ion extraction path 1312 to facilitate directing and shaping of ion streams. In the illustrated implementation, ion extraction assembly 1310 includes multiple lenses of varying configurations. As described below in further detail, in at least certain implementations gate valve 1334 may also be configured to act as an electromagnetic lens when in the open position.

System 1300 is generally configured to switch ion extraction assembly 1310 and related systems between a rejection state in which primary ions are directed away from ion extraction path 1312 and an acceptance state in which secondary ions are directed along ion extraction path 1312. To do so, system 1300 switches ion extractor tip 1316 between being positively and negatively charged, respectively. More specifically, when ion extraction assembly 1310 is in the rejection state, system 1300 positively charges ion extractor tip 1316 to produce a rejection field that repels positive ions away from ion extractor inlet 1324. Conversely, when ion extraction assembly 1310 is in the acceptance state, system 1300 negatively charges ion extractor tip 1316 to produce an acceptance field in which the positively charged secondary ions are attracted towards ion extractor inlet 1324 and along ion extraction path 1312.

In certain implementations, ion extraction assembly 1310 may also include repelling plate 1318, which may be positioned generally opposite aperture 1320 from ion extractor inlet 1324. During operation, repelling plate 1318 may facilitate direction of ions relative to ion extraction path 1312. For example, when ion extraction assembly 1310 is in the acceptance state, repelling plate 1318 may be positively charged such that the positively charged secondary ions are repelled towards ion extractor inlet 1324.

Although referred to herein as a “repelling” plate, repelling plate 1318 may also be negatively charged to attract positively charged ions. For example, in certain implementations, when ion extraction assembly 1310 is in the rejection state, repelling plate 1318 may be negatively charged to attract primary ions away from ion extractor inlet 1324. Alternatively, to reduce cost and complexity of ion extraction assembly 1310 and its associated electrical control system, repelling plate 1318 may also be uncharged/off or positively charged while ion extraction assembly 1310 is in the rejection state provided that the field produced by ion extraction assembly 1310 results in a net repelling of the primary ions away from ion extractor inlet 1324. For example, if ion extractor tip 1316 has a higher positive charge than repelling plate 1318, the resulting electromagnetic field generally results in a net repelling of primary ions away from ion extractor inlet 1324 despite repelling plate 1318 producing a field on its own that would repel primary ions towards ion extractor inlet 1324.

In certain implementations, aperture plate 1314 may also be selectively charged when ion extraction assembly 1310 is in the rejection and acceptance states. For example, when ion extraction assembly 1310 is in the rejection state, aperture plate 1314 may be positively charged. When positively charged, aperture plate 1314 shapes the rejection field to induce acceleration of primary ions past ion extractor inlet 1324 (e.g., in the upward direction relative to the arrangement illustrated in FIGS. 13 and 14). In contrast, when ion extraction assembly 1310 is in the acceptance state, aperture plate 1314 may be negatively charged to inhibit acceleration of secondary ions past ion extractor inlet 1324 and to allow the secondary ions to be more easily directed along ion extraction path 1312.

Notably, ion extraction assembly 1310 may be used in sample analysis systems that perform both desorption- and ablation-based analysis, similar to those describe earlier in this disclosure. However, ion extraction assembly 1310 is more generally applicable to any analysis system in which ions are preferably separated (e.g., primary from secondary ions) or directed/extracted along a preferred path. Accordingly, while certain implementations of system 1300 may be configured to perform both desorption- and ablation-based analysis, this disclosure contemplates that system 1300 may alternatively conduct sample analysis using ablation or desorption only.

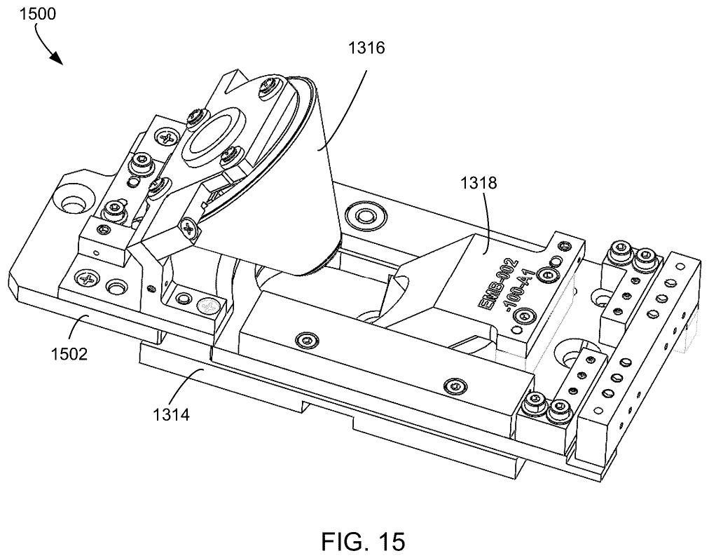

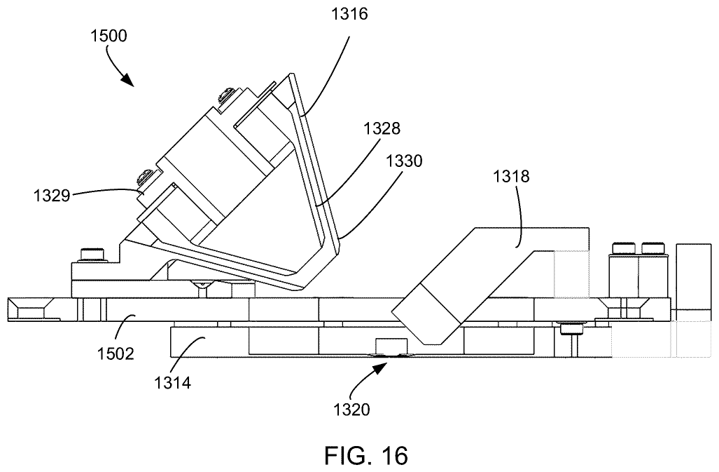

FIGS. 15 and 16 are an isometric view and a cross-sectional view of a modular assembly 1500 that may include certain components of the ion extraction assembly 1310 and may facilitate ready assembly, repair, reconfiguration, and the like of systems according to the present disclosure. The example modular assembly 1500 includes a frame 1502 coupled to and supporting each of aperture plate 1314, ion extractor tip 1316, repelling plate 1318, and related sub-components.

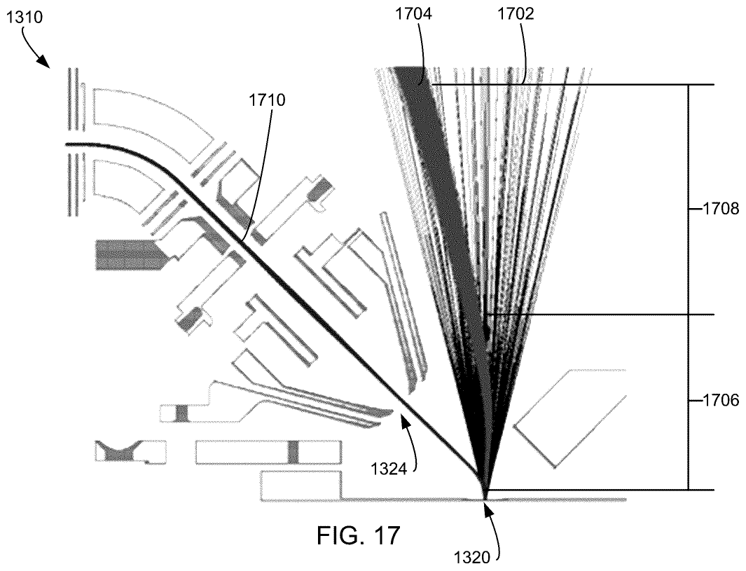

FIG. 17 is a cross-sectional view of ion extraction assembly 1310 illustrating the movement of particles and ions during operation of system 1300. FIG. 17 includes each of a neutral particle trajectory 1702, a primary ion trajectory 1704, and a secondary ion trajectory 1710 over time. During operation, system 1300 generates a plume of material by applying an ablation or desorption beam to a sample disposed within sample chamber 1304. Neutral particles produced by the beam pass through aperture 1320 and disperse in a generally conical pattern, as illustrated by neutral particle trajectory 1702 due to their not being influenced by the acceptance or rejection fields produced by ion extraction assembly 1310.

Primary ion trajectory 1704 illustrates the path of the primary ions during operation of system 1300 over time. Accordingly, a first portion 1706 of primary ion trajectory 1704 generally corresponds to movement of primary ions when ion extraction assembly 1310 is initially operated in the rejection state while a second portion 1708 of primary ion trajectory 1704 generally corresponds to movement of primary ions while ion extraction assembly 1310 is operated in the rejection state.

When in the rejection state, ion extraction assembly 1310 produces a field that repels positively charged ions away from ion extractor inlet 1324. Accordingly, first portion 1706 of primary ion trajectory 1704 generally bends away from ion extractor inlet 1324. As previously noted, while in the rejection state, ion extraction assembly 1310 may also accelerate the primary ions past ion extractor inlet 1324 (e.g., in an upwards direction relative to the view shown in FIG. 17).

Subsequent to being operated in the rejection state, system 1300 ionizes a portion of the neutral particles above aperture 1320 and switches ion extraction assembly 1310 into the acceptance state. The resulting secondary ions are directed along secondary ion trajectory 1710 for analysis. Notably, the field produced by ion extraction assembly 1310 when in the acceptance state may still affect the primary ions, as illustrated by second portion 1708 of primary ion trajectory 1704 bending towards ion extractor inlet 1324. However, by the time system 1300 switches ion extraction assembly 1310 into the acceptance state, the primary ions are positioned substantially above and away from ion extractor inlet 1324 such that there is minimal likelihood that any of the primary ions will enter ion extractor inlet 1324.

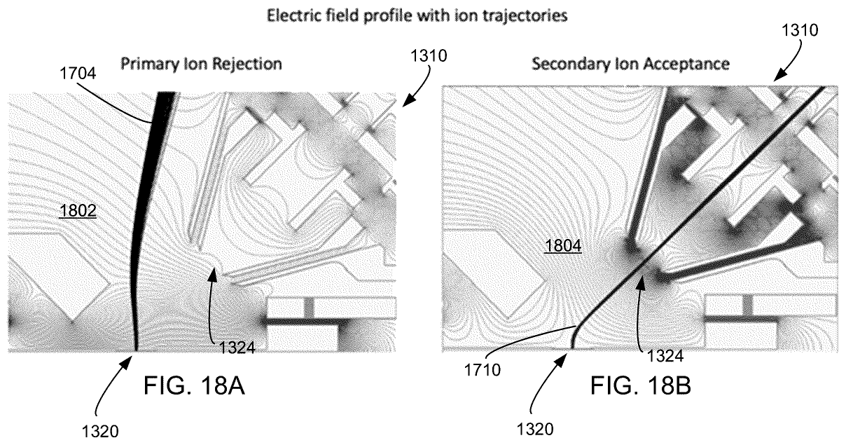

FIGS. 18A and 18B illustrate the fields produced by ion extraction assembly 1310 in each of the acceptance and rejection states with primary ion trajectory 1704 and secondary ion trajectory 1710, respectively. More specifically, FIG. 18A illustrates a rejection field 1802 configured to direct positively charged ions away from ion extractor inlet 1324 while FIG. 18B illustrates an acceptance field 1804 configured to direct positively charged ions towards ion extractor inlet 1324. In general, the density of the field lines shown in FIGS. 18A and 18B correspond to the relative field strength at the corresponding location. Accordingly, as shown in FIG. 18A, when ion extraction assembly 1310 is operated in the rejection state, a maximum field density is located between aperture 1320 and ion extractor inlet 1324. Given that the rejection field 1802 is electromagnetically positive, positively charged ions are repelled away from ion extractor inlet 1324. In contrast, as shown in FIG. 18B, when ion extraction assembly 1310 is operated in the acceptance state, the acceptance field is electromagnetically negative and shaped to have relatively high density adjacent ion extractor inlet 1324. As a result, positive ions (e.g., secondary ions) are directed into ion extractor inlet 1324 and along the ion extraction path for delivery to the mass spectrometer.

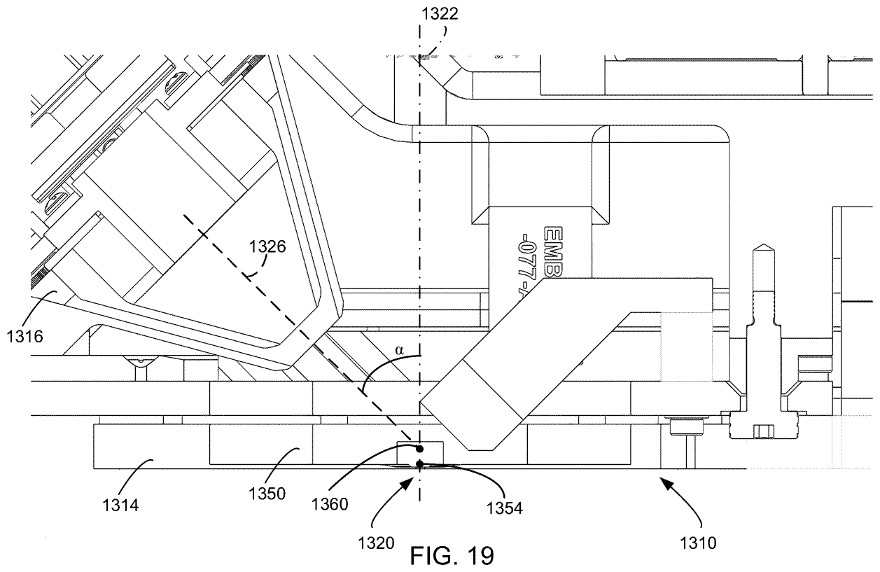

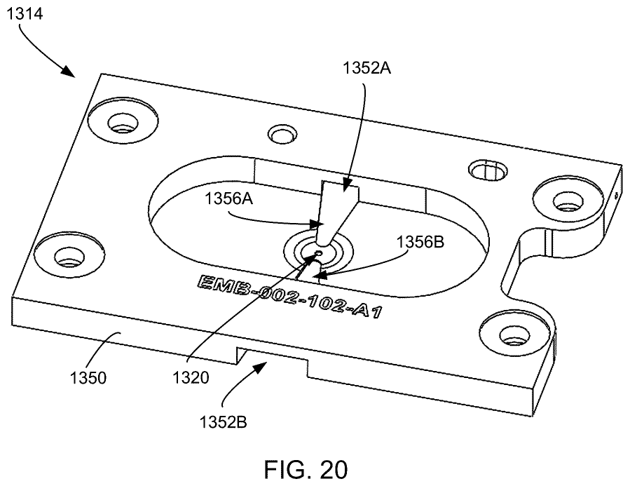

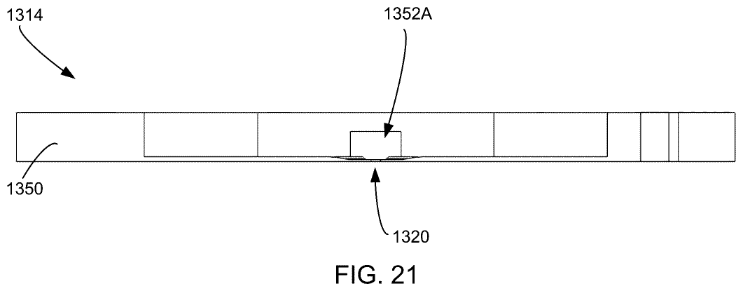

FIG. 19 is a detailed cross-sectional view of system 1300 and, specifically ion extraction assembly 1310, illustrating certain geometric relationships between components of ion extraction assembly 1310 while FIGS. 20 and 21 are isometric and cross-sectional views of aperture plate 1314, which illustrate features of aperture plate 1314 relevant to the relationships illustrated in FIG. 19.

Referring first to FIGS. 20 and 21, aperture plate 1314 generally includes a plate body 1350 including aperture 1320. Aperture axis 1322 (shown in FIG. 19) extends through and normal to aperture 1320. During operation, desorption and ablation beams pass through aperture 1320 along aperture axis 1322 to desorb and ablate material from a sample within sample chamber 1304 (shown in FIG. 13). The material produced from the sample then passes through aperture 1320 for further processing and redirection by ion extraction assembly 1310.

Plate body 1350 further includes ionization windows, such as ionization window 1352A and ionization window 1352B, through which system 1300 directs an ionization beam to produce secondary ions from neutral particles that pass through aperture 1320. So, for example, the ionization beam enters plate body 1350 through ionization windows 1352A and exits through ionization windows 1352B. As the ionization beam passes through plate body 1350, it intersects with aperture axis 1322 at an ionization location 1354 (shown in FIG. 19) disposed above aperture 1320. Accordingly, material located at ionization location 1354 when system 1300 delivers the ionization beam will undergo controlled ionized to produce secondary ions.

In at least certain implementations, plate body 1350 may be locally thinned about aperture 1320 and may include cutouts between the ionization windows and aperture 1320. For example, plate body 1350 may include troughs, such as trough 1356A and trough 1356B extending between aperture 1320 and ionization window 1352A and ionization window 1352B, respectively.

Referring back to FIG. 19, ion extractor tip 1316 generally defines inlet axis 1326 extending through ion extractor inlet 1324. As shown, ion extractor tip 1316 is positioned such that inlet axis 1326 intersects with aperture axis 1322. For purposes of this discussion, the location at which inlet axis 1326 and aperture axis 1322 intersect is referred to as extractor intersection 1360. Extractor intersection 1360 is generally positioned above ionization location 1354. In certain implementations, extractor intersection 1360 may be positioned from about 0 mm to about 20 mm above ionization location 1354. For example, in one specific implementation, extractor intersection 1360 may be positioned about 1 mm above aperture 1320.

In addition to the offset of extractor intersection 1360 relative to ionization location 1354, the angle α between inlet axis 1326 and aperture axis 1322 may vary in implementations of this disclosure. In certain implementations, α may be from and including about 30 degrees to and including about 60 degrees. For example, in one specific implementation, α may be approximately 45 degrees.

Ion extraction assembly 1310 is not limited to the specific geometry illustrated in the previously discussions and associated figures. Rather, various aspects of ion extraction assembly 1310 can be adjusted for specific applications and, in particular, to tune the acceptance and rejection fields produced by ion extraction assembly 1310. By way of example, the operating voltages of the various components of ion extraction assembly 1310, the size and geometry of individual components of ion extraction assembly 1310, and the relative positioning and orientation of components of ion extraction assembly 1310 can all be modified for a given application.

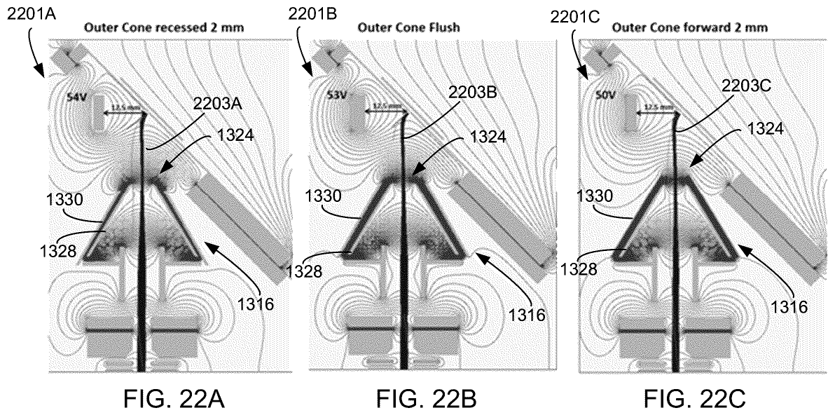

By way of non-limiting example, FIGS. 22A-22C illustrate variations in fields 2201A-2201C and corresponding secondary ion trajectories 2203A-2203C produced by modifying the relative positioning between inner cone 1328 and outer cone 1330 of ion extractor tip 1316. More specifically, FIG. 22A illustrates outer cone 1330 recessed by approximately 2 mm relative to inner cone 1328; FIG. 22B illustrates outer cone 1330 and inner cone 1328 in a flush mounted arrangement; and FIG. 22C illustrates outer cone 1330 extending forward of inner cone 1328 by approximately 2 mm. Among other things, the relative positioning of the cones may be relied upon to control the field densities at ion extractor inlet 1324 and, as a result, the relative force with which positively charged ions are directed along a target ion extraction path. For example, the arrangement shown in FIG. 22C (i.e., inner cone 1328 recessed relative to outer cone 1330) results in a substantially denser field at ion extractor inlet 1324 than that shown in FIG. 22A (i.e., outer cone 1330 recessed relative to inner cone 1328).

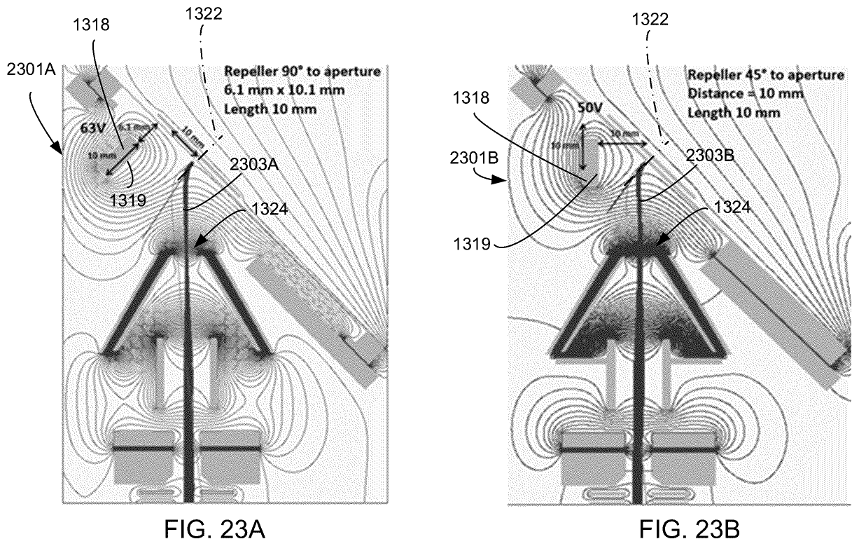

FIGS. 23A and 23B illustrate other examples of ion extraction assembly designs. In particular, FIGS. 23A and 23B illustrate how a change in orientation and positioning of repelling plate 1318 can alter the resultant fields 2301A, 2301B produced by the ion extraction assembly and the resultant secondary ion trajectories 2303A, 2303B. In FIG. 23A, for instance, repelling plate 1318 is positioned such that a leading surface 1319 extends parallel to aperture axis 1322. In contrast, FIG. 23B illustrated repelling plate 1318 with leading surface 1319 disposed at approximately 45 degrees relative to aperture axis 1322. As shown, despite lower voltage being applied to repelling plate 1318, the field density at ion extractor inlet 1324 is substantially increased relative to the 90-degree orientation shown in FIG. 23A, thereby increasing the tendency of secondary ions to be directed into ion extractor inlet 1324 and along ion extraction path 1312.

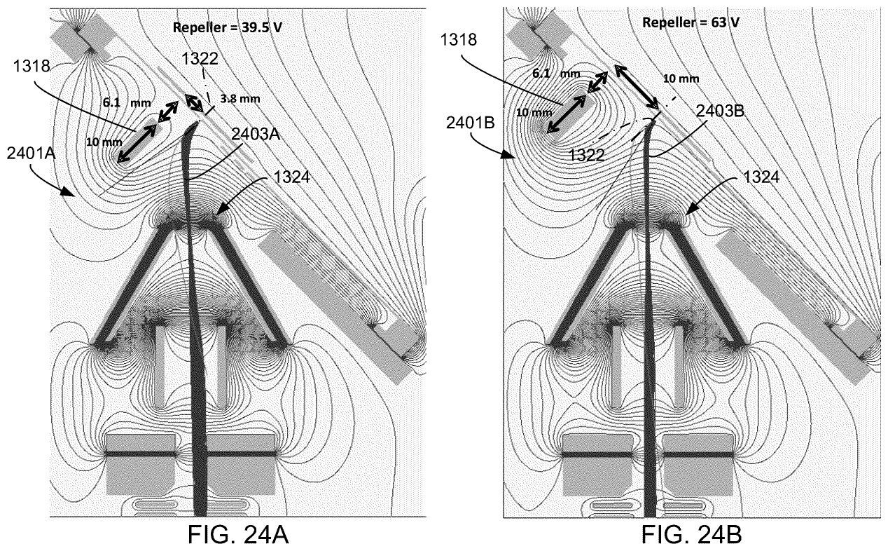

FIGS. 24A and 24B illustrate the effect of offsetting repelling plate 1318 relative to aperture 1320. FIG. 24A illustrates a field 2401A and a secondary ion trajectory 2403A when repelling plate 1318 is oriented parallel to aperture axis 1322, offset from aperture 1320 by approximately 3.8 mm, and given a voltage of approximately 39.5 V. As shown in FIG. 24A, secondary ion trajectory 2403A is suboptimal in that there is a likelihood that at least a portion of the secondary ions will contact or otherwise interfere portions of ion extraction assembly 1310 disposed along ion extraction path 1312. FIG. 24B, on the other hand, illustrates a field 2401B and a secondary ion trajectory 2403B. when repelling plate 1318 is oriented parallel to aperture axis 1322, offset from aperture 1320 by approximately 10 mm, and given a voltage of approximately 63 V. Notably, the configuration of FIG. 24B corrects the issues present in that of FIG. 24A, with secondary ion trajectory 2403B being better aligned with a target ion extraction path and interference between secondary ion trajectory 2403B and internal components of ion extraction assembly 1310 eliminated.

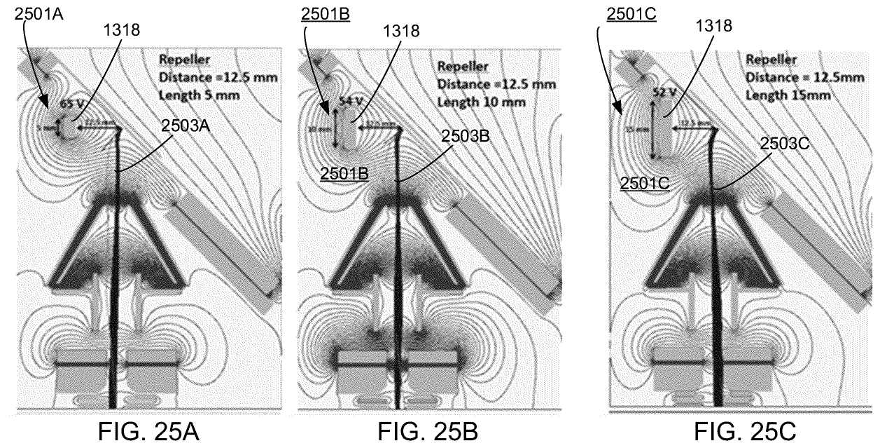

FIGS. 25A-25C illustrate the effect of repelling plate size (i.e., a thickness of leading surface 1319 of repelling plate 1318) on field, other parameters being substantially equal. As shown, the field 2501A produced in the configuration of FIG. 25A (5 mm repelling plate 1318) results in a suboptimal secondary ion trajectory 2503A that deviates from ion extraction path 1312. The field 2501C produced in the configuration of FIG. 25C (15 mm repelling plate 1318) also results in a suboptimal ion trajectory 2503C that deviates from ion extraction path 1312. In contrast, the field 2501B produced by the configuration of FIG. 25B (10 mm repelling plate repelling plate 1318) provides an improved secondary ion trajectory 2503B in which the secondary ions are directed substantially along ion extraction path 1312.

Notably, while certain example configurations shown in FIGS. 22A-25C illustrate suboptimal secondary ion trajectories, such configurations may result in improved secondary ion trajectories under certain conditions and with tuning and optimization of system 1300 and ion extraction assembly 1310. For example, the voltage applied to components of ion extraction assembly 1310 may be modified to alter and tune the resultant electromagnetic field to provide improved direction of secondary ions along the ion extraction path. As another example, certain configurations and arrangements of ion extraction assembly 1310 may be more suitable for directing secondary ions of certain materials (e.g., heavier or lighter particles) or secondary ions having different charges. While the discussion above regarding FIGS. 22A-25C identify certain configurations as resulting in suboptimal secondary ion trajectories, such suboptimality is for specific conditions and should not imply that the corresponding configurations are disclaimed or otherwise outside the scope of this disclosure. Rather, each of the example implementations shown in FIGS. 22A-25C may be suitable for a given application/operating conditions and are considered to be non-limiting implementations within the scope of this disclosure.

### Ion Bender Assemblies

As previously discussed, ion extraction assembly 1310 includes ion bender assembly 1309, which further includes ion extractor tip 1316 and multiple electromagnetic lenses disposed along ion extraction path 1312. Among other things, the electromagnetic lenses are selectively controlled to direct and shape secondary ion streams for delivery to a mass spectrometer for analysis.

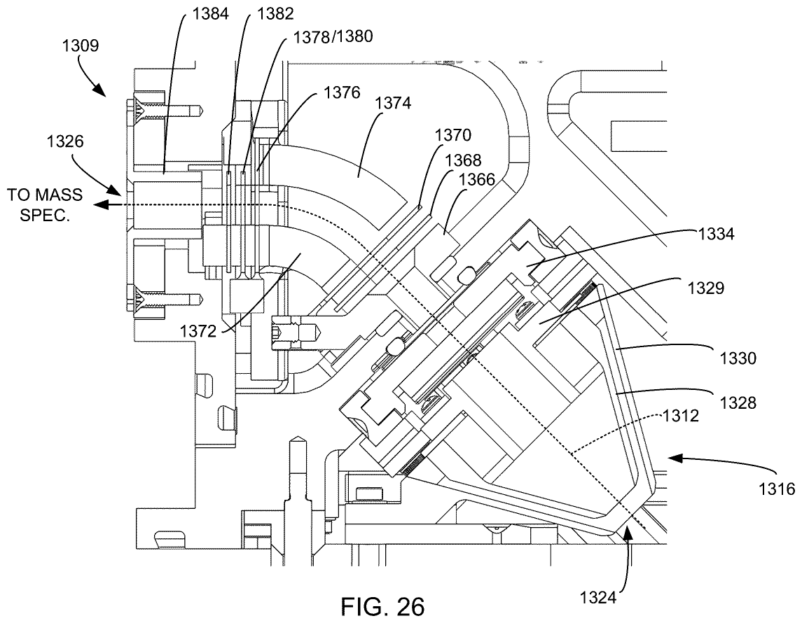

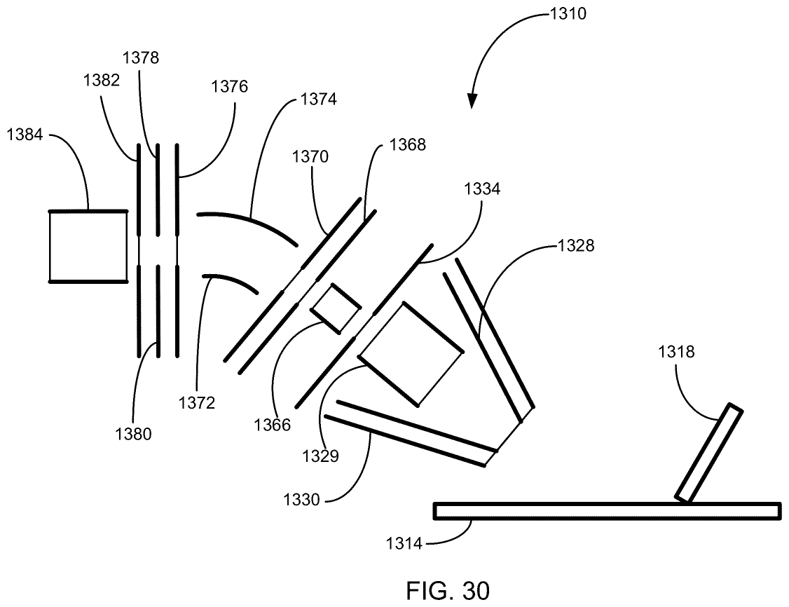

FIG. 26 is a detailed cross-sectional view of ion bender assembly 1309 and FIG. 30 is a cross-sectional plan view of the same. As shown, ion bender assembly 1309 is generally configured to direct a stream of ions along ion extraction path 1312 from ion extractor inlet 1324 to an outlet 1362 in communication with a mass spectrometer (e.g., a TOF mass spectrometer, not shown). In the specific implementation shown, ion extraction path 1312 includes a 45-degree bend; however, in other implementations, ion extraction path 1312 may include bends of more or less than 45 degrees or may include multiple bends.

In addition to directing secondary ions around any bends between ion extractor inlet 1324 and outlet 1362, ion bender assembly 1309 may also concentrate the secondary ions into a more focused stream. Notably, while this disclosure primarily illustrates ion extraction path 1312 as being curved and refers to ion bender assembly 1309 as an ion “bender” assembly, this disclosure contemplates that ion extraction path 1312 may be substantially straight. In such implementations, directing secondary ions around curves of ion extraction path 1312 may not be necessary but ion bender assembly 1309 may nevertheless concentrate and direct secondary ions for analysis by the mass spectrometer.

Although other arrangements are contemplated to be within the scope of this disclosure, FIG. 26 illustrates one potential configuration of ion bender assembly 1309. As shown and beginning from ion extractor inlet 1324, ion bender assembly 1309 generally includes inner cone 1328, outer cone 1330, and tube lens 1329 of ion extractor tip 1316, with tube lens 1329 disposed between inner cone 1328 and gate valve 1334. In certain implementations, gate valve 1334 may be configured to be electrically chargeable when in its open position such that gate valve 1334 may act as a lens when open. Following gate valve 1334, ion bender assembly 1309 includes lenses 1366-1380. As shown, lenses 1366-1382 include an inlet tube lens 1366; plate lenses 1368, 1370, 1376, and 1382; curved lenses 1372 and 1374; an outlet tube lens 1384; and a split lens including a first split lens segment 1378 and a second split lens segment 1380.

The lenses of ion extraction assembly 1310 are configured to collectively shape and direct secondary ions. In certain applications, the plate and tubular lenses are configured and charged to emphasize shaping, while the curved lenses and split lens are configured and charged to emphasize redirecting the secondary ion stream. Nevertheless, any component of ion extraction assembly 1310 that produces or shapes an electromagnetic field can be used to influence the concentration and direction of secondary ions.

In the example implementation of FIG. 26 redirection of the secondary ion stream is provided primarily by curved lenses 1372, 1374. However, as secondary ions pass through curved lenses 1372, 1374, their trajectory may deviate from ion extraction path 1312. Accordingly, a split lens is provided after the curved lenses to correct the trajectory of the secondary ions prior to delivery to the mass spectrometer.

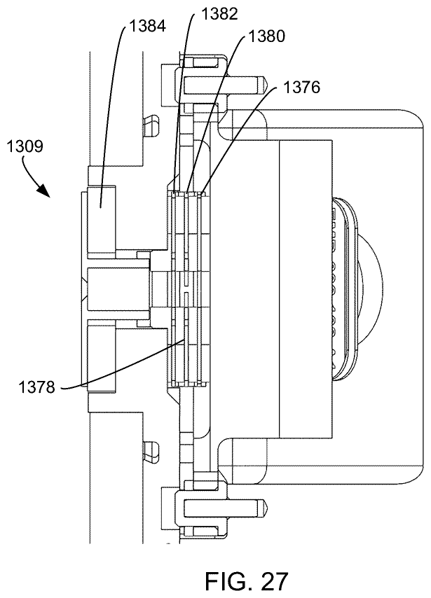

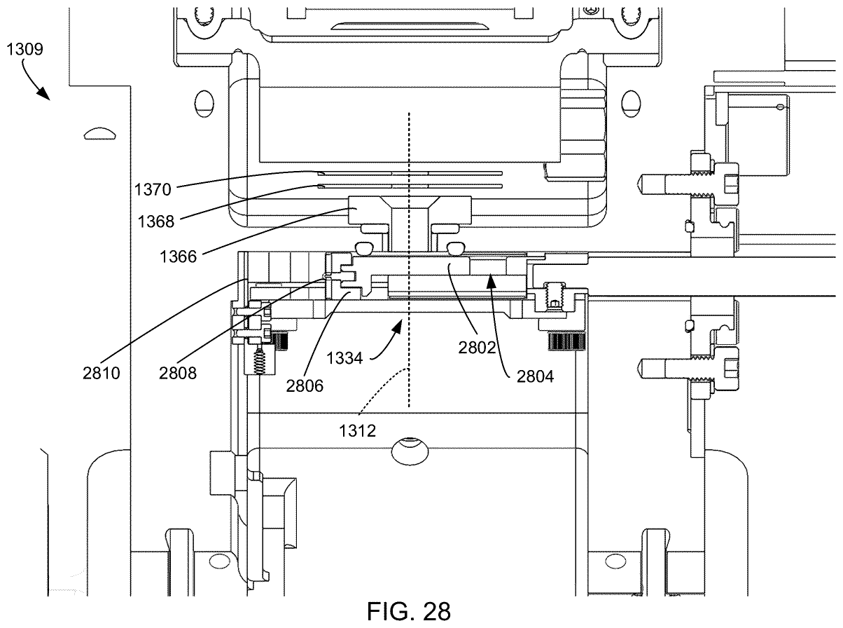

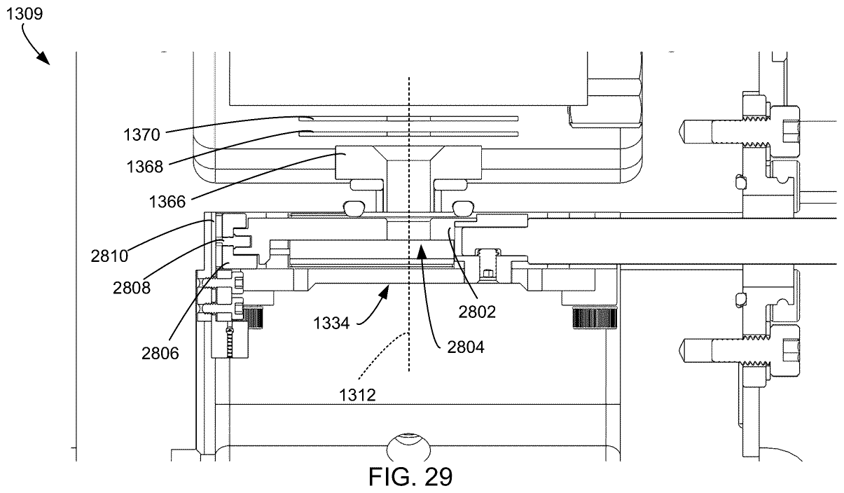

FIG. 27 is a top view of ion bender assembly 1309 that more clearly illustrates the arrangement of the split lens. As shown, the split lens includes a first split lens segment 1378 disposed opposite a second split lens segment 1380, each of which may be separately and independently charged. To correct the trajectory of secondary ions as they exit the curved lenses 1372, 1374, first split lens segment 1378 and second split lens segment 1380 may be charged unevenly to modify the electromagnetic field in their vicinity such that the secondary ions directed towards ion extraction path 1312, thereby correcting the trajectory of the secondary ions.

First split lens segment 1378 and second split lens segment 1380 are illustrated in FIG. 27 as being disposed directly opposite each other. While doing so reduces the overall length of ion bender assembly 1309, in alternative implementations first split lens segment 1378 and second split lens segment 1380 may be offset along ion extraction path 1312. Moreover, implementations of the present disclosure may include any suitable number of split lenses and/or lens segments to correct the trajectory of the secondary ions prior to delivery to the mass spectrometer.

FIGS. 28 and 29 are detailed views of ion bender assembly 1309 including gate valve 1334. More specifically, FIG. 28 illustrates gate valve 1334 in the closed configuration while FIG. 29 illustrates gate valve 1334 in the open configuration.

Mass spectrometers for use with system 1300 include internal volumes that are kept at a vacuum during testing. In system 1300, internal chamber 1302 (shown in FIG. 13) is in communication with the mass spectrometer to provide secondary ions for analysis and, as a result, must be kept at near vacuum during sample analysis. While mass spectrometers often include vacuum pumps for drawing down pressure within the mass spectrometer, such pumps are generally inadequate to draw down pressure in larger volumes, such as internal chamber 1302.

To address this issue in system 1300, gate valve 1334 is positioned between the mass spectrometer and internal chamber 1302. Prior to sample chamber 1304 of internal chamber 1302 being opened to insert, remove, or change samples, gate valve 1334 is closed, thereby maintaining the internal volume of the mass spectrometer at or near vacuum. When sample chamber 1304 is closed and internal chamber 1302 is sealed relative to the external environment, gate valve 1334 is kept closed such that a rough vacuum pump of system 1300 can be used to substantially draw down internal chamber 1302. Once an initial draw down threshold is reached, gate valve 1334 is opened and system 1300 activates the finer vacuum pump of the mass spectrometer to complete the draw down process.

### Gate Valves Including Chargeable Gates

Referring to FIGS. 28 and 29, gate valve 1334 includes a gate 2802 movable between an open and closed position and defining an aperture 2804. In the open position shown in FIG. 29, aperture 2804 generally aligns with ion extraction path 1312 such that communication is established between internal chamber 1302 and the mass spectrometer. In contrast and as shown in FIG. 28, when gate valve 1334 is in the closed position, aperture 2804 is not aligned with ion extraction path 1312 and gate 2902 blocks ion extraction path 1312, thereby sealing internal chamber 1302 from the mass spectrometer.

Given that gate valve 1334 is positioned along ion extraction path 1312, in at least certain implementations, gate valve 1334 may be configured to act as a lens in addition to performing its gating/sealing functions. To do so, gate 2802 of gate valve 1334 may be formed from an electrically conductive material and may be selectively charged when in the open position.

In the implementation shown in FIGS. 28 and 29, gate 2802 of gate valve 1334 is supported by an insulating frame 2806, which may also act as a bearing and seal for gate 2802. A conductive pin 2808 or similar contact element may be electrically coupled to gate 2802 and extend through insulating frame 2806. In the closed position shown in FIG. 28, conductive pin 2808 is not connected to a power source such that gate 2802 is uncharged. In contrast, when gate 2802 is in the open position, conductive pin 2808 makes an electrical connection with a contact 2810. Although not shown in FIGS. 28 and 30, contact 2810 may be electrically coupled to a broader wiring and power system of system 1300 and corresponding switching or control system to selectively provide power to contact 2810 and, by extension, gate 2802 of gate valve 1334.

By functioning as both a method of sealing ion processing chamber 1306 from the mass spectrometer and an electromagnetic lens, gate valve 1334 performs multiple functions and, as a result, obviates the need for separate gate valve and lens elements. Among other advantages, using gate valve 1334 as both a gate and lens in this way can reduce the overall size of ion bender assembly 1309, thereby allowing more space within system 1300 for other components or facilitating reduction in the overall size of system 1300.

Additionally, using gate valve 1334 as both a lens and gate can improve analysis by the mass spectrometer by reducing the overall length of ion extraction path 1312. Accurate readings by a TOF mass spectrometer generally requires that ions be delivered to the mass spectrometer for analysis as close to simultaneously as possible. To the extent ions must travel before reaching a mass spectrometer, the ions can separate with ions of heavier elements (e.g., uranium) lagging behind ions of lighter elements (e.g., lithium). In general, the longer the path ions must travel prior to reaching the mass spectrometer, the more pronounced their separation and, as a result, the less reliable the corresponding mass spectrometer results. Accordingly, by using gate valve 1334 to provide both gating and lens functionality, the overall length of ion extraction path 1312 is reduced and the reliability of results provided by the mass spectrometer can be increased.

In addition to combining lens and gating functionality into gate valve 1334, ion bender assembly 1309 may be configured in other ways to reduce the overall size of ion bender assembly 1309 and to shorten the length of ion extraction path 1312. For example, certain implementations of ion bender assembly 1309 may include one or more split lenses to facilitate steering of ion streams. Although segments of split lenses may be offset along ion extraction path 1312 and still provide ion directing functionality, disposing split lens segments directly opposite each other (such as illustrated by first split lens segment 1378 and second split lens segment 1380 in FIG. 27), the overall size of ion bender assembly 1309 and the overall length of ion extraction path 1312) may be reduced.

### Example Charging Schemas for Ion Extraction Assemblies

FIG. 30 is a schematic diagram of ion extraction assembly 1310 including components of ion extraction assembly 1310 that may be charged to generate a rejection field and an acceptance field when ion extraction assembly 1310 is in the rejection and acceptance field, respectively.

The following tables illustrate voltage ranges and example voltages applied to the different components when ion extraction assembly 1310 is in the rejection and acceptance state. The following tables should not be considered limiting, but rather reflect various example voltages that may be used during operation of ion extraction assembly 1310.

TABLE 1
Example Charging Schema for Ion Extraction
Assembly (Rejection State)

| Component | Range | Example Value |
|---|---|---|
| Aperture plate 1314 | >=100 V or <=−50 V | 130 V |
| Repelling plate 1318 | −400 V to 400 V | 40 V |
| Inner cone 1328 | >50 V | 100 V |
| Outer cone 1330 | −400 V to 10 V | 0 V |

TABLE 2
Example Charging Schema for Ion Extraction Assembly (Acceptance State)

| Component | Range 1 | Range 2 | Example Value | |
|---|---|---|---|---|
| Aperture plate 1314 | 0 V to 50 V | 20 V to 40 V | 30 | V |
| Repelling plate 1318 | 0 V to 100 V | 10 V to 60 V | 40 | V |
| Inner cone 1328 | −400 V to −100 V | −350 V to −100 V | −180 | V |
| Tube lens 1329 | −400 V to 10 V | −160 V to 10 V | −150 | V |
| Outer cone 1330 | −400 V to 10 V | −160 V to 10 V | 0 | V |
| Gate valve 1334 | −400 V to 10 V | −160 V to −10 V | −150 | V |
| Inlet tube lens 1366 | −400 V to 10 V | −160 V to −10 V | −150 | V |
| Plate lens 1368 | −400 V to 10 V | −160 V to −10 V | −90 | V |
| Plate lens 1370 | −400 V to 10 V | −160 V to −10 V | −90 | V |
| Curved lens 1372 | −400 V to 10 V | −160 V to −10 V | −44 | V |
| Curved lens 1374 | −400 V to 10 V | −160 V to −10 V | −103 | V |
| Plate lens 1376 | −400 V to 10 V | −160 V to −10 V | −90 | V |
| Split lens segment 1378 | −400 V to 10 V | −160 V to −10 V | −90 | V |
| Split lens segment 1380 | −400 V to 10 V | −160 V to −10 V | −90 | V |
| Outlet tube lens 1384 | −400 V to 10 V | −160 V to 10 V | −10 | V |

As noted, Tables 1 and 2 include various ranges and operational voltages for components of ion extraction assembly 1310 during operation in the rejection and acceptance states, respectively. Table 1 includes only a subset of components of ion extraction assembly 1310 and generally excludes components downstream of inner cone 1328 given that ions do not enter inner cone 1328 and are substantially unaffected by components downstream of inner cone 1328. Accordingly, in certain implementations, components downstream of gate valve 1334 may be maintained at their acceptance state charge when ion extraction assembly 1310 is in the rejection state. In other implementations, components downstream of gate valve 1334 may be uncharged when ion extraction assembly 1310 is in the rejection state and then charged according to Table 2 when ion extraction assembly 1310 is put into the acceptance state.

Notably, Table 1 lists the voltage range of aperture plate 1314 as being greater than or equal to 100 V or less than or equal to −50 V. In implementations in which aperture plate 1314 is configured to have a positive voltage during operation in the rejection state, the positively charged aperture plate is intended to repel positive primary ions above aperture plate 1314. Stated differently, after primary ions pass through aperture 1320 of aperture plate 1314, the positive charge of aperture plate 1314 is intended to repel the primary ions, accelerating the primary ions past ion extractor inlet 1324. Alternatively, in implementations in which aperture plate 1314 is negatively charged during rejection, aperture plate 1314 is intended to attract primary ions from below aperture plate 1314 and accelerate the primary ions through aperture 1320 where they are then subjected to fields produced by other components of ion extraction assembly 1310 to divert the primary ions away from ion extractor inlet 1324.

As previously discussed, when system 1300 is configured to process negative ions, charge polarities are generally reversed. As a result, when processing negative ions, the magnitude of voltages in Tables 1 and 2 for the listed components may remain the same albeit with reversed polarities.

### Glass Shield Assemblies

Systems of this disclosure include chambers within which a user places a sample for analysis. When closed following insertion of a sample, the chamber seals such that a vacuum can form within the chamber. The system then delivers desorption/ablation and ionization beams to generate ions from the material for analysis. To allow the desorption/ablation and ionization beams to enter the chamber, the chamber may include windows (formed, e.g., of coated glass or a similar material) through which the various beams pass to enter the chamber. Certain implementations of this disclosure may rely on desorption or ablation only. Alternatively, and as discussed previously, systems according to this disclosure may perform either or both of desorption and ablation of a sample. Moreover, implementations of this disclosure may include systems configured to analyze multiple locations of a sample, including in a programmed sequence/along a programmed path.

During operation, laser ablation and desorption produces dust and debris within the chamber that may settle or otherwise accumulate on various surfaces within the chamber. Among these surfaces are the interior surfaces of the windows through which the beams enter the chamber. If left to accumulate, the dust and debris can obstruct the window, reducing the power of any beam passing through the window and/or deflecting or partially scattering the beam. Accordingly, to ensure proper and accurate functioning of the system, the interior surfaces of the windows must be protected and/or regularly cleaned.

In one implementation of the present disclosure, the system includes a glass shield disposed between the sample and a window of the sample chamber. For example, in certain implementations, the system may direct the desorption and/or ablation beams vertically down through a window of the sample chamber and onto the sample. The system may include a glass shield between the window and the sample such that as the system generates plumes of material from the sample, any dust and debris builds up on the glass shield instead of on the window.

To avoid the previously discussed issues of material buildup impacting beam performance, the glass shield is part of a broader assembly that moves the glass shield such that the areas of the glass shield through which the beam passes vary over time. Stated differently, as material builds up on an area of the glass shield, the assembly indexes the glass shield such that the assembly exposes a “fresh” area of the glass shield to the plumes of material produced during desorption and/or ablation of the sample. The size, shape, and indexing pattern of the glass can vary to adjust the life of the glass shield and the time between cleanings/replacements of the glass shields. For example, in certain implementations, the glass shield may be shaped and indexed to be replaced or cleaned every month, every quarter, bi-annually, or annually.

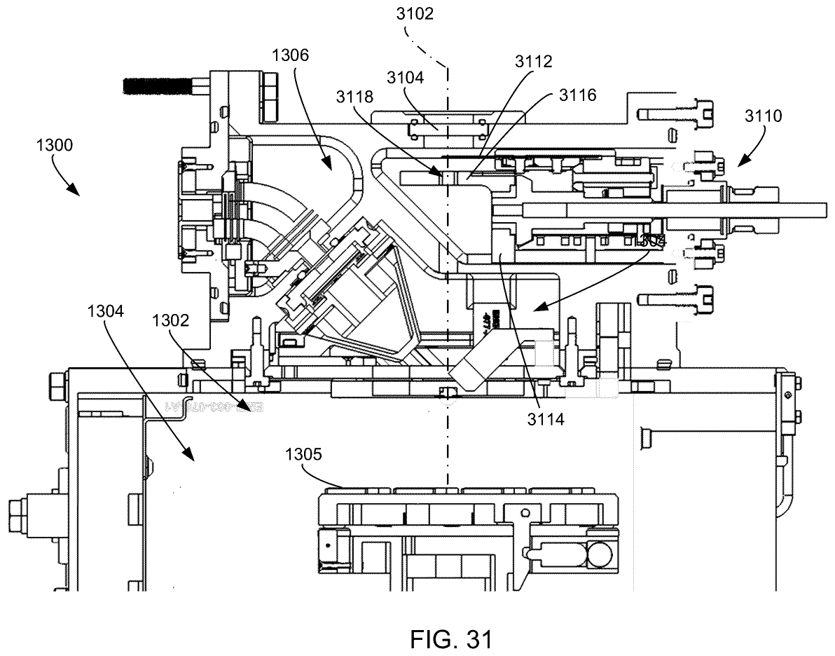

FIG. 31 is a detailed cross-sectional view of system 1300. In particular, FIG. 31 includes internal chamber 1302 which is divided into sample chamber 1304 and ion processing chamber 1306. As described throughout this disclosure, during operation of system 1300, a sample is placed on sample holder 1305 and an ablation or desorption beam is applied to the sample to liberate material from the sample. As previously noted, systems of this disclosure may be configured for ablation only, desorption only, or both ablation and desorption.

The ablation/desorption beam is delivered along a beam axis 3102 (which is coincident with aperture axis 1322, described above in further detail). Given that internal chamber 1302 is sealed such that it can be maintained at a vacuum, internal chamber 1302 includes a window 3104 through which the ablation/desorption beam passes to enter internal chamber 1302. In at least certain implementations, window 3104 may be formed using a coated glass.

During operation of system 1300, material ejected from samples by the ablation/desorption beam travels into ion processing chamber 1306. While some of the material is ultimately directed to the mass spectrometer for analysis, other material remains in ion processing chamber 1306 and can settle on surfaces within ion processing chamber 1306, including the inner surface of window 3104. Over time, such buildup can negatively impact any beams passed through window 3104, e.g., by reducing the power or deflecting the beam.

Given the sealing required for window 3104 and the likely presence of coatings on window 3104, replacing or cleaning window 3104 in response to material buildup can be impractical and/or expensive (e.g., requiring recoating resealing of window 3104). To address this issue, system 1300 may include a glass shield assembly 3110 configured to protect window 3104. Glass shield assembly 3110 generally includes a glass shield 3112 disposed between window 3104 and sample chamber 1304 along beam axis 3102. Glass shield 3112 may be formed from a material that is optically transparent (e.g., quartz glass) to the desorption and ablation beams such that glass shield 3112 does not affect the beams in any substantial way. However, due to the positioning of glass shield 3112 between window 3104 and sample chamber 1304, any sample material that would typically build up on window 3104 is deposited instead on glass shield 3112.

As shown in FIG. 31, glass shield assembly 3110 may include a frame 3114 having a plate 3116 extending across beam axis 3102. Plate 3116 may define a shield aperture 3118 aligned with beam axis 3102 such that the desorption/ablation beam is able to pass through glass shield assembly 3110 into sample chamber 1304. Plate 3116 and shield aperture 3118 also limit and control the size and spread of material that passes upwards towards glass shield 3112. As a result, ejected material deposits on glass shield 3112 in a relatively controlled way and on a known surface location of glass shield 3112.

As described below in further detail, glass shield assembly 3110 is configured to be readily accessible when internal chamber 1302 is opened (e.g., to change samples) to permit cleaning or changing of glass shield 3112 when glass shield 3112 becomes sufficiently fouled. Glass shield assembly 3110 may also include an actuator for transitioning or indexing glass shield 3112 relative to shield aperture 3118. So, for example, glass shield 3112 may be initially positioned such that a first portion of glass shield 3112 is positioned above shield aperture 3118. When glass shield 3112 becomes fouled, the actuator may index glass shield 3112 into a new position or orientation relative to shield aperture 3118 such that an unfouled portion of glass shield 3112 is positioned over shield aperture 3118 for subsequent testing. This process may be repeated through a series of glass shield configurations to increase the amount of surface area of glass shield 3112 that is fouled before requiring glass shield 3112 to be cleaned or replaced.

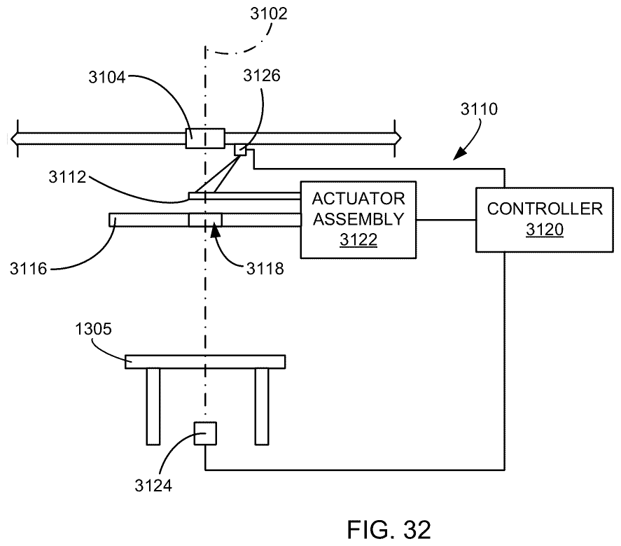

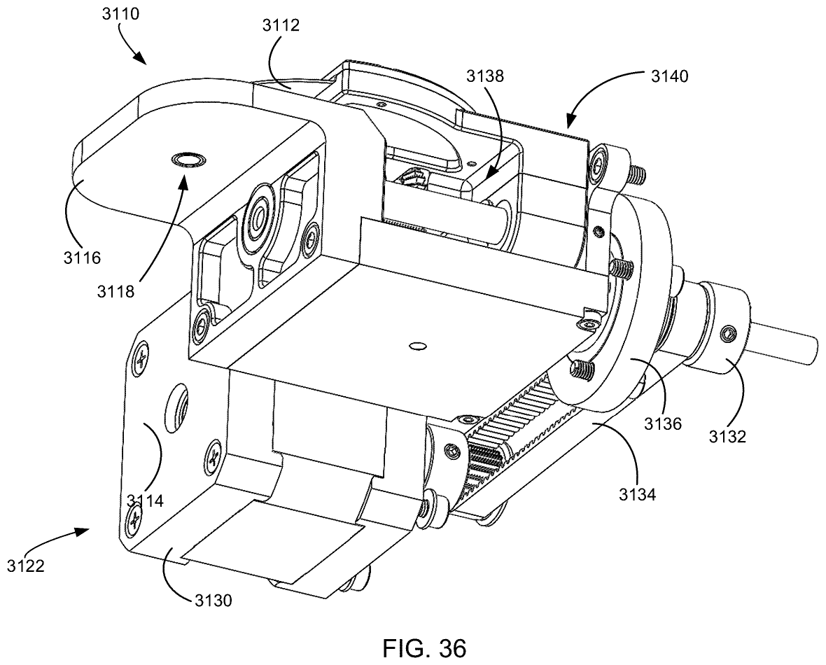

FIG. 32 is a simplified schematic diagram of system 1300 illustrating control of glass shield assembly 3110. As shown, window 3104, a portion of glass shield 3112, and shield aperture 3118 of plate 3116 are each aligned along beam axis 3102. Beam axis 3102 extends into sample chamber 1304, within contains sample holder 1305. FIG. 36 further includes a controller 3120 communicatively coupled to an actuator assembly 3122, which is configured to move glass shield 3112 relative to shield aperture 3118 in response to control signals received from controller 3120.

Indexing of glass shield 3112 relative to shield aperture 3118 may occur in various ways and in response to various events. In general, however, indexing in the context of glass shield assembly 3110 refers to actuator assembly 3122 moving (e.g., by rotating and/or translating) glass shield 3112 relative to shield aperture 3118 to expose a new/clean location of glass shield 3112 to material passing through shield aperture 3118.

In certain implementations, indexing occurs based on a predetermined number of samples (e.g., the assembly indexes the glass shield to a new position every 20 samples) or a predetermined time period (e.g., every 3 days or every 2 hours of operational time). So, for example, controller 3120 may track the number of analyses performed by system 1300 or monitor time between indexing and issue an indexing control command to actuator assembly 3122 in response to either value exceeding a corresponding threshold. In other implementations, a user of system 1300 may index glass shield 3112 manually by providing a corresponding command to controller 3120.

In still other implementations, indexing of glass shield 3112 may occur in response to one or more monitored parameters. FIG. 36, for example, illustrates an example subsystem for monitoring the condition of the desorption and ablation beam and indexing glass shield 3112 in response to changes in the condition. More specifically, controller 3120 may be configured to monitor characteristics of a test beam as delivered to sample chamber 1304 and to issue an index command to actuator assembly 3122 in response to changes in the characteristics. In certain implementations, the test beam may be a beam having characteristics similar to an ablation beam or a desorption beam generated by system 1300 during sample testing; however, the test beam is not limited to having such characteristics.

A beam sensor 3124 may be fixed or placed within sample chamber 1304 along a beam path of the desorption/ablation beam. As shown in in FIG. 36, for example, beam sensor 3124 is positioned along beam axis 3102. More specifically, FIG. 36 illustrates beam sensor 3124 as being positioned under sample holder 1305, which may include holes, apertures, or windows that permit desorption, ablation, or test beams to reach beam sensor 3124 when a sample is not present. Alternatively, beam sensor 3124 may be temporarily placed on sample holder 1305 in line with beam axis 3102 to measure characteristics of the delivered beam. In one specific example implementation, beam sensor 3124 measures the power of the test beam as delivered to sample chamber 1304. In still other implementations, beam sensor 3124 may be offset from beam axis 3102 but system 1300 may include additional optical elements to direct a beam to beam sensor 3124 at a location below/after glass shield 3112. While beam sensor 3124 may measure beam power, in other implementations, beam sensor 3124 may measure spread, position/deflection, or other characteristics of the test beam. Beam sensor 3124 may then transmit a corresponding measurement to controller 3120, which determines whether the measurement deviates, exceeds, or is otherwise inconsistent with a specification (e.g., a threshold value). If the measurement is out of specification, controller 3120 may issue an indexing command to actuator assembly 3122 to index glass shield 3112. Alternatively, if controller 3120 has already indexed glass shield 3112 through a range of positions, controller 3120 may issue an alert, a warning, or similar communication that glass shield 3112 is to be cleaned or replaced.

In addition to or as an alternative to measuring characteristics of a test beam, controller 3120 may be configured to issue indexing commands based on a direct measurement of glass shield 3112. FIG. 36 includes a sensor 3126 placed and configured to assess the area of glass shield 3112 above shield aperture 3118. For example, sensor 3126 may be a camera or an infrared sensor that can determine whether and to what extent the location of glass shield 3112 is fouled. In other implementations, fouling of glass shield 3112 may be determined using an ultrasonic sensor, a sensor for measuring an electrical property (e.g., resistance) on a surface of glass shield 3112, a sensor for measuring a change in weight of glass shield 3112, and any other suitable sensors for measuring a change in glass shield 3112 resulting from fouling. Sensor 3126 may transmit measurements to controller 3120 which may issue indexing commands to actuator assembly 3122 in response to the measurements being outside of specification or otherwise indicative of fouling.

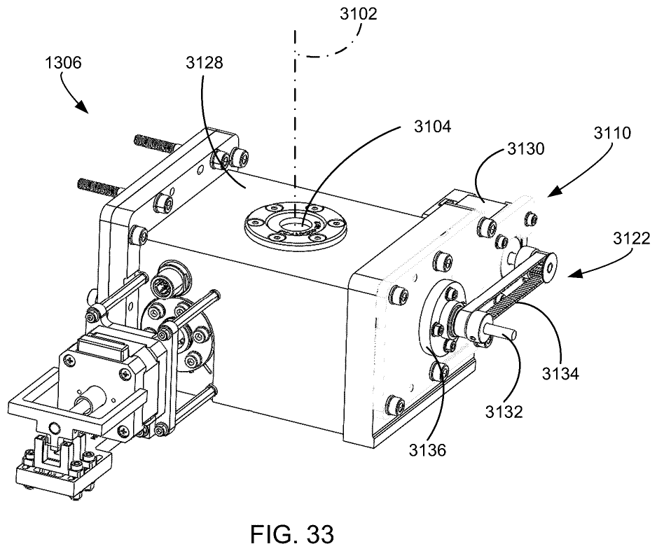

With the foregoing in mind, FIGS. 33-37B illustrate an example implementation of glass shield assembly 3110 according to this disclosure.

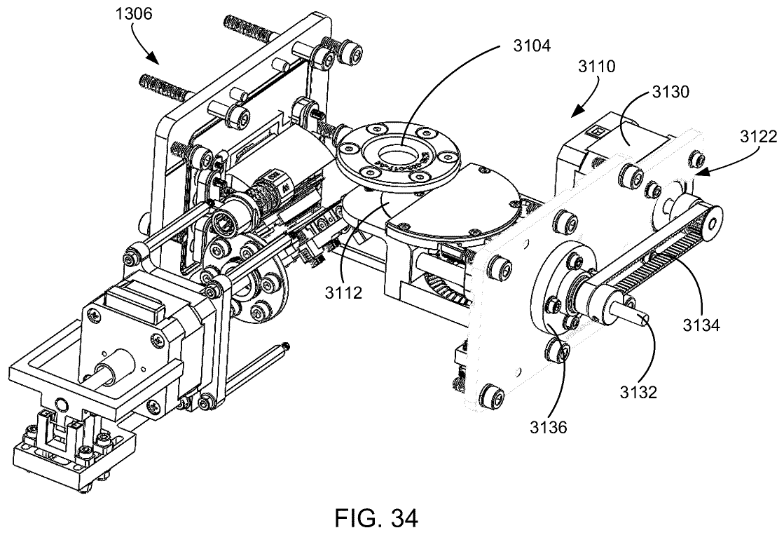

FIG. 33 is an isometric, external view of ion processing chamber 1306. Ion processing chamber 1306 includes an external housing 3128 that, when fully assembled in system 1300 is sealed to permit formation of a vacuum within ion processing chamber 1306. FIG. 34 is an isometric view of ion processing chamber 1306 with external housing 3128 partially removed to illustrate internal components of ion processing chamber 1306.

Referring to FIG. 33, window 3104 is shown as disposed on a top of external housing 3128 along beam axis 3102. Window 3104 is generally coupled to external housing 3128 such that a seal is formed between window 3104 and external housing 3128.

In the implementation shown in FIGS. 33 and 34, actuator assembly 3122 of glass shield assembly 3110 is partially disposed outside of external housing 3128. More specifically, actuator assembly 3122 includes a motor 3130 (e.g., a stepper motor) supported outside of external housing 3128. Motor 3130 is coupled to a drive shaft 3132 by a belt 3134 (although other coupling mechanisms (e.g., gears) may be used instead of belt 3134) and is configured to rotate drive shaft 3132 responsive to control signals received from a controller (e.g., controller 3120 of FIG. 32). As shown in FIG. 34, drive shaft 3132 extends through a portion of external housing 3128 into ion processing chamber 1306 to drive glass shield 3112 of glass shield assembly 3110, as described below in further detail. To maintain sealing of ion processing chamber 1306, a shaft seal 3136 is coupled to and supported by external housing 3128 and drive shaft 3132 extends through shaft seal 3136.

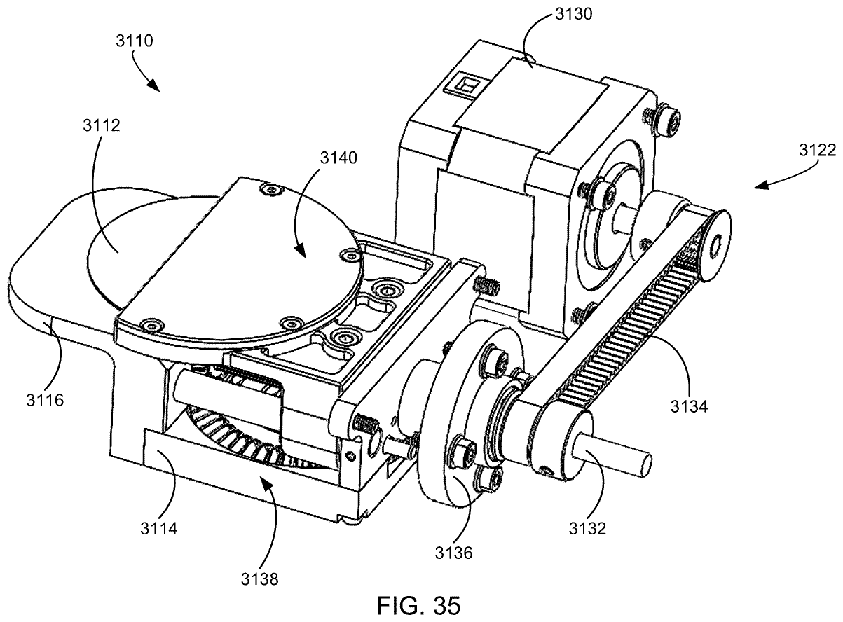

FIGS. 35 and 36 are top and bottom isometric views of glass shield assembly 3110, respectively. Glass shield assembly 3110 includes frame 3114, which includes plate 3116 and which may be mounted within ion processing chamber 1306. As previously discussed, plate 3116 further defines shield aperture 3118 (visible in FIG. 36), which is aligned with beam axis 3102 when frame 3114 is mounted within ion processing chamber 1306. Frame 3114 further supports each of a gear assembly 3138 to distribute power to various components of glass shield assembly 3110 and a shield shuttle assembly 3140 configured to facilitate translation of glass shield 3112.

Responsive to rotation of drive shaft 3132, gear assembly 3138 indexes glass shield 3112 to position different areas of glass shield 3112 over shield aperture 3118. In the specific implementation discussed in FIGS. 33-37B glass shield assembly 3110 is configured to index glass shield 3112 by both rotating and translating glass shield 3112 relative to shield aperture 3118. More specifically, starting with a clean glass shield, glass shield assembly 3110 disposes a location of glass shield 3112 at a first radius over shield aperture 3118. As glass shield assembly 3110 indexes glass shield 3112, glass shield assembly 3110 rotates glass shield 3112 such that non-overlapping areas of glass shield 3112 at the first radius are successively disposed over shield aperture 3118. Following a complete rotation, glass shield assembly 3110 translates glass shield 3112 to dispose a location of glass shield 3112 at a second, smaller radius over shield aperture 3118. Glass shield assembly 3110 then indexes glass shield 3112 through a second full rotation such that non-overlapping areas of glass shield 3112 at the second radius are successively disposed over shield aperture 3118. This process of translating then indexing glass shield 3112 through a full rotation of non-overlapping area being disposed over shield aperture 3118 may be repeated until all or a significant proportion of glass shield 3112 has been fouled.

To facilitate movement of glass shield 3112 relative to shield aperture 3118, glass shield 3112 may be supported by a shield shuttle assembly 3140. Shield shuttle assembly 3140 includes a shuttle 3142 that supports glass shield 3112 and that is translatable along a pair of rails, such as rail 3144 (a second rail being obscured in the views presented).

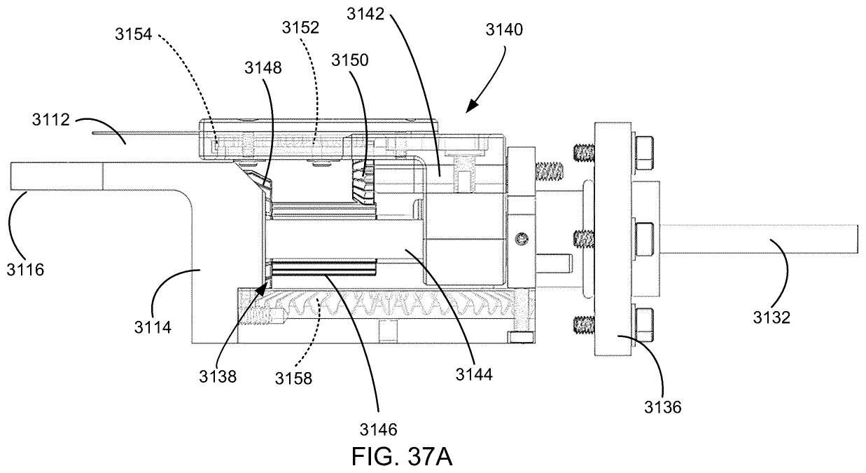

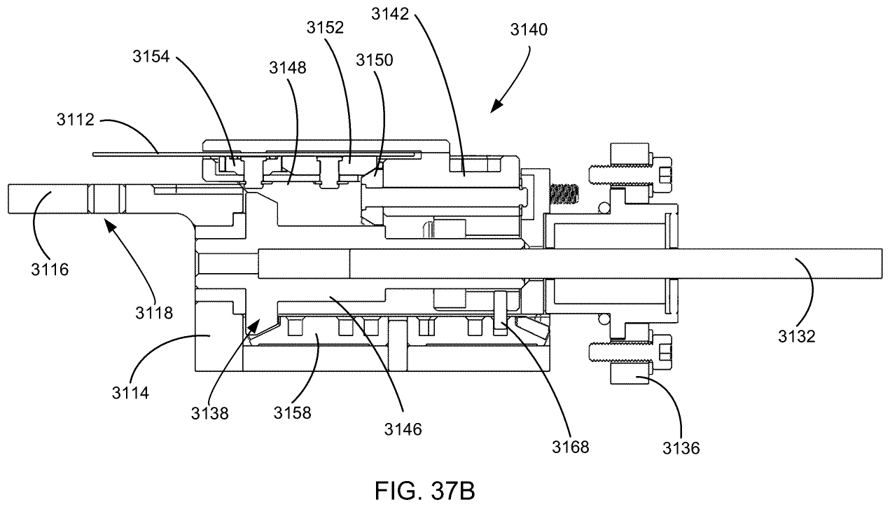

FIGS. 37A and 37B are elevation and cross-sectional views of glass shield assembly 3110 that further illustrate the drive system of glass shield assembly 3110. As illustrated, drive shaft 3132 extends through shaft seal 3136 in a direction generally parallel to rail 3144. Drive shaft 3132 includes each of a splined section 3146 and a drive shaft bevel gear 3148.

During operation, rotation of drive shaft 3132 is transferred to a gear train that drives rotation of glass shield 3112. In the specific implementation of FIGS. 37A and 37B, gear assembly 3138 includes a bevel gear 3150 in communication with a shield gear 3154 via an intermediate gear 3152. Shield gear 3154 is coupled to glass shield 3112 such that rotation of drive shaft 3132 results in rotation of glass shield 3112.

In certain implementations, glass shield 3112 may be coupled to shield gear 3154 using an adhesive or similar chemical bond instead of a mechanical coupling. Among other things, use of an adhesive/chemical bond avoid the necessity of drilling or otherwise cutting glass shield 3112 to mount glass shield 3112 onto shield gear 3154, thereby improving the structural integrity of glass shield 3112. Use of an adhesive/chemical bond also reduces the overall profile of glass shield 3112 and shield gear 3154 as compared to a mechanical coupling that may include a cap, fasteners, or other components disposed opposite shield gear 3154.

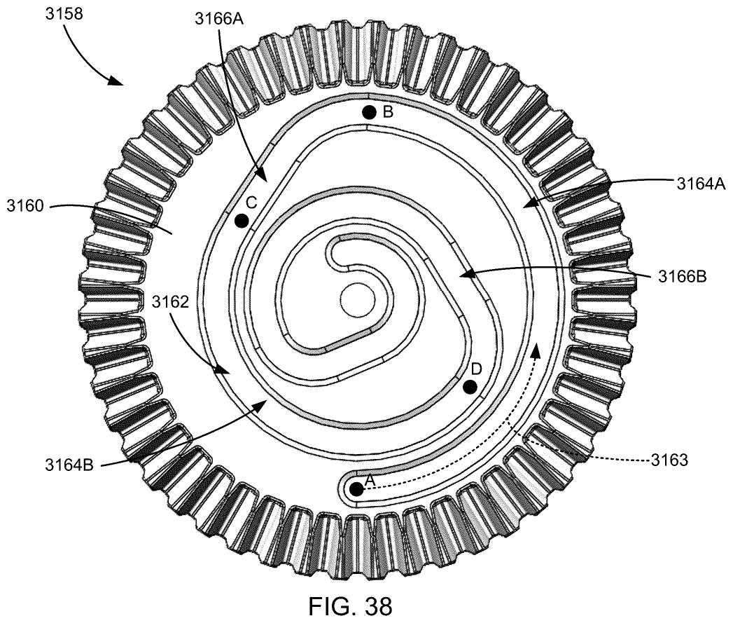

During operation, rotation of drive shaft 3132 is also transferred to a labyrinth gear 3158 by drive shaft bevel gear 3148, which is illustrated in FIG. 38 in further detail. As shown in FIG. 38, labyrinth gear 3158 includes a body 3160 defining an internal channel 3162 forming a path 3163. Internal channel 3162 generally includes curved sections (such as curved section 3164A and 3164B) interspersed with substantially straight sections (such as straight section 3166A and 3166B), thereby forming a non-uniform spiral pattern.

As shown in FIG. 37B, a pin 3168 is coupled to and extends from shuttle 3142 and into internal channel 3162. As drive shaft 3132 rotates, drive shaft bevel gear 3148 rotates labyrinth gear 3158. Rotation of labyrinth gear 3158 causes relative movement of pin 3168 and internal channel 3162 such that pin 3168 effectively “moves” along path 3163.

Notably, while pin 3168 transitions through curved sections of internal channel 3162, shuttle 3142 remains stationary on the rails of glass shield assembly 3110. In contrast, when pin 3168 transitions through straight sections of internal channel 3162, shuttle 3142 undergoes translation along the rails of glass shield assembly 3110.

By sizing and shaping the curved and straight sections of internal channel 3162 translation of shuttle 3142 can be timed to occur after a full rotation of glass shield 3112 using only a single drive. For example, through proper gearing, rotation of drive shaft 3132 such that glass shield 3112 undergoes a first full rotation with shield aperture 3118 at a first radius can simultaneously cause relative movement of pin 3168 from point A to point B along curved section 3164A, maintaining shuttle 3142 in a first position. Further rotation of drive shaft 3132 may then cause relative movement of pin 3168 from point B to point C along straight section 3166A to translate shuttle 3142 and, by extension, glass shield 3112 such that shield aperture 3118 is at a second radius of glass shield 3112. Further rotation of drive shaft 3132 causes another full rotation of glass shield 3112 as pin 3168 undergoes relative movement from point C to point D along curved section 3164B. This process can be repeated until to alternate periods of rotation of glass shield 3112 and translation of glass shield 3112 until pin 3168 reaches the end of internal channel 3162.

The foregoing approach to indexing glass shield 3112 may include programming controller 3120 to suitably actuate motor 3130. For example, controller 3120 may be configured to actuate motor 3130 by different step sizes depending on the radius at which shield aperture 3118 is positioned relative to glass shield 3112. For example, at a first radius, glass shield 3112 may have an area sufficient for 20 distinct “clean” surface locations. Accordingly, while at the first radius, controller 3120 may actuate motor 3130 to cause 18 degrees of rotation at glass shield 3112 when indexing. At a second radius, glass shield 3112 may only have an area sufficient for 10 surface locations, thereby requiring 36 degrees of rotation of glass shield 3112 when indexing.

As another example, controller 3120 may be configured to actuate motor 3130 by a relatively small steps during rotation of glass shield 3112 but by larger steps during translation of glass shield 3112. For example, controller 3120 may actuate motor 3130 in relatively small steps during rotation of glass shield 3112 such that pin 3168 undergoes relative movement along curved sections of internal channel 3162 (e.g., curved section 3164A, 3164B) in incremental steps. During translation of glass shield 3112, however, controller 3120 may actuate motor 3130 in a single large step that causes relative movement of pin 3168 through the entirety of the corresponding straight section of internal channel 3162 (e.g., straight section 3166A, 3166B).

The foregoing is just one implementation of an example system for moving glass shield 3112 relative to shield aperture 3118 to permit substantial portions of glass shield 3112 to be fouled before cleaning or replacement of glass shield 3112. The foregoing technique has the advantage of producing both rotation and translation of glass shield 3112 using a single drive. Nevertheless, other implementations are contemplated by this disclosure. For example, glass shield assembly 3110 may alternatively include multiple actuators, with a first actuator configured to rotate glass shield 3112 and second actuator configured to translate shuttle 3142. Glass shield assembly 3110 may alternatively be configured to only rotate glass shield 3112 or only translate glass shield 3112. For example, in one implementation, glass shield 3112 may be coupled to a movable stage that can be translated in two directions along a plane parallel to shield aperture 3118. In such an implementation, glass shield 3112 may be translated above shield aperture 3118 such that fouling occurs in a grid-like pattern on glass shield 3112 instead of the spiral-like pattern discussed above.

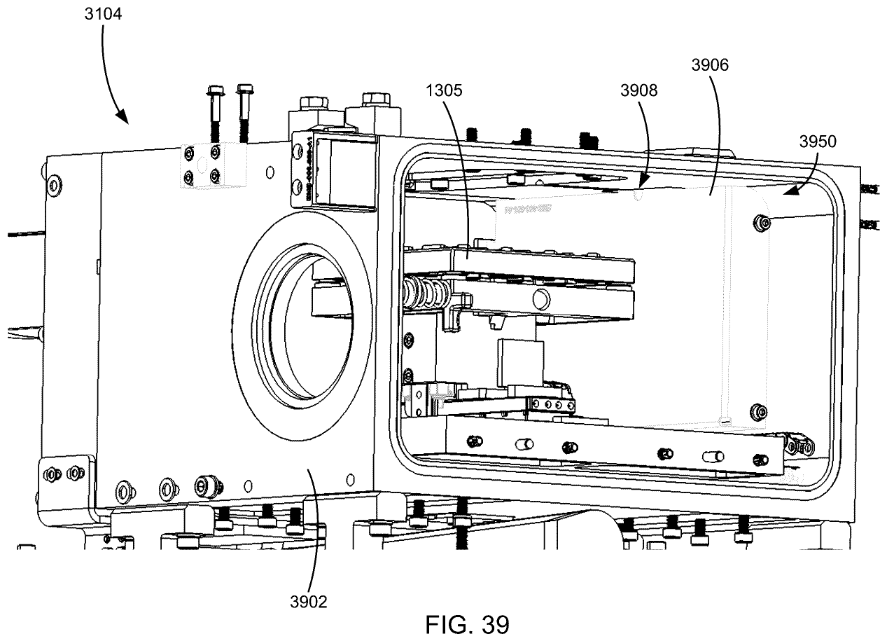

An example of a rotating glass shield is provided in FIGS. 39-42. In addition to including a rotating glass shield, the implementation illustrated in FIGS. 39-42 and discussed below implements glass shielding in the context of the ionization beam generated by system 1300 to produce secondary ions.

FIG. 39 shows sample chamber 1304 in an isometric view with a portion of a chamber wall 3902 removed such that internal components of sample chamber 1304 are visible. As previously discussed, sample chamber 1304 generally contains sample holder 1305 on which a sample may be mounted during testing. As discussed throughout this disclosure, system 1300 generally functions by applying a desorption or ablation beam to a sample supported by sample holder 1305 to liberate organic or inorganic material, respectively. To do so, a desorption or ablation beam is generated by system 1300 and directed into sample chamber 1304 through ion processing chamber 1306 (e.g., in a substantially vertical direction along aperture axis 1322, shown in FIG. 13, which is coincident with beam axis 3102 shown in FIG. 31). System 1300 subsequently ionizes particles generated by the desorption or ablation beam using an ionization beam to produce secondary ions for delivery and analysis by a mass spectrometer.

In at least certain implementations, system 1300 delivers the ionization beam horizontally into sample chamber 1304 at a location above the sample. For example, with reference to FIG. 19, ionization location 1354 may be disposed above aperture 1320 of aperture plate 1314 with the ionization beam being delivered through ionization window 1352A of aperture plate 1314.

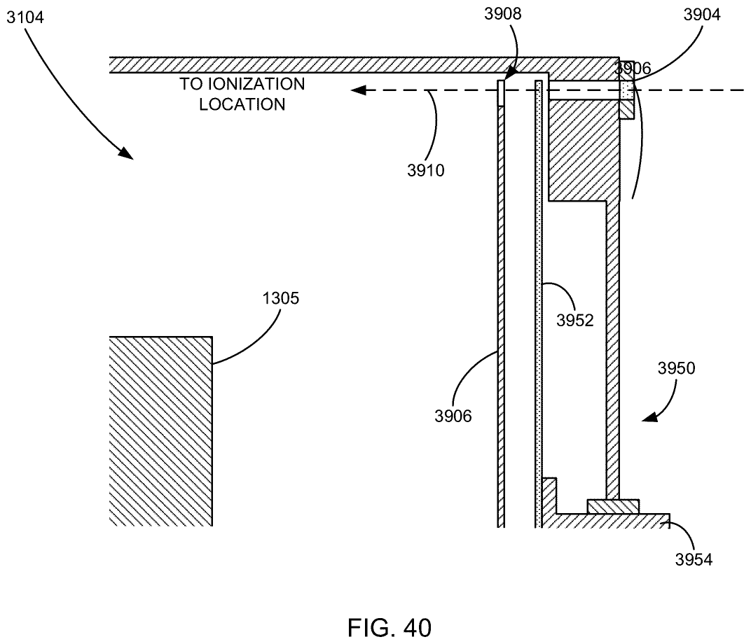

As previously noted in the context of glass shield assembly 3110 of ion processing chamber 1306, internal chamber 1302 is maintained at or near vacuum during testing. Accordingly, any beams directed into the internal chamber 1302 are passed through respective windows that extend through and seal against the walls of internal chamber 1302. Like window 3104 of ion processing chamber 1306 through which system 1300 directs the desorption and ablation beam, sample chamber 1304 may include a window 3904 (shown in FIG. 40) through which system 1300 delivers the ionization beam (e.g., along an ionization beam axis 3910, shown in FIG. 40). Also, like window 3104, the internal surface of window 3904 may become fouled from testing samples, impacting the strength and quality of the ionization beam. With this in mind, implementations of this disclosure may include a glass shield assembly 3950 directed to protecting window 3904 from fouling.

Referring to FIGS. 39 and 40, glass shield assembly 3950 may include a glass shield 3952 (shown in FIG. 40) disposed behind a cover 3906 coupled to the interior surface of ion processing chamber 1306. In certain implementations, cover 3906 extends over and protects the entirety of glass shield 3952 but for a port 3908 to permit passage of the ionization beam into sample chamber 1304.

FIG. 40 is a simplified cross-sectional view of sample chamber 1304 including portions of glass shield assembly 3950. Specifically, FIG. 40 illustrates chamber wall 3902 with window 3904 extending through chamber wall 3902 to allow ionization beams to enter sample chamber 1304 along ionization beam axis 3910. As shown, ionization beam axis 3910 extends through both glass shield 3952 of glass shield assembly 3950 and port 3908 of cover 3906. As a result, glass shield 3952 is substantially protected by cover 3906, substantially limiting fouling of glass shield 3952 to the area of glass shield assembly 3950 between port 3908 and window 3904.

FIG. 40 also shows a drive shaft 3954 of glass shield assembly 3950 coupled to glass shield 3952. Drive shaft 3954 may be coupled to an actuator (e.g., a motor) to facilitate indexing of glass shield 3952 by rotation. Like the coupling of glass shield 3112 to shield gear 3154, in at least certain implementations, glass shield 3952 is coupled to drive shaft 3954 by an adhesive to reduce the overall thickness of the assembly including glass shield 3952 and drive shaft 3954 and to preserve structural integrity of glass shield 3952; however, this disclosure contemplates that glass shield 3952 may be coupled to drive shaft 3954 using any suitable coupling technique.

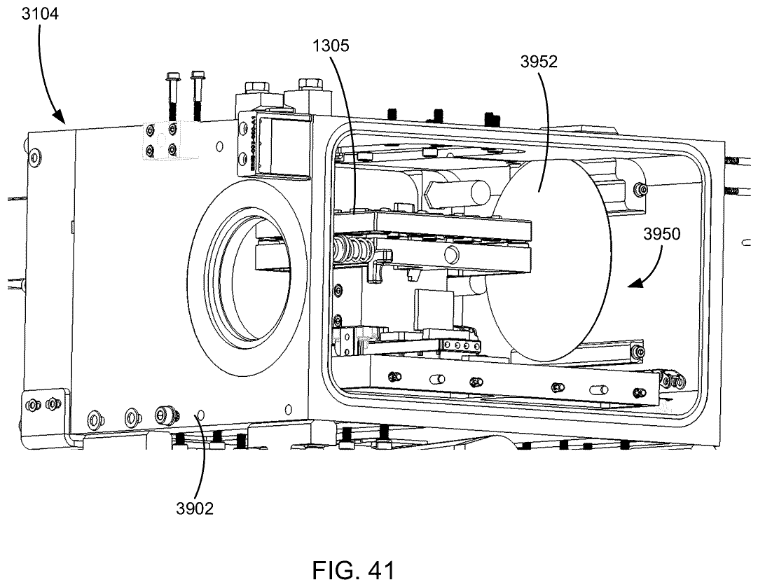

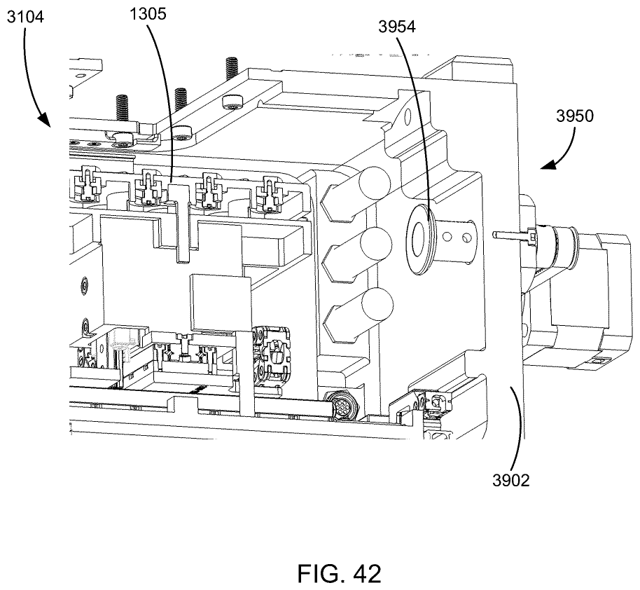

FIG. 41 illustrates the internal components of sample chamber 1304 with cover 3906 removed. To better illustrate the positioning of glass shield 3952 within sample chamber 1304. Among other things, FIG. 41 illustrates how glass shield 3952 may be circular in shape and in a vertical orientation in at least some implementations. FIG. 42 further illustrates sample chamber 1304 with glass shield 3952 removed, exposing drive shaft 3954.

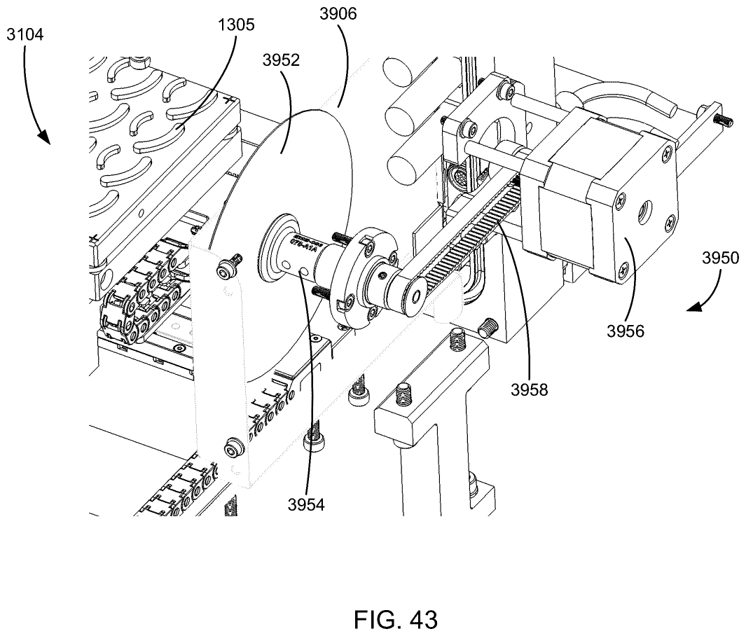

Finally, FIG. 43 is an exterior view of sample chamber 1304 with chamber wall 3902 removed to better illustrate the drive system of glass shield assembly 3950. As shown, glass shield assembly 3950 may include a motor 3956 (e.g., a stepper motor), which may be in communication with and controlled by a controller (not shown). Motor 3956 is coupled to drive shaft 3954 (e.g., by a belt 3958, or similar mechanism) such that actuation of motor 3956 results in rotation of glass shield glass shield 3952.

Similar to the previously discussed glass shield assembly, glass shield assembly 3950 may be configured to index glass shield 3952 by actuating motor 3956 to incrementally rotate glass shield 3952 and expose a new, clean portion of glass shield 3952 to debris and fouling. Like the previously discussed glass shield assembly, indexing of glass shield 3952 may be based on any suitable factor or event including, but not limited to, completion of a certain number of tests, elapsing of a certain period of time, changes in characteristics of a test beam passed through glass shield 3952, direct measurements of the surface of glass shield 3952, and the like. In at least certain implementations, indexing of glass shield 3952 and indexing of glass shield 3112 may be synchronized. Additionally, glass shield assembly 3950 and glass shield assembly 3110 may be configured to have the same number of glass shield positions such that cleaning and/or replacement of the glass shields occur on substantially the same schedule. Alternatively, one of glass shield assembly 3950 and glass shield assembly 3110 may have a whole number multiple of index positions such that maintenance tasks can be similarly synchronized. For example, glass shield assembly 3950 may index through 100 positions while glass shield assembly 3110 may index through 50 positions such that maintenance of glass shield assembly 3950 is synchronized with every other maintenance performed on glass shield assembly 3110.

### Example Computing System

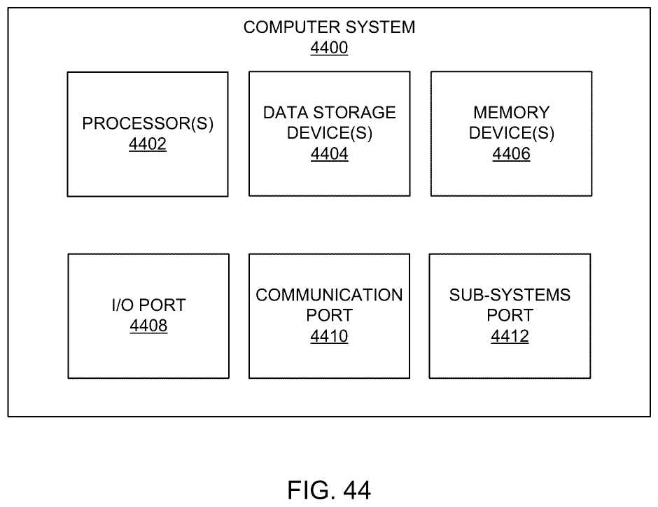

Referring to FIG. 44, a schematic illustration of an example computing system 4400 having one or more computing units that may implement various systems, processes, and methods discussed herein is provided. For example, the example computing system 4400 may correspond to, among other things, the computing device 192 of the analysis system 100 of FIG. 1A. It will be appreciated that specific implementations of these devices may be of differing possible specific computing architectures not all of which are specifically discussed herein but will be understood by those of ordinary skill in the art.

The computing system 4400 may be a computing system capable of executing a computer program product to execute a computer process. Data and program files may be input to computing system 4400, which reads the files and executes the programs therein. Some of the elements of the computing system 4400 are shown in FIG. 44, including one or more hardware processors 4402, one or more data storage devices 4404, one or more memory devices 4406, and/or one or more ports 4408-4412. Additionally, other elements that will be recognized by those skilled in the art may be included in the computing system 4400 but are not explicitly depicted in FIG. 44 or discussed further herein. Various elements of the computing system 4400 may communicate with one another by way of one or more communication buses, point-to-point communication paths, or other communication means not explicitly depicted in FIG. 44.

The processor 4402 may include, for example, a central processing unit (CPU), a microprocessor, a microcontroller, a digital signal processor (DSP), and/or one or more internal levels of cache. There may be one or more processors 4402, such that the processor 4402 includes a single central-processing unit, or a plurality of processing units capable of executing instructions and performing operations in parallel with each other, commonly referred to as a parallel processing environment.

The computing system 4400 may be a conventional computer, a distributed computer, or any other type of computer, such as one or more external computers made available via a cloud computing architecture. The presently described technology is optionally implemented in software stored on data storage device(s) 4404, stored on memory device(s) 4406, and/or communicated via one or more of the ports 4408-4412, thereby transforming the computing system 4400 in FIG. 44 to a special purpose machine for implementing the operations described herein. Examples of the computing system 4400 include personal computers, terminals, workstations, mobile phones, tablets, laptops, personal computers, multimedia consoles, gaming consoles, set top boxes, and the like.

One or more data storage devices 4404 may include any non-volatile data storage device capable of storing data generated or employed within the computing system 4400, such as computer executable instructions for performing a computer process, which may include instructions of both application programs and an operating system (OS) that manages the various components of the computing system 4400. Data storage devices 4404 may include, without limitation, magnetic disk drives, optical disk drives, solid state drives (SSDs), flash drives, and the like. Data storage devices 4404 may include removable data storage media, non-removable data storage media, and/or external storage devices made available via wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. One or more memory devices 4406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 4404 and/or the memory devices 4406, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing system 4400 includes one or more ports, such as an input/output (I/O) port 4408, a communication port 4410, and a sub-systems port 4412, for communicating with other computing, network, or similar devices. It will be appreciated that the ports 4408-4412 may be combined or separate and that more or fewer ports may be included in the computing system 4400.

The I/O port 4408 may be connected to an I/O device, or other device, by which information is input to or output from the computing system 4400. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 4400 via the I/O port 4408. Similarly, the output devices may convert electrical signals received from the computing system 4400 via the I/O port 4408 into signals that may be sensed as output by a human, such as sound, light, and/or touch. The input device may be an alphanumeric input device, including alphanumeric and other keys for communicating information and/or command selections to the processor 4402 via the I/O port 4408. The input device may be another type of user input device including, but not limited to direction and selection control devices, such as a mouse, a trackball, cursor direction keys, a joystick, and/or a wheel; one or more sensors, such as an imaging device, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 4400 via the I/O port 4408. For example, an electrical signal generated within the computing system 4400 may be converted to another type of signal, and/or vice-versa. In one implementation, the environment transducer devices sense characteristics or aspects of an environment local to or remote from the computing system 4400, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example the computing system 4400, such as, physical movement of some object (e.g., a mechanical actuator), heating, or cooling of a substance, adding a chemical substance, and/or the like.

In one implementation, a communication port 4410 is connected to a network by way of which the computing system 4400 may receive network data useful in executing the methods and systems set out herein as well as transmitting information and network configuration changes determined thereby. Stated differently, the communication port 4410 connects the computing system 4400 to one or more communication interface devices configured to transmit and/or receive information between the computing system 4400 and other devices by way of one or more wired or wireless communication networks or connections. Examples of such networks or connections include, without limitation, Universal Serial Bus (USB), Ethernet, WiFi, Bluetooth®, Near Field Communication (NFC), Long-Term Evolution (LTE), and so on. One or more such communication interface devices may be utilized via communication port 4410 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 4410 may communicate with an antenna for electromagnetic signal transmission and/or reception.

The computing system 4400 may include a sub-systems port 4412 for communicating with one or more sub-systems, to control an operation of the one or more sub-systems, and to exchange information between the computing system 4400 and the one or more sub-systems. Examples of such sub-systems include, without limitation, imaging systems, radar, LIDAR, motor controllers and systems, battery controllers, fuel cell or other energy storage systems or controls, light systems, navigation systems, environment controls, entertainment systems, and the like.

The system set forth in FIG. 44 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Although various representative embodiments have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

### Illustrative Aspects of the Present Disclosure

Illustrative examples of the disclosure include, but are not limited to the following:

Aspect 1-1. A system for performing sample analysis, the system including a sample chamber; an aperture plate defining an aperture having an aperture axis, the aperture axis aligned with a sample location within the sample chamber such that, when a sample is disposed within the sample chamber below the aperture plate and a beam is applied to the sample along the aperture axis, a cloud of material removed from the sample by the beam passes through the aperture; an ion extractor assembly defining an ion extraction path and including an ion extractor tip, the ion extractor tip disposed within the sample chamber and defining an ion extractor inlet, the ion extractor inlet disposed above the aperture and offset from the aperture axis; and a mass spectrometer in communication with the ion extractor assembly along the ion extraction path, the mass spectrometer configured to receive ionized material from the ion extractor assembly and to analyze the ionized material, wherein the ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by applying an ionization beam to the cloud of material toward the ion extractor inlet and along the extraction path.

Aspect 1-2. The system of claim Aspect 1-1, wherein, when the ion extractor assembly is in the rejection state, the ion extractor tip is positively charged.

Aspect 1-3. The system of claim Aspect 1-1, wherein, when the ion extractor assembly is in the acceptance state, the ion extractor tip is negatively charged.

Aspect 1-4. The system of claim Aspect 1-1, wherein the ion extractor tip includes an external tip portion and an internal tip portion disposed within the external tip portion.

Aspect 1-5. The system of claim Aspect 1-4, wherein the external tip portion is recessed relative to the internal tip portion and away from the aperture axis.

Aspect 1-6. The system of claim Aspect 1-4, wherein the internal tip portion is recessed relative to the external tip portion and away from the aperture axis.

Aspect 1-7. The system of claim Aspect 1-4, wherein the internal tip portion is flush with the external tip portion.

Aspect 1-8. The system of claim Aspect 1-4, wherein, when in the rejection state, the internal tip portion is positively charged and the external tip portion is neutrally charged.

Aspect 1-9. The system of claim Aspect 1-4, wherein, when in the rejection state, the internal tip portion has a voltage of at least about 50 V.

Aspect 1-10. The system of claim Aspect 1-4, wherein, when in the rejection state, the internal tip portion has a voltage of about 100 V.

Aspect 1-11. The system of claim Aspect 1-4, wherein, when in the acceptance state, the internal tip portion has a voltage from and including −400 V to and including about −100 V.

Aspect 1-12. The system of claim Aspect 1-4, wherein, when in the acceptance state, the internal tip portion has a voltage from and including −350 V to and including −100 V.

Aspect 1-13. The system of claim Aspect 1-4, wherein, when in the acceptance state, the internal tip portion has a voltage of about −180 V.

Aspect 1-14. The system of claim Aspect 1-1, wherein the ion extractor tip is conical.

Aspect 1-15. The system of claim Aspect 1-1, wherein the ion extractor assembly further includes a tube lens disposed within the ion extractor tip.

Aspect 1-16. The system of claim Aspect 1-1, wherein the ion extractor assembly includes a gate valve disposed between the ion extractor tip and the mass spectrometer to selectively permit the ionized material to pass through the ion extractor assembly to the mass spectrometer.

Aspect 1-17. The system of claim Aspect 1-1, wherein the ion extractor assembly further includes an ion bender lens between the ion extractor tip and the mass spectrometer to redirect the ionized material toward the mass spectrometer.

Aspect 1-18. The system of claim Aspect 1-17, wherein the ion bender lens is one of a plurality of ion bender lenses disposed between the ion extractor tip and the mass spectrometer.

Aspect 1-19. The system of claim Aspect 1-18, wherein the ion extraction path includes a bend of approximately 45 degrees and the plurality of ion bender lenses are configured to direct the ionized material along the bend.

Aspect 1-20. The system of claim Aspect 1-1, wherein the ion extractor assembly further includes a repelling plate disposed adjacent the aperture.

Aspect 1-21. The system of claim Aspect 1-20, wherein the repelling plate is disposed adjacent the aperture, across the aperture and opposite the ion extractor inlet.

Aspect 1-22. The system of claim Aspect 1-20, wherein, when the ion extractor assembly is in the rejection state, the ion repelling plate is negatively charged.

Aspect 1-23. The system of claim Aspect 1-20, wherein, when the ion extractor assembly is in the rejection state, the repelling plate is positively charged.

Aspect 1-24. The system of claim Aspect 1-23, wherein, when the ion extractor assembly is in the rejection state, the extractor tip is positively charged and has a greater positive charge than the repelling plate.

Aspect 1-25. The system of claim Aspect 1-20, wherein, when in the rejection state, the repelling plate has a voltage from and including about −400 V to and including about 400 V.

Aspect 1-26. The system of claim Aspect 1-20, wherein, when in the rejection state, the repelling plate has a voltage of about 40 V.

Aspect 1-27. The system of claim Aspect 1-20, wherein, when in the acceptance state, the repelling plate has a voltage from and including 0 V to and including 100 V.

Aspect 1-28. The system of claim Aspect 1-20, wherein, when in the acceptance state, the repelling plate has a voltage from and including 10 V to and including 60 V.

Aspect 1-29. The system of claim Aspect 1-20, wherein, when in the acceptance state, the repelling plate has a voltage of about 40 V.

Aspect 1-30. The system of claim Aspect 1-20, wherein the repelling plate includes a lead surface closest to the aperture axis and the lead surface is parallel to the aperture axis.

Aspect 1-31. The system of claim Aspect 1-30, wherein the repelling plate has a cross-sectional height parallel to the aperture axis and the cross-sectional height is from and including about 2.5 mm to and including about 20 mm.

Aspect 1-32. The system of claim Aspect 1-30, wherein the repelling plate has a cross-sectional height parallel to the aperture axis and the cross-sectional height is from and including about 5 mm to and including about 15 mm.

Aspect 1-33. The system of claim Aspect 1-30, wherein the repelling plate has a cross-sectional height parallel to the aperture axis and the cross-sectional height is about 10 mm.

Aspect 1-34. The system of claim Aspect 1-30, wherein the repelling plate defines a vertical centerline and the vertical centerline is offset laterally from the aperture axis by a distance from and including about 3 mm to and including 12 mm.

Aspect 1-35. The system of claim Aspect 1-30, wherein the repelling plate defines a vertical centerline and the vertical centerline is offset laterally from the aperture axis by a distance from and including about 3.8 mm to and including 11.2 mm.

Aspect 1-36. The system of claim Aspect 1-30, wherein the repelling plate defines a vertical centerline and the vertical centerline is offset laterally from the aperture axis by a distance of about 10 mm.

Aspect 1-37. The system of claim Aspect 1-30, wherein the repelling plate includes a bottom surface and the bottom surface is vertically offset from a top of the aperture by a distance from and including about 2.5 mm to and including 12.5 mm.

Aspect 1-38. The system of claim Aspect 1-30, wherein the repelling plate includes a bottom surface and the bottom surface is vertically offset from a top of the aperture by a distance from and including about 4 mm to and including 10 mm.

Aspect 1-39. The system of claim Aspect 1-30, wherein the repelling plate includes a bottom surface and the bottom surface is vertically offset from a top of the aperture by a distance of about 6.3 mm.

Aspect 1-40. The system of claim Aspect 1-20, wherein the repelling plate includes a lead surface closest to the aperture axis and the lead surface is angled relative to the aperture axis.

Aspect 1-41. The system of claim Aspect 1-40, wherein the lead surface is angled at approximately 45 degrees relative to the aperture axis.

Aspect 1-42. The system of claim Aspect 1-41, wherein the lead surface is offset from the aperture axis at the top of the aperture by a distance from and including about 10 mm to and including about 14 mm.

Aspect 1-43. The system of claim Aspect 1-41, wherein the lead surface is offset from the aperture axis at the top of the aperture by a distance from and including about 11 mm to and including about 13 mm.

Aspect 1-44. The system of claim Aspect 1-41, wherein the lead surface is offset from the aperture axis at the top of the aperture by a distance from and including about 12.5.

Aspect 1-45. The system of claim Aspect 1-40, wherein the repelling plate has a thickness extending parallel to the lead surface and the thickness is from and including about 2.5 mm to and including about 20 mm.

Aspect 1-46. The system of claim Aspect 1-40, wherein the repelling plate has a thickness extending parallel to the lead surface and the thickness is from and including about 5 mm to and including about 15 mm.

Aspect 1-47. The system of claim Aspect 1-40, wherein the repelling plate has a thickness extending parallel to the lead surface and the thickness is about 10 mm.

Aspect 1-48. The system of claim Aspect 1-1, wherein, when the ion extractor assembly is in the rejection state, the aperture plate is positively charged.

Aspect 1-49. The system of claim Aspect 1-1, wherein, when the ion extractor assembly is in the acceptance state, the aperture plate is negatively charged.

Aspect 1-50. The system of claim Aspect 1-1, wherein, when in the rejection state, the aperture plate has a voltage greater than or equal to 100 V.

Aspect 1-51. The system of claim Aspect 1-1, wherein, when in the rejection state, the aperture plate has a voltage of about 130 V.

Aspect 1-52. The system of claim Aspect 1-1, wherein, when in the rejection state, the aperture plate has a voltage less than or equal to −50 V.

Aspect 1-53. The system of claim Aspect 1-1, wherein, when in the acceptance state, the aperture plate has a voltage from and including 0 V to and including 50 V.

Aspect 1-54. The system of claim Aspect 1-1, wherein, when in the acceptance state, the aperture plate has a voltage from and including 20 V to and including 40 V.

Aspect 1-55. The system of claim Aspect 1-1, wherein, when in the acceptance state, the aperture plate has a voltage of about 30 V.

Aspect 1-56. The system of claim Aspect 1-1, wherein the aperture plate defines an ionization beam channel that intersects with the aperture axis.

Aspect 1-57. The system of claim Aspect 1-1, wherein the aperture plate has a thickness from an including about 0.001 mm to and including about 2 mm surrounding the aperture.

Aspect 1-58. The system of claim Aspect 1-1, wherein the aperture plate has a thickness of about 1 mm surrounding the aperture.

Aspect 1-59. The system of claim Aspect 1-1, wherein the ion extractor inlet defines an inlet axis and the inlet axis is offset by an angle from and including about 0 degrees to and including about 90 degrees relative to the aperture axis.

Aspect 1-60. The system of claim Aspect 1-1, wherein the ion extractor inlet defines an inlet axis and the inlet axis is offset by an angle of about 45 degrees relative to the aperture axis.

Aspect 1-61. The system of claim Aspect 1-1, wherein the aperture plate defines an ionization beam channel that extends along an ionization beam path, the ion extractor inlet defines an inlet axis angularly offset from the aperture axis, the inlet axis intersects the aperture axis at a first location, and the ionization beam path intersects the aperture axis at a second location.

Aspect 1-62. The system of claim Aspect 1-61, wherein the first location is from and including about 0 mm to and including about 20 mm above the second location.

Aspect 1-63. The system of claim Aspect 1-61, wherein the first location is about 1 mm above the aperture.

Aspect 2-1. A device including a frame coupleable to a sample chamber of an analysis system; an aperture plate coupled to the frame, the aperture plate defining an aperture having an aperture axis; an ion extractor tip assembly coupled to the frame and including an ion extractor tip defining an ion extractor inlet, the ion extractor inlet disposed above the aperture and offset from the aperture axis; and a repelling plate disposed adjacent the aperture.

Aspect 2-2. The device of Aspect 2-1, wherein the ion extractor tip includes an external tip portion and an internal tip portion disposed within the external tip portion.

Aspect 2-3. The device of Aspect 2-2, wherein the external tip portion is recessed relative to the internal tip portion and away from the aperture axis.

Aspect 2-4. The device of Aspect 2-2, wherein the internal tip portion is recessed relative to the external tip portion and away from the aperture axis.

Aspect 2-5. The device of Aspect 2-2, wherein the internal tip portion is flush with the external tip portion.

Aspect 2-6. The device of Aspect 2-1, wherein the ion extractor tip is conical.

Aspect 2-7. The device of Aspect 2-1, wherein the ion extractor tip assembly further includes a tube lens disposed within the ion extractor tip.

Aspect 2-8. The device of Aspect 2-1, wherein the repelling plate is disposed directly across the aperture and opposite the ion extractor inlet.

Aspect 2-9. The device of Aspect 2-1, wherein the repelling plate includes a lead surface closest to the aperture axis and the lead surface is parallel to the aperture axis.

Aspect 2-10. The device of Aspect 2-1, wherein the repelling plate includes a lead surface closest to the aperture axis and the lead surface is angled relative to the aperture axis.

Aspect 2-11. The device of Aspect 2-10, wherein the lead surface is angled at approximately 45 degrees relative to the aperture axis.

Aspect 2-12. The device of Aspect 2-1, wherein the aperture plate defines an ionization beam channel that intersects with the aperture axis.

Aspect 2-13. The device of Aspect 2-1, wherein the ion inlet defines an inlet axis and the inlet axis is offset by an angle of about 45 degrees relative to the aperture axis.

Aspect 2-14. The device of Aspect 2-1, wherein the aperture plate defines an ionization beam channel that extends along an ionization beam path the ion extractor inlet defines an inlet axis angularly offset from the aperture axis, and each of the ionization beam path, the inlet axis, and the aperture axis intersect at an intersection location above the aperture.

Aspect 3-1. A method of performing sample analysis including generating a rejection field within a sample chamber of a sample analysis system, the rejection field shaped to direct ions of a cloud of material away from an ion extraction path of an ion extractor assembly, wherein the ion extractor assembly is operably connected to a mass spectrometer, and the cloud of material is produced by applying a beam to a sample within the sample chamber; and generating an acceptance field within the sample chamber, the acceptance field shaped to direct ionized material toward the ion extraction path, wherein the ionized material is generated by applying an ionization beam to the cloud of material subsequent to generating the rejection field.

Aspect 3-2. The method of Aspect 3-1, further including applying the laser to the sample to produce the cloud of material.

Aspect 3-3. The method of Aspect 3-1, further including applying the ionization beam to the cloud of material to produce the ionized material.

Aspect 3-4. The method of Aspect 3-1, wherein the ion extractor assembly includes an ion extractor tip defining the ion extractor inlet.

Aspect 3-5. The method of Aspect 3-4, wherein generating the rejection field includes causing the ion extractor tip to be positively charged.

Aspect 3-6. The method of claim Aspect 3-4, wherein generating the acceptance field includes causing the ion extractor tip to be negatively charged.

Aspect 3-7. The method of Aspect 3-1, wherein the ion extractor assembly includes an aperture plate defining an aperture through which the cloud of material passes following application of the laser to the sample.

Aspect 3-8. The method of Aspect 3-7, wherein generating the rejection field includes causing the aperture plate to be positively charged.

Aspect 3-9. The method of Aspect 3-7, wherein generating the acceptance field includes causing the aperture plate to be negatively charged.

Aspect 3-10. The method of Aspect 3-7, wherein the ion extractor assembly includes a repelling plate adjacent the aperture.

Aspect 3-11. The method of Aspect 3-10, wherein generating the rejection field includes causing the repelling plate to be positively charged.

Aspect 3-12. The method of Aspect 3-10, wherein generating the rejection field includes causing each of an ion extractor tip and the repelling plate to be positively charged, the ion extractor tip being more positively charged than the repelling plate.

Aspect 3-13. The method of Aspect 3-10, wherein generating the acceptance field includes causing the repelling plate to be positively charged.

Aspect 3-14. The method of claim Aspect 3-1, further including receiving the ionized material within the ion extractor tip; and directing the ionized material along the ion extractor path to a mass spectrometer in communication with the ion extractor assembly.

Aspect 3-15. The method of Aspect 3-14, wherein directing the ionized material along the ion extractor path to the mass spectrometer includes directing the ionized material along at least one curved segment of the ion extraction path.

Aspect 3-16. The method of claim Aspect 3-1, wherein directing the ionized material along the ion extractor path to the mass spectrometer includes opening a gate valve of the ion extractor assembly to permit the ionized material to travel along the ion extraction path.

Aspect 3-17. The method of Aspect 3-1, wherein the ion extractor assembly includes an ion extractor tip defining an ion extractor inlet; and an aperture plate defining an aperture having an aperture axis through which the cloud of material passes following application of the beam to the sample, wherein the ion extractor inlet is disposed above the aperture and offset from the aperture axis.

Aspect 3-18. The method of Aspect 3-17, wherein generating the rejection field includes causing at least one of the ion extractor tip and the aperture plate to be positively charged and generating the acceptance field includes causing at least one of the ion extractor tip and the aperture plate to be negatively charged.

Aspect 3-19. The method of Aspect 3-17, wherein the ion extractor assembly includes a repelling plate adjacent the aperture and generating the rejection field includes causing the repelling plate to be positively charged.

Aspect 4-1. A system including a sample chamber; an aperture plate defining an aperture having an aperture axis, the aperture axis aligned with a sample location within the sample chamber; a first laser source configured to deliver a first beam along a first beam path to produce a cloud of material from a sample disposed at the sample location; a second laser source configured to deliver a second beam along a second beam path to produce ionized material from the cloud of material at an ionization location, wherein the ionization location is between the sample location and the aperture; an ion extractor assembly defining an ion extraction path and including an ion extractor tip, the ion extractor tip disposed within the sample chamber and defining an ion extractor inlet, the ion extractor inlet disposed above the aperture and offset from the aperture axis; and a mass spectrometer in communication with the ion extractor assembly along the ion extraction path, the mass spectrometer configured to receive ionized material from the ion extractor assembly and to analyze the ionized material, wherein the ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by the second beam along the ion extraction path.

Aspect 5-1. A device for sample analysis including a laser source for generating a beam; a vacuum chamber having a chamber wall defining an inner volume, the chamber wall including a window disposed along a beam path of the beam; and a glass shield assembly including a glass shield disposed within the vacuum chamber and extending across the beam path; and a drive assembly operably coupled to the glass shield, wherein the drive assembly is configured to transition the glass shield from a first configuration in which a first portion of the glass shield overlaps the window and a second configuration in which a second portion of the glass shield different than the first portion of the glass shield overlaps the window.

Aspect 5-2. The device of Aspect 5-1, wherein the glass shield extends perpendicularly across the beam path.

Aspect 5-3. The device of Aspect 5-1, wherein the drive assembly transitions the glass shield by rotating the glass shield.

Aspect 5-4. The device of Aspect 5-1, wherein the drive assembly transitions the glass shield by translating the glass shield.

Aspect 5-5. The device of Aspect 5-1, wherein the drive assembly transitions the glass shield by each of rotating and translating the glass shield.

Aspect 5-6. The device of Aspect 5-1, further including a controller operatively connected to the drive assembly and configured to actuate the drive assembly to transition the glass shield.

Aspect 5-7. The device of Aspect 5-6, wherein the controller is configured to actuate the drive assembly in response to the device exceeding a sample quantity.

Aspect 5-8. The device of Aspect 5-6, wherein the controller is configured to actuate the drive assembly in response to the device exceeding an operation time.

Aspect 5-9. The device of Aspect 5-6, further including a power meter disposed within the vacuum chamber to receive and generate a power measurement of the beam; and wherein the controller is configured to actuate the drive assembly to transition the glass shield based on the power measurement.

Aspect 5-10. The device of Aspect 5-1, wherein the drive assembly includes a motor and a gear assembly, the gear assembly configured to provide both rotation and translation of the glass shield in response to actuation of the motor.

Aspect 5-11. The device of Aspect 5-1, wherein the drive assembly includes a motor; a drive gear operably coupled to the motor; a rotational gear assembly engaged with the drive gear and operably coupled to the glass shield such that actuation of the motor causes rotation of the glass shield; a sled supporting the glass shield; and a translational gear assembly engaged with the drive gear and operably coupled to the sled such that actuation of the motor further causes translation of the sled.

Aspect 5-12. The device of Aspect 5-11, wherein the rotation of the glass shield about an axis of rotation and the translation of the sled is perpendicular to the axis of rotation.

Aspect 5-13. The device of Aspect 5-11, wherein the translational gear assembly incrementally translates the sled after a full rotation of the glass shield.

Aspect 5-14. The device of Aspect 5-11, wherein the sled includes a sled body supporting the glass shield and a pin extending from the sled body, the translational gear assembly includes a slotted gear, the slotted gear including a gear body defining a slot within which the pin of the sled extends, and the slotted gear rotates to cause movement of the pin along the slot to translate the sled.

Aspect 5-15. The device of Aspect 5-14, wherein the slot includes a first arcuate segment extending about an axis of the slotted gear at a first radius, a second arcuate segment extending about the axis of the slotted gear at a second radius different from the first radius, and a linear segment disposed between the first arcuate segment and the second arcuate segment, the sled remains stationary when the pin travels along each of the first arcuate segment and the second arcuate segment during rotation of the slotted gear, and the sled translates when the pin travels along the linear segment during rotation of the slotted gear.

Aspect 5-16. The device of Aspect 5-1, wherein the glass shield is formed from quartz glass.

Aspect 5-17. The device of Aspect 5-1, further including, wherein the glass shield is a first glass shield and the beam path is a first beam path, the device further including a second laser source for generating a second beam; and a second glass shield assembly including a second glass shield disposed within the vacuum chamber; and a second drive assembly coupled to the second glass shield, wherein the vacuum chamber wall includes a second window disposed along a beam path of the second beam, the second glass shield extends perpendicular to and across the beam path of the second beam, and the second drive assembly is configured to transition the second glass shield from a first configuration of the second glass shield in which a first portion of the second glass shield overlaps the second window to a second configuration of the second glass shield in which a second portion of the second glass shield overlaps the second window.

Aspect 5-18. The device of Aspect 5-17, wherein the second beam path intersects the first beam path perpendicularly.

Aspect 6-1. A device including a frame; a glass shield supported by the frame; and a drive assembly operably coupled to the glass shield, wherein the drive assembly is configured to transition the glass shield relative to the frame between a first configuration in which a first portion of the second glass shield is disposed at a target location and a second configuration in which a second portion of the second glass shield is disposed at the position.

Aspect 6-2. The device of Aspect 6-1, wherein the drive assembly is configured to transition the glass shield relative to the frame by rotating the glass shield.

Aspect 6-3. The device of Aspect 6-1, wherein the drive assembly is configured to transition the glass shield relative to the frame by translating the glass shield.

Aspect 6-4. The device of Aspect 6-1, wherein the drive assembly is configured to transition the glass shield relative to the frame by each of rotating and translating the glass shield.

Aspect 6-5. The device of Aspect 6-1, further including a controller operatively connected to the drive assembly and configured to actuate the drive assembly to transition the glass shield.

Aspect 6-6. The device of Aspect 6-5, wherein the controller is configured to actuate the drive assembly in response to a sample analysis system within which the device is integrated exceeding a sample quantity.

Aspect 6-7. The device of Aspect 6-5, wherein the controller is configured to actuate the drive assembly in response to operation time for a system within which the device is integrated exceeding an operation time.

Aspect 6-8. The device of Aspect 6-5, wherein the controller is configured to actuate the drive assembly in response to a beam power measurement.

Aspect 6-9. The device of Aspect 6-1, wherein the drive assembly includes a motor and a gear assembly, the gear assembly configured to provide both rotation and translation of the glass shield in response to actuation of the motor.

Aspect 6-10. The device of Aspect 6-1, wherein the drive assembly includes a motor; a drive gear operably coupled to the motor; a rotational gear assembly engaged with the drive gear and operably coupled to the glass shield such that actuation of the motor causes rotation of the glass shield; a sled supporting the glass shield; and a translational gear assembly engaged with the drive gear and operably coupled to the sled such that actuation of the motor further causes translation of the sled.

Aspect 6-11. The device of Aspect 6-10, wherein the rotation of the glass shield about an axis of rotation and the translation of the sled is perpendicular to the axis of rotation.

Aspect 6-12. The device of Aspect 6-10, wherein the drive assembly, wherein the translational gear assembly incrementally translates the sled after a full rotation of the glass shield.

Aspect 6-13. The device of Aspect 6-10, wherein the sled includes a sled body supporting the glass shield and a pin extending from the sled body, the translational gear assembly includes a slotted gear, the slotted gear including a gear body defining a slot within which the pin of the sled extends, and the slotted gear rotates to cause movement of the pin along the slot to translate the sled.

Aspect 6-14. The device of Aspect 6-13, wherein the slot includes a first arcuate segment extending about an axis of the slotted gear at a first radius, a second arcuate segment extending about the axis of the slotted gear at a second radius different from the first radius, and a linear segment disposed between the first arcuate segment and the second arcuate segment, the sled remains stationary when the pin travels along each of the first arcuate segment and the second arcuate segment during rotation of the slotted gear, and the sled translates when the pin travels along the linear segment during rotation of the slotted gear.

Aspect 6-15. The device of Aspect 6-1, wherein the glass shield is formed from quartz glass.

Aspect 7-1. A method, including actuating a drive assembly operably coupled to a glass shield disposed within a vacuum chamber of a sample analysis system, wherein the vacuum chamber includes a chamber wall and a window extending through the chamber wall, the window is disposed along a beam path of a laser source of the sample analysis system, the glass shield extends across the beam path, and actuating the drive assembly transitions the glass shield relative to the window from a first configuration in which a first portion of the glass shield overlaps the window to a second configuration different from the first configuration in which a second portion of the glass shield overlaps the window.

Aspect 7-2. The method of Aspect 7-1, wherein the glass shield extends perpendicular to the beam path.

Aspect 7-3. The method of Aspect 7-1, wherein the drive assembly transitions the glass shield by rotating the glass shield.

Aspect 7-4. The method of Aspect 7-1, wherein the drive assembly moves the glass shield by translating the glass shield.

Aspect 7-5. The method of Aspect 7-1, wherein the drive assembly moves the glass shield by each of rotating the glass shield and translating the glass shield.

Aspect 7-6. The method of Aspect 7-1, wherein actuating the drive assembly is in response to the sample analysis system exceeding a sample quantity.

Aspect 7-7. The method of Aspect 7-1, wherein actuating the drive assembly is in response to operation time of the device exceeding an operation time.

Aspect 7-8. The method of Aspect 7-1, further including determining a beam power measurement for a beam passed through the window and the glass shield, wherein actuating the drive assembly is in response to the power measurement is based on the beam power measurement.

Aspect 7-9. The method of Aspect 7-1, wherein the drive assembly includes a motor and a gear assembly, actuation of the drive assembly includes actuation of the motor, and movement of the glass shield includes both rotation and translation of the glass shield.

Aspect 7-10. The method of Aspect 7-1, wherein the drive assembly includes a motor; a drive gear operably coupled to the motor; a rotational gear assembly engaged with the drive gear and operably coupled to the glass shield; a sled supporting the glass shield; and a translational gear assembly engaged with the drive gear and operably coupled to the sled, actuating the drive assembly includes actuating the motor, and actuating the motor causes each of rotation of the glass shield and translation of the sled.

Aspect 7-11. The method of Aspect 7-10, wherein the rotation of the glass shield about an axis of rotation and the translation of the sled is perpendicular to the axis of rotation.

Aspect 7-12. The method of Aspect 7-10, wherein the translational gear assembly incrementally translates the sled after a full rotation of the glass shield.

Aspect 7-13. The method of Aspect 7-10, wherein the sled includes a sled body supporting the glass shield and a pin extending from the sled body, the translational gear assembly includes a slotted gear, the slotted gear including a gear body defining a slot within which the pin of the sled extends, and responsive to actuation of the motor, the slotted gear rotates to cause movement of the pin along the slot to translate the sled.

Aspect 7-14. The method of Aspect 7-13, wherein the slot includes a first arcuate segment extending about an axis of the slotted gear at a first radius, a second arcuate segment extending about the axis of the slotted gear at a second radius different from the first radius, and a linear segment disposed between the first arcuate segment and the second arcuate segment, the sled remains stationary when the pin travels along each of the first arcuate segment and the second arcuate segment during rotation of the slotted gear, and the sled translates when the pin travels along the linear segment during rotation of the slotted gear.

Aspect 7-15. The method of Aspect 7-1 further including actuating a second drive assembly operably coupled to a second glass shield disposed within the vacuum chamber, wherein the vacuum chamber includes a second window extending through the chamber wall, and actuating the second drive assembly moves the second glass shield relative to the second window from a first position in which a first portion of the second glass shield overlaps the aperture to a second position different from the first position in which a second portion of the second glass shield overlaps the window.

Aspect 7-16. The method of Aspect 7-15, wherein actuating the drive assembly and the second drive assembly is substantially simultaneous.

Aspect 7-17. The method of claim Aspect 7-15 further including delivering a first beam produced by the laser source along the beam path to a sample disposed within the vacuum chamber to removed material from the sample; delivering a second beam produced by the second laser source along the second beam path to produce ionized material from the material removed from the sample; and transporting the ionized material to a mass spectrometer in communication with the vacuum chamber.

Aspect 8-1. A system including a first laser source for generating a first beam; a second laser source for generating a second beam; a vacuum chamber having a chamber wall defining an inner volume, the chamber wall including a first window disposed along a first beam path corresponding to the first beam and a second window disposed along a second beam path corresponding to the second beam; and a glass shield assembly including a glass shield extending perpendicular to and across the first beam path; and a drive assembly operably coupled to the first glass shield, wherein the drive assembly is configured to transition the glass shield from a first configuration in which a first portion of the glass shield overlaps the first window and a second configuration in which a second portion of the first glass shield different than the first portion overlaps the first window.

Aspect 8-2. The system of Aspect 8-1, wherein the glass shield assembly is a first glass shield assembly, the glass shield is a first glass shield, and the drive assembly is a first drive assembly, the system further including a second glass shield assembly including a second glass shield extending perpendicular to and across the second beam path; and a second drive assembly operably coupled to the second glass shield, wherein the second drive assembly is configured to transition the second glass shield from a first configuration in which a first portion of the second glass shield overlaps the second window and a second configuration in which a second portion of the second glass shield different than the first portion overlaps the second window.

Aspect 8-3. The system of Aspect 8-1, wherein the second beam path intersects the first beam path perpendicularly.

Aspect 8-4. The system of Aspect 8-1, wherein the first laser source is configured to remove material from a sample disposed within the vacuum chamber using the first beam and the second laser source is configured to ionize material removed by the first laser source.

What is claimed is:

1. A system for performing sample analysis, the system comprising:
a sample chamber;
an aperture plate defining an aperture having an aperture axis, the aperture axis aligned with a sample location within the sample chamber such that, when a sample is disposed within the sample chamber below the aperture plate and a beam is applied to the sample along the aperture axis, a cloud of material removed from the sample by the beam passes through the aperture;
an ion extractor assembly defining an ion extraction path and including an ion extractor tip, the ion extractor tip disposed within the sample chamber and defining an ion extractor inlet, the ion extractor inlet disposed above the aperture and offset from the aperture axis; and
a mass spectrometer in communication with the ion extractor assembly along the ion extraction path, the mass spectrometer configured to receive ionized material from the ion extractor assembly and to analyze the ionized material,
wherein the ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by applying an ionization beam to the cloud of material toward the ion extractor inlet and along the ion extraction path.

2. The system of claim 1, wherein, when the ion extractor assembly is in the rejection state, the ion extractor tip is positively charged.

3. The system of claim 1, wherein, when the ion extractor assembly is in the acceptance state, the ion extractor tip is negatively charged.

4. The system of claim 1, wherein the ion extractor tip includes an external tip portion and an internal tip portion disposed within the external tip portion.

5. The system of claim 4, wherein, when in the rejection state, the internal tip portion is positively charged and the external tip portion is neutrally charged.

6. The system of claim 1, wherein the ion extractor assembly further includes a tube lens disposed within the ion extractor tip.

7. The system of claim 1, wherein the ion extractor assembly includes a gate valve disposed between the ion extractor tip and the mass spectrometer to selectively permit the ionized material to pass through the ion extractor assembly to the mass spectrometer.

8. The system of claim 1, wherein the ion extractor assembly further includes at least one ion bender lens disposed between the ion extractor tip and the mass spectrometer to redirect the ionized material toward the mass spectrometer.

9. The system of claim 1, wherein the ion extractor assembly further includes a repelling plate disposed adjacent the aperture, across the aperture and opposite the ion extractor inlet.

10. The system of claim 9, wherein, when the ion extractor assembly is in the rejection state, the repelling plate is one of negatively and positively charged.

11. The system of claim 9, wherein, when the ion extractor assembly is in the rejection state, each of the ion extractor tip and the repelling plate is positively charged with the ion extractor tip having a greater positive charge than the repelling plate.

12. The system of claim 1, wherein, when the ion extractor assembly is in the rejection state, the aperture plate is positively charged.

13. The system of claim 1, wherein, when the ion extractor assembly is in the acceptance state, the aperture plate is negatively charged.

14. A method of performing sample analysis comprising:
generating a rejection field within a sample chamber of a sample analysis system, the rejection field shaped to direct ions of a cloud of material away from an ion extraction path of an ion extractor assembly, wherein:
the ion extractor assembly is operably connected to a mass spectrometer, and
the cloud of material is produced by applying a beam to a sample within the sample chamber; and
generating an acceptance field within the sample chamber, the acceptance field shaped to direct ionized material toward the ion extraction path, wherein the ionized material is generated by applying an ionization beam to the cloud of material subsequent to generating the rejection field.

15. The method of claim 14 further comprising applying the beam to the sample to produce the cloud of material.

16. The method of claim 14 further comprising applying the ionization beam to the cloud of material to produce the ionized material.

17. The method of claim 14, wherein the ion extractor assembly includes:
an ion extractor tip defining an ion extractor inlet; and
an aperture plate defining an aperture having an aperture axis through which the cloud of material passes following application of the beam to the sample,
wherein the ion extractor inlet is disposed above the aperture and offset from the aperture axis.

18. The method of claim 17, wherein generating the rejection field includes causing at least one of the ion extractor tip and the aperture plate to be positively charged and generating the acceptance field includes causing at least one of the ion extractor tip and the aperture plate to be negatively charged.

19. The method of claim 17, wherein the ion extractor assembly includes a repelling plate adjacent the aperture and generating the rejection field includes causing the repelling plate to be positively charged.

20. A system comprising:
a sample chamber;
an aperture plate defining an aperture having an aperture axis, the aperture axis aligned with a sample location within the sample chamber;
a first laser source configured to deliver a first beam along a first beam path to produce a cloud of material from a sample disposed at the sample location;
a second laser source configured to deliver a second beam along a second beam path to produce ionized material from the cloud of material at an ionization location, wherein the ionization location is between the sample location and the aperture;
an ion extractor assembly defining an ion extraction path and including an ion extractor tip, the ion extractor tip disposed within the sample chamber and defining an ion extractor inlet, the ion extractor inlet disposed above the aperture and offset from the aperture axis; and
a mass spectrometer in communication with the ion extractor assembly along the ion extraction path, the mass spectrometer configured to receive ionized material from the ion extractor assembly and to analyze the ionized material,
wherein the ion extractor assembly is switchable between a rejection state in which the ion extractor assembly generates a rejection field to direct ions of the cloud of material away from the ion extractor inlet, and an acceptance state in which the ion extractor assembly generates an acceptance field to direct ionized material produced by the second beam along the ion extraction path.
